(19) United States
(12) Patent Application Publication
(10) Pub. No.: US 2023/0271840 A1
(43) Pub. Date: Aug. 31, 2023

(54) POROUS CARBON MATERIALS, NANOPARTICLES, METHODS OF MAKING SAME, AND USES THEREOF

(71) Applicants: The Research Foundation for the State University of New York, Buffalo, NY (US); Triad National Security, LLC, Los Alamos, NM (US)

(72) Inventors: Gang Wu, Clarence Center, NY (US); Zhi Qiao, Amherst, NY (US); Jacob Spendelow, Santa Fe, NM (US); Chenyu Wang, Los Alamos, NM (US); Dongguo Li, Los Alamos, NM (US); Yung-Tin Pan, East Dist., Hsinchu City (TW)

(21) Appl. No.: 18/005,723

(22) PCT Filed: Jul. 14, 2021
(86) PCT No.: PCT/US2021/041689

§ 371 Date: Jan. 17, 2023

Related U.S. Application Data
(60) Provisional application No. 63/051,703, filed on Jul. 14, 2020.

(51) Int. Cl. C01B 32/205; C01B 32/215; H01M 8/1004; H01M 4/92; H01M 4/36; H01M 4/38; H01M 4/587; C25B 11/054; C25B 11/065; C25B 11/081; C25B 11/089

(52) U.S. Cl. CPC C01B 32/205; C01B 32/215; H01M 8/1004; H01M 4/926; H01M 4/366; H01M 4/38; H01M 4/587; C25B 11/054; C25B 11/065; C25B 11/081; C25B 11/089; C01P 2006/40; C01P 2006/12; C01P 2002/74; C01P 2002/52; C01P 2006/14; C01P 2006/16; H01M 2008/1095

(57) ABSTRACT

Provided are graphitic carbon materials and methods of making graphitic carbon materials. Also provided are compositions of the graphitic carbon materials with nanoparticles disposed thereon and methods of making the compositions. Also disclosed are devices utilizing the graphitic carbon materials and/or the compositions. The graphitic carbon materials are porous and have a desirable graphitic content. The graphitic materials may be nitrogen- and/or metal-doped. The nanoparticles may be platinum or platinum/transition metal nanoparticles. The compositions may be used in oxygen reduction reaction applications.

### CROSS REFERENCE TO RELATED APPLICATION

This application claims priority to U.S. Provisional Application No. 63/051,703, filed on Jul. 14, 2021, the disclosure of which is incorporated herein by reference.

### STATEMENT REGARDING FEDERALLY SPONSORED RESEARCH

This invention was made with government support under contract no. DE-AC52-06NA25396 awarded by the Department of Energy. The government has certain rights in the invention.

### BACKGROUND OF THE DISCLOSURE

Proton exchange membrane fuel cells (PEMFCs) have attracted attention because of their high energy efficiency and environmental friendliness. Progress has been achieved during recent years, but improvements in several components, especially catalysts for cathode, are still needed to meet the cost and durability targets for large-scale fuel cell commercialization. State of the art catalysts are based on Pt and Pt alloy nanoparticles dispersed on high-surface area carbon supports, which are able to stabilize the nanoparticles to increase catalyst utilization and provide effective mass transport and electronic conductivity. However, catalyst durability with low Pt loadings remains insufficient for practical applications due to the existences of several degradation mechanisms. Poor support stability, which leads to the detachment of Pt nanoparticles, particle agglomeration, and the compaction and then the loss of electrode porosity, is a critical limitation on durability of current catalysts. A variety of conductive materials have been studied as the support for Pt, including nanostructured carbons, conductive diamonds, conductive oxides and carbides. Among them, nanostructured carbon materials have been the most successful due to their high surface area, high electrical conductivity, good interaction with Pt, and reasonable stability in acidic media. Currently, XC-72 and Ketjen black are among the most promising supports, and are commercially used for Pt/C catalysts. However, they are not electrochemically stable under the corrosive conditions in PEMFCs, which include high oxygen concentration, high water content, low pH, elevated temperature up to 100° C., and high electrode potential. Thus, severe carbon corrosion has been observed in fuel cell catalysts, leading to unacceptable catalyst durability.

To address this challenge, many kinds of carbon materials have been investigated as catalyst supports, and it has been observed that structural properties of carbon can have a significant effect on the catalytic activity and durability. Among them, carbon nanotubes and carbon nanofibers (CNTs and CNFs) attracted attention in recent years, and improved activity and stability have been claimed. However, due to the limitation of specific surface area and porous structure, the electrochemical surface area of Pt could be restricted in the case of CNTs and CNFs, which could limit the catalytic performance in a fuel cell. Although enhanced stability was observed in aqueous acidic electrolytes, poor dispersion of Nafion ionomer in CNT supported Pt cathodes usually leads to poor fuel cell performance, especially at high current density. Another candidate support is graphitized carbon, which has been suggested to be more favorable in terms of the decrease of electrical resistance and enhancement of carbon corrosion resistance. Unfortunately, most graphitization approaches compromise the porosity and specific surface area of carbon, while also weakening interactions between carbon and platinum, making it difficult to uniformly disperse Pt nanoparticles on the support. Therefore, significant challenges still remain to develop support materials for PEM fuel cells.

The oxygen reduction reaction (ORR) is critical but sluggish in proton-exchange membrane fuel cells (PEMFCs) and it requires enough catalysts to promote at the cathode. Platinum (Pt) is the only metal catalyst showing promising performance along with feasibility in real application scenario. Unfortunately, the high cost and scarcity of Pt dramatically limit the popularization of PEMFCs and have driven intensive efforts to reduce Pt usage regrading to catalysts development.

Typically, there are two approaches in response to Pt usage reduction. The first strategy explored is to alloy Pt with another first-row transition metal (M), such as cobalt (Co), nickel (Ni); lead (Pb), and iron (Fe). With smaller atomic radius, the incorporation of M atoms in the Pt-based alloy brings beneficial strain and alloy effects that are significant to improving the ORR performance of PtM catalyst. With improved intrinsic activity, intensive research has been conducted in terms of optimization of PtM alloy nanoparticles (NPs) structures. Compared to the common solid solution Al-structure, a PtM alloy with the specific Pt/M composition can adopt an ordered intermetallic structures, which can be cubic L1₂ (Pt₃M) or tetragonal L1₀ (PtM). The ordered intermetallic structure is formed when there is a strong 3d-5d orbital interaction between M and Pt, which is capable to stabilize M much better by Pt in the more close-packed structure, resulting in less M etching and reasonable stability under acidic fuel cell conditions. Unlike the disordered Al-structure, the cubic L1₂ and the tetragonal L1₀ structures are normally obtained by thermal annealing of the Al-counterparts at high temperature (>700° C.). However, under the exact composition of Pt and M during synthesis, undesirable agglomeration of NPs at high temperature can result in a smaller number of shaped but large crystallites, which are not enough to spread over the electrode surface to encounter all the O₂ and produce high current density. This results in significant drop of fuel cell current, especially under low fuel cell polarization voltage.

Another approach is to use a platinum group metal (PGM)-free catalyst, which could eliminate the Pt usage altogether, thus attracts intensive researchers to tackle this high-risk but high-reward task. Generally, such catalysts are prepared from earth-abundant elements such as Fe and Co embedded in nitrogen-carbon composites (M-N—C). The state-of-the-art PGM-free catalysts are located at the Fe-based ones produced from zeolitic imidazolate framework-8 (ZIF-8), have demonstrated promising ORR activity approaching that of Pt. The claimed active sites FeNₓ disperse densely and uniformly throughout the electrode, easily accessible by O₂ fluxes. However, their poor stability under PEMFC operations becomes the fatal drawback, placing the development of PGM-free catalysts into an awkward scenario. Due to the ongoing debate about the nature of the active sites, the mechanism of PGM-free catalyst degradation is still poorly understood.

### SUMMARY OF THE DISCLOSURE

The present disclosure provides compositions, graphitic carbon materials and methods of making graphitic carbon materials; compositions comprising graphitic carbon materials and nanoparticles and methods of making the compositions; platinum cobalt nanoparticles and methods of making platinum cobalt nanoparticles. Also provided are catalyst materials and uses of the graphitic carbon materials, platinum cobalt nanoparticles, catalyst materials, and devices.

In an aspect, the present disclosure provides a graphitic carbon material. The graphitic carbon materials have a desirable amount of graphitization and porosity.

In an aspect, the present disclosure provides compositions. A composition may comprise a graphitic carbon material of the present disclosure and a plurality of nanoparticles. The graphitic carbon material may be a graphitic carbon material as described herein.

In an aspect, the present disclosure provides a method of making a graphitic carbon material of the present disclosure. The graphitic carbon material may be used to make a composition of the present disclosure.

In an aspect, the present disclosure provides methods of a making a composition. A composition may comprise a graphitic carbon material of the present disclosure and a plurality of nanoparticles.

In an aspect, the present disclosure provides devices. The device may comprise a graphitic carbon material of the present disclosure or a composition of the present disclosure. For example the device may be an electrode. The electrode may comprise an electrolyte membrane, a gas diffusion membrane, or a combination thereof. In other examples, the device is a fuel cell, an electrolysis device, or a battery. A battery may be a primary battery or a secondary battery. Non-limiting examples of batteries include ion-conducting batteries, such as, for example, lithium-ion batteries, and the like.

### BRIEF DESCRIPTION OF THE FIGURES

For a fuller understanding of the nature and objects of the disclosure, reference should be made to the following detailed description taken in conjunction with the accompanying figures.

FIG. 1 shows (a) a synthetic scheme for porous graphitic carbons (PGCs) derived from polymer hydrogel; TEM, HRTEM and STEM images of (b) Mn-PANI-PGC and (c) Mn-PANI-PPy-PGC at different magnifications.

FIG. 2 shows (a) Raman spectra, (b) N₂ adsorption/desorption plots, (c) corresponding pore size distributions, and high-resolution XPS (d) Nis, (e) C1s spectra for PGCs synthesized at different temperatures.

FIG. 3 shows STEM-EDS elemental mapping of (a) Mn-PANI-PPy-PGC and (b) Pt catalysts supported on Mn-PANI-PPy-PGC.

FIG. 4 shows (a) in-situ TEM images showing the evolution of Mn species in the Mn-PANI-PPy precursor at RT, 400, 800, 1000, and 1100° C. The regions of Mn species are highlighted by the yellow outlines. (b) In-situ HRTEM image series showing the sublimation process of a Mn particle at 1100° C. In-situ HRTEM images (c) showing the evolution of carbon in Mn-PANI-PPy precursor at heating temperatures of RT, 400, 800, 1000, and 1100° C. (some crystalized Mn particles are highlighted by yellow outlines); (d) of Pt/Mn-PANI-PPy-PGC at pyrolysis temperatures of RT, 400, 600, 800, and 1000° C.

FIG. 5 shows high-resolution XPS (a) N1s and (b) Pt 4f spectra of Pt catalysts supported on Mn-PANI-PGC and Mn-PANI-PPy-PGC; XANES and EXAFS spectra of Pt/Mn-PANI-PPy-PGC and Pt/C: (c) Comparison of Pt L3-edge XANES spectra for Pt/Mn-PANI-PPy-PGC, Pt/C and Pt foil, (d) Fourier-transformed magnitudes of Pt L3-edge EXAFS spectra in R space for Pt/Mn-PANI-PPy-PGC fitted with Pt—Pt and Pt—N scattering paths. (e) Optimized atomistic structures (side view) of a thirteen-Pt-atom cluster adsorbed on a pristine graphene layer (left) and an N-doped graphene layer (right).

FIG. 6 shows (a) oxygen reduction reaction (ORR) polarization plots for Pt/PGC catalysts and various commercial Pt/C catalysts, (b) the corresponding CV plots and the corresponding ECSA, and (c) the corresponding mass activities and specific activities at 0.9 V after IR correction; RDE potential cycling stability tests for (d) Pt/Mn-PANI-PPy-PGC, (e) TEC10V20E and (f) TEC10EA20E during high potential range (1.0-1.5 V).

FIG. 7 shows fuel cell performance of (b) Pt/Mn-PANI-PPy-PGC with a comparison with (a) a commercial Pt/C (TEC10V20E) during high potential ASTs; (c) corresponding comparison of carbon loss during those ASTs (total carbon content during testing: TEC10V20E—0.38 mg/cm², Pt/Mn-PANI-PPy-PGC—0.43 mg/cm², Pt/Mn-PANI-PGC—0.52 mg/cm²); (d) ECSA analysis during corresponding ASTs in MEAs.

FIG. 8 shows SEM images for two kinds of PGCs and their precursors.

FIG. 9 shows Raman spectra for different hydrogel based carbons derived from different metals with identical method.

FIG. 10 shows high-resolution XPS Mn 2p spectra of different PGCs derived from different temperature.

FIG. 11 shows more STEM-EDS mapping images for two kinds of PGCs.

FIG. 12 shows TEM images of Pt/Mn-PANI-PPy-PGC.

FIG. 13 shows XRD spectra of two kinds of Pt catalysts supported on Mn-PANI-PGC and Mn-PANI-PPy-PGC respectively.

FIG. 14 shows STEM images of Pt/Mn-PANI-PPy-PGC.

FIG. 15 shows in-situ STEM-EDS mapping images of Mn-PANI-PPy precursor at different temperatures.

FIG. 16 shows in-situ HRTEM images of Mn-PANI-PPy precursor at 800° C. (Mn species circled by curves).

FIG. 17 shows STEM-EDS elemental mapping of (Above) Pt/Mn-PANI-PPy-PGC and (Below) Pt/Mn-PANI-PGC. (Both catalysts were obtained after post heat treatments.)

FIG. 18 shows STEM-EDS elemental mapping of Pt/Mn-PANI-PPy-PGC.

FIG. 19 shows (a) EXAFS fitting result for Pt/Mn-PANI-PPy-PGC using Pt—Pt and Pt—N scattering paths in k space. (b) The EXAFS fitting result for Pt foil in R space. (c) The EXAFS fitting result for Pt foil in k space.

FIG. 20 shows EXAFS fitting results for Pt/C using different combinations of scattering paths (a) The EXAFS fitting results using Pt—Pt and Pt—O scattering paths in R space and, (b) k space (c) The EXAFS fitting results using Pt—Pt and Pt—C scattering paths in R space and, (d) k space.

FIG. 21 shows EXAFS fitting results for Pt/Mn-PANI-PPy-PGC using different combinations of scattering paths (a) The EXAFS fitting results using Pt—Pt and Pt—C scattering paths in R space and, (b) k space (c) The EXAFS fitting results using Pt—Pt, Pt—C and Pt—N scattering paths in R space and, (d) k space (e) The EXAFS fitting results using Pt—Pt and Pt—O scattering paths in R space and, (f) k space (g) The EXAFS fitting results using Pt—Pt, Pt—N and Pt—O scattering paths in R space and, (h) k space.

FIG. 22 shows optimized atomistic structures (top panel: top view; bottom panel: side view) and predicted binding energy of a single Pt atom adsorbed on an un-doped graphene layer on the top of (a) the center of a carbon ring, (b) a carbon atom, and (c) the middle point of two neighboring carbon atoms.

FIG. 23 shows optimized atomistic structures (top panel: top view; bottom panel: side view) and predicted binding energy of a single Pt atom adsorbed on an N-doped graphene layer on the top of (a) the doped graphitic N atom, (b) a carbon atom far-away from the doped graphitic N atom, (c) a carbon atom adjacent to the doped graphitic N atom, and (d) the middle point of two neighboring carbon atoms adjacent to the doped graphitic N atom.

FIG. 24 shows optimized atomistic structures (top panel: top view; bottom panel: side view) of a thirteen-Pt-atom cluster adsorbed on (a) an un-doped graphene layer and (b) an N-doped graphene layer.

FIG. 25 shows (a) charge density difference of N-doped graphene layer with respect to the superposition of atomic charge density; Charge density difference of Pt cluster adsorbed (b) on an undoped graphene layer and (c) on an N-doped graphene layer with respect to the superposition of the charge density of Pt cluster and graphene layer. The various regions refer to the increase and decrease in charge density. The isosurface level is set to be 0.015 e Å⁻³ in (a) and 0.007 e Å⁻³ in (b) and (c).

FIG. 26 shows ORR steady-state polarization plots (0.1 M HClO₄, 900 rpm) during high potential ASTs for Pt catalysts supported by different PGCs derived from various temperature.

FIG. 27 shows ORR steady-state polarization plots (0.1 M HClO₄, 900 rpm) during high potential ASTs for Pt catalysts supported by different hydrogel-based carbon derived from various metals.

FIG. 28 shows ORR steady-state polarization plots (0.1 M HClO₄, 900 rpm) during even higher potential ASTs (1.0-1.6 V) for different Pt catalysts.

FIG. 29 shows ORR polarization (0.1 M HClO₄, 900 rpm) and CV plots for Pt/Mn-PANI-PPy-PGC with and without post treatment; and the comparison of their stabilities.

FIG. 30 shows TEM and STEM-EDS images of Pt/Mn-PANI-PPy-PGC without post heat treatment and the corresponding particle size distribution.

FIG. 31 shows N2 adsorption/desorption plots and corresponding pore size distributions for different Pt/C compared with Pt/PGC.

FIG. 32 shows Raman spectra for different Pt/C compared with Pt/PGC.

FIG. 33 shows RDE potential cycling stability tests for Pt/Mn-PANI-PPy-PGC, TEC10V20E and TEC10EA20E during low potential range (0.6-1.0 V).

FIG. 34 show stability test results for different Pt/C and Pt/PGC, and their corresponding CV plots and change of ECSA.

FIG. 35 shows a comparison of the morphology and microstructure among (a) original Pt/Mn-PANI-PPy-PGC, and the ones after RDE potential cycling stability tests during (b) high potential range and (c) low potential range.

FIG. 36 shows corresponding Pt particle size distribution of (a) Pt/Mn-PANI-PPy-PGC and the ones after (b) high potential ASTs and (c) low potential ASTs, according to the TEM images in FIG. 35.

FIG. 37 shows ORR steady-state polarization plots (0.1 M HClO₄, 900 rpm) during high potential ASTs (1.0-1.5 V) for comparative Pt catalyst supported on N-doped multiwalled carbon nanotube (MWCNT).

FIG. 38 shows structures and morphologies of Pt/Mn-PANI-PPy-PGC after various ASTs.

FIG. 39 shows activity loss summary for fuel cell high potential ASTs at 0.8 V and 0.6 V.

FIG. 40 shows support stability AST results for different Pt/C catalysts, including E type (high surface area carbon support), V type (Vulcan carbon support), and EA type (Highly graphitized carbon support) supported Pt catalysts from TKK, from 1.0 to 1.5 V in MEAs.

FIG. 41 shows Pt/C catalyst durability ASTs (0.6-0.95 V, for 30,000 cycles) in MEAs for Pt/PGC developed in this work and other commercially available Pt/C catalysts.

FIG. 42 shows a graphical representation of a graphitic carbon material of the present disclosure.

FIG. 43 shows (a) comparison of the morphology and microstructure; (b) XRD spectra; (c) ORR polarization plots in 0.5 M H₂SO₄ at 25° C. and 900 rpm among different ZIF-8_Fe (˜100 nm) heat treated with different durations.

FIG. 44 shows schematics of Pt/Z8_Fe (PtCo/Z8_Fe) catalysts, showing coexistence of Pt-based NPs and FeN₄ PGM-free active sites.

FIG. 45 shows an illustration of the facile method of synthesizing different intermetallic structures of PtCo catalysts.

FIG. 46 shows (a) ORR polarization plots for Pt(PtCo)/Z8_Fe catalysts and commercial Pt/C catalysts, (b) the corresponding CV plots and the corresponding ECSA, and (c) the corresponding mass activities and specific activities at 0.9 V after IR correction; RDE potential cycling stability tests for (d) PtCo(L1₀)/Z8_Fe and (e) PtCo(L1₂)/Z8_Fe in the potential range of 0.6-1.0 V; (f) XRD spectra of different ZIF-8_Fe supported Pt-based catalysts.

FIG. 47 shows (a) Fuel cell performance of Pt/Z8_Fe supported on various ZIF-8_Fe with various particle size; (b) Fuel cell performance comparison between Pt/Z8_Fe (100 nm) and commercial Pt/C (TEC10V20E).

FIG. 48 shows TEM, STEM images with STEM-EDS elemental mapping of ZIF-8_Fe carbon support material (heat treated for 3 h (hour)).

FIG. 49 shows N₂ adsorption/desorption plots and the corresponding pore size distributions of typical Z8_Fe carbon support.

FIG. 50 shows Raman spectra of different ZIF-8_Fe carbon support with different duration of high temperature treatments.

FIG. 51 shows ORR steady-state polarization plots of PtCo(L1₀)/Z8_Fe, PtCo(L1₀)/Z8_Co and PtCo(L1₀)/Z8, and their stability testing results during ADTs.

FIG. 52 shows (a) beginning-of-Life (BOL) polarization curves for L1₀-CoPt/NPGC, L1₀-CoPt/HSC, and Pt/HSC catalysts performed under 500/2000 sccm H₂/air at 80° C. cell temperature, 150 kPa back pressure, and 100% RH. (b) BOL polarization curves for L1₀-CoPt/NPGC and L1₀-CoPt/HSC collected under 500/2000 sccm H₂/air at 80° C. cell temperature, 250 kPa back pressure, and 100% RH; the insets indicate rated power densities for each catalyst. (c)-(e) show ECSAs, current densities at 0.8 V (interpolated from polarization curves in (a)), and mass activities (measured under 500/2000 sccm H₂/O₂ at 80° C., 150 kPa back pressure, and 100% RH at 0.9 V) for these three catalysts at BOL cycle, respectively.

FIG. 53 shows (a) end-of-Life (EOL) polarization curves for L1₀-CoPt/NPGC, L1₀-CoPt/HSC, and Pt/HSC catalysts performed under 500/2000 sccm H₂/air at 80° C. cell temperature, 150 kPa back pressure, and 100% RH. (b)-(d) show the performance loss (change from BOL to EOL) in mass activities (measured under 500/2000 sccm H₂/O₂ at 80° C., 150 kPa back pressure, and 100% RH at 0.9 V), potentials at 0.8 A/cm² (interpolated from polarization curves in (a)), and ECSAs for these three catalysts, respectively.

FIG. 54 shows (a) BOL polarization curves for L1₀-CoPt/NPGC, L1₀-CoPt/Vulcan, and Pt/Vulcan catalysts performed under 500/2000 sccm H₂/air at 80° C. cell temperature, 150 kPa back pressure, and 100% RH. (b)-(d) show rated power densities (interpolated from polarization curves in (a) at 0.67 V), ECSAs, and mass activities (measured under 500/2000 sccm H₂/O₂ at 80° C., 150 kPa back pressure, and 100% RH at 0.9 V) for these three catalysts at BOL cycle, respectively.

FIG. 55 shows (a) EOL polarization curves for L1₀-CoPt/NPGC, L1₀-CoPt/Vulcan, and Pt/Vulcan catalysts performed under 500/2000 sccm H₂/air at 80° C. cell temperature, 150 kPa back pressure, and 100% RH. (b)-(d) show the performance loss (change from BOL to EOL) in mass activities (measured under 500/2000 sccm H₂/O₂ at 80° C., 150 kPa back pressure, and 100% RH at 0.9 V), potentials at 0.8 A/cm² (interpolated from polarization curves in (a)), and ECSAs for these three catalysts, respectively.

FIG. 56 shows (a) synthesis scheme of this FeN₄—C derived carbon-supported Pt or PtCo catalysts. (b) Schematics of Pt/FeN₄—C(Pt—Co/FeN₄—C) catalysts, showing coexistence of Pt-based NPs and FeN₄ PGM-free active sites. (c-e) STEM images of the Pt/FeN₄—C catalyst showing the uniform distribution of Pt nanoparticles and the coexistence with FeN₄ sites. (f) EELS analysis of the elemental composition were provided for the circled little bright spots in (e).

FIG. 57 shows (a) illustration of Pt₃Co(L1₂) intermetallic structures synthesis. (b) XRD spectra of two different catalysts. (c-e) STEM images of the Pt₃Co/FeN₄—C NPs showing the corresponding core-shell ordering structures and NPs distribution; HAADF-STEM images of (d). The Pt₃Co/FeN₄—C catalyst showing the coexistence of intermetallic NPs and FeN₄ sites and the EELS analysis of the elemental composition were provided for the circled small bright spot in the (d).

FIG. 58 shows X-ray photoelectron spectroscopy analysis of (a) Pt 4f, (b) N 1s, and (c) Fe 2p for various studied Pt-based catalysts. (d) X-ray scattering curves in the small-angle (SAXS) region. (e) Metal particle volume distributions obtained from SAXS data fits, and (f) Wide-angle X-ray scattering (WAXS) curves for the Pt/FeN₄—C and the Pt₃Co/FeN₄—C.

FIG. 59 shows (a) ORR polarization plots for FeN₄—C supported Pt and Pt₃Co catalysts and commercial Pt/C catalyst. (b) The corresponding CV plots and the corresponding ECSA, and (c) the corresponding mass activities and specific activities at 0.9 V after IR correction. RDE potential cycling stability tests for (d) the Pt/NC, (e) the Pt/FeN₄—C, and (f) the Pt₃Co/FeN₄—C catalysts in the potential range of 0.6-1.0 V.

FIG. 60 shows (a) H₂-air fuel cell polarization plots for different Pt catalysts supported on FeN₄—C carbon supports with different sizes. (b) H₂-air fuel cell polarization and power density plots for various catalysts supported on the 100 nm FeN₄—C support. BOL and EOL fuel cell polarization and power density plots comparisons during voltage cycles (0.6-0.95V) for (c) the Pt/C(XC-72), (d) the Pt/FeN₄—C, and (e) the Pt₃Co/FeN₄—C. (f) MEA MAs at 0.9 V_{iR-free} before (solid) and after (hatched) 30 k voltage cycles for these studied catalysts; DOE's MA targets for before (green dashed line, 0.44 A/mg_{PT}) and after (red dashed line, 0.264 A/mg_{PT} or 40% of the initial value) AST; Voltage loss at 0.8 A/cm² were also indicated with DOE targets for less than 30 mV (solid magenta line).

FIG. 61 shows STEM and HAADF-STEM images and EELS analysis of the elemental composition of (a-c) the Pt/FeN₄—C catalyst and (d-g) the Pt₃Co/FeN₄—C catalysts in MEAS after 30,000 voltage cycles (0.6-0.95 V) under an H₂/N₂ atmosphere. (h) X-ray scattering curves in the SAXS region; (i) Metal particle volume distributions obtained from SAXS data fits and (j) WAXS curves for fresh Pt₃Co/FeN₄—C and after 30,000 voltage cycles (0.6-0.95 V) in an MEA.

FIG. 62 shows optimized atomic structures of (a) a thirteen atom Pt₁₃ cluster adsorbed on a FeN₄ moiety embedded in a graphene layer and (b) a four atom Pt₄ cluster adsorbed on different locations of a FeN₄ moiety embedded in a graphene layer. (c) Charge density difference map showing significant charge transfer near Pt—C and Pt—Fe bond. The iso-surface level is 0.01 eV/A3. Yellow and cyan represent electrons accumulation and depletion, respectively. (d) Atomic structure of Pt (111) surface modified by an adsorbed FeN₄ moiety. The active site for ORR is marked with an adsorbed 0 atom. The black, blue, orange, red, and grey balls represent the C, N, Fe, 0, and Pt atoms, respectively.

FIG. 63 shows (a) Comparison of the morphology and microstructure; (b) XRD spectra; (c) ORR polarization plots in 0.5 M H₂SO₄ at 25° C. and 900 rpm among different ZIF-8_Fe (˜100 nm) heat treated with different durations.

FIG. 64 shows more TEM images of ZIF_Fe derived carbon support with 3 h pyrolysis (FeN₄—C).

FIG. 65 shows Raman spectra of different ZIF-8_Fe carbon support with different duration of high temperature treatments.

FIG. 66 shows TEM, STEM images with STEM-EDS elemental mapping of FeN₄—C carbon support material (heat treated for 3 h).

FIG. 67 shows STEM images and particle size distribution of corresponding Pt-based NPs for (a) Pt/FeN₄—C and (b) Pt₃Co/FeN₄—C.

FIG. 68 shows more HAADF-STEM images Pt/FeN₄—C showing the coexistence of Pt nanoparticles and FeN₄ active sites.

FIG. 69 shows STEM-EDX mapping of the Pt/FeN₄—C catalysts.

FIG. 70 shows STEM-EDX mapping of the Pt₃Co/FeN₄—C.

FIG. 71 shows STEM-EDX mapping of the Pt₃Co/FeN₄—C.

FIG. 72 shows RDE potential cycling stability tests for Pt/FeN₄—C, Pt/CoN₄—C and Pt/NC in the potential range of 0.6-1.0 V.

FIG. 73 shows Raman spectra of different carbon material derived from ZIF_Fe (FeN₄—C) and ZIF_Co (CoN₄—C) and pristine ZIF-8 (NC) respectively.

FIG. 74 shows ORR steady-state polarization plots of PtCo/FeN₄—C, PtCo/CoN₄—C and PtCo/NC, and their stability testing results during ADTs.

FIG. 75 shows pore size distribution of different Fe doped ZIF-8 derived carbon supports.

FIG. 76 shows STEM images of Pt/FeN₄—C after 30 k AST showing the coexistence of Pt nanoparticles and FeN₄ active sites. No obvious agglomeration was observed.

FIG. 77 shows STEM-EDX mapping of Pt/FeN₄—C after 30 k AST.

FIG. 78 shows (a) Pt L3 edge XANES; (b) Co K edge k²-weighted EXAFS for various catalysts. (c) EXAFS Fourier transform magnitude for Pt₃Co/FeN₄—C, showing the data, fit and R-space fitting window (k² weighting, k-range=3.0-13.5 Å⁻¹). Individual single-scattering path components are shown offset for clarity. Fit results given in Table 9.

FIG. 79 shows atomic structures of (a) metal, nitrogen co-doped graphene, denoted as MN₄—C(M=Fe, Co), and (b) nitrogen doped graphene, denoted as N₄—C. In these figures, the black, blue, orange, and white balls represent the C, N, M, and H atoms, respectively.

FIG. 80 shows optimized atomic structures of (a) Pt/CoN₄—C, (b) Pt/N₄—C, and (c) Pt/C. In these figures, the black, blue, yellow, grey, and white balls represent the C, N, Co, Pt, and H atoms, respectively.

FIG. 81 shows ORR activity of different carbon substrates studied in this work to promote Pt and Pt₃Co intermetallic catalysts.

FIG. 82 shows optimized atomic structures of (a) MN₄@ Pt(111) and (b) N₄@Pt(111). In these figures, the black, blue, orange, grey, and white balls represent the C, N, M (Fe, Co), Pt, and H atoms, respectively.

FIG. 83 shows optimized atomic structure of 0 adsorption on (a) CoN₄@Pt(111) and (b) N₄@Pt(111). In these figures, the black, blue, yellow, grey, red and white balls represent the C, N, Co, Pt, O and H atoms, respectively.

### DETAILED DESCRIPTION OF THE DISCLOSURE

Although claimed subject matter is described in terms of certain examples, other examples, including examples that do not necessarily provide all of the benefits and features set forth herein, are also within the scope of this disclosure. Various structural, logical, and process step changes may be made without departing from the scope of the disclosure.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent and multivalent, such as, for example, divalent radicals, trivalent radicals, and the like). Illustrative examples of groups include:

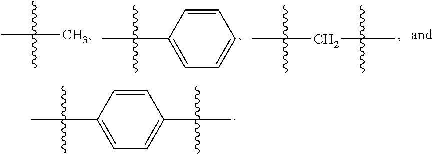

Throughout this application, the use of the singular form encompasses the plural form and vice versa. For example, “a”, or “an” also includes a plurality of the referenced items, unless otherwise indicated.

The present disclosure provides compositions, graphitic carbon materials and methods of making graphitic carbon materials; compositions comprising graphitic carbon materials and nanoparticles and methods of making the compositions; platinum cobalt nanoparticles and methods of making platinum cobalt nanoparticles. Also provided are catalyst materials and uses of the graphitic carbon materials, platinum cobalt nanoparticles, catalyst materials, and devices.

In an aspect, the present disclosure provides a graphitic carbon material. The graphitic carbon materials have a desirable amount of graphitization and porosity.

A graphitic carbon material of the present disclosure may comprise various domains of graphitic carbon and amorphous carbon. In various examples, at least 85% of the carbon is graphitic carbon (e.g., 85-95%, inclusive (including all 0.1% values and ranges therebetween)) and the remainder may be amorphous carbon (e.g., 5-15%, inclusive (including all 0.1% values and ranges therebetween)). The graphitic carbon material may be defined by its graphitic content. The graphitic content may be represented by the ratio of the intensity of the D band (e.g., Raman peak maximum about 1350 cm⁻¹ (e.g., 1340-1360 cm⁻¹)) and G band (e.g., Raman peak maximum about 1590 cm⁻¹ (e.g., 1580-1600 cm⁻¹)) as determined by Raman spectroscopy (I_{D}/I_{G}). The D band is associated with structural defects in graphene and graphene-like materials and the G band is associated with C—C bond stretching of graphitic carbon. Graphitic carbon material of the present disclosure may have an I_{D}/I_{G} of 1-10, including all 0.01 ratio values and ranges therebetween (e.g., 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0). The total carbon content of the graphitic carbon material is at least 90 at % carbon (e.g., at least 90, at least 91, at least 92, at least 93, at least 94, or at least 95 at %).

The graphitic carbon material of the present disclosure may have a hierarchical porosity and has a desirable surface area. The term hierarchical porosity, refers to the graphitic carbon materials may have two or more pore scale ranges. For example, the graphitic carbon material may have any combination of mesopores, macropores, and micropores (e.g., i) mesopores, macropores, and micropores; ii) mesopores and macropores; iii) mesopores and micropores; or iv) micropores and macropores). The graphitic carbon material may be defined by its porosity (or a combination of its porosity and graphitic content). For example, the graphitic carbon may have a specific surface area of 350-550 m²/g, inclusive (including all 0.1 m²/g values and ranges therebetween) (e.g., 450±50 m²/g) and/or a cumulative pore volume of 0.70±0.1 cm³/g. In various other examples, the surface area is up to 700 m²/g. The graphitic carbon material may have mesopores (2-50 nm in size), macropores (greater than 50 nm in size), micropores (less than 2 nm in size), or a combination thereof. The terms “mesopores,” “macropores,” and “micropores” are used as defined by International Union of Pure and Applied Chemistry (IUPAC). Each pore of the plurality of pores may have a longest linear dimension or diameter of 1-75 nm, inclusive (including all 0.1 nm values and ranges therebetween). The pores may be formed by the removal of a metal graphitization catalyst (e.g., Mn). Various metal graphitization catalysts may be used.

The graphitic carbon material may be a plurality of carbon particles. The carbon particles may have a longest linear dimension of 100-300 nm, inclusive (including all 0.1 nm values and ranges therebetween). In other examples, the carbon particles may have a longest linear dimension of 20 to 1000 nm, inclusive (including all 0.1 nm values and ranges therebetween). The carbon material may be a three-dimensional (3D) carbon material. In various examples, the carbon material is a monolith, a film, or the like. The carbon material may have curly multilayer structures, flower (rose)-like structures, or the like, or a combination thereof. The graphitic carbon material may exhibit irregularly folded carbon layers, flower-like graphitic carbon structures, curly multilayer graphitic carbon structures, or the like, or a combination thereof.

The graphitic carbon material may be doped. For example, the graphitic carbon material may be N-doped and/or comprise a metal (e.g., metal binding sites (e.g., M-Nₓ groups, where M is a metal, such as, for example, Fe or Co)). In various examples, the graphitic material comprises a metal (e.g., metal-doped, such as, for example Fe-doped) and is also N-doped. In various other examples, the graphitic material is only N-doped. When the graphitic carbon material is N-doped, it may be doped by one or more N-dopants. The one or more N-dopants may be chosen from graphitic N-dopants, pyridinic N-dopants, NOₓ species, and combinations thereof. Examples of these groups include pyridinic-N at edges of carbon planes, graphitic-N doped in the interior of the graphitic planes, and oxidized pyridinic-N associated with oxygen. Such N-doped graphitic carbon materials may be formed by a method of the present disclosure. Such a method may include formation from polymerization of aniline (e.g., polyaniline (PANT)) and pyrrole (e.g., polypyrrole (PPy)) with a graphitization metal catalyst (e.g., Mn) and subsequent heat treatment and/or acid leaching. The N-dopant may be present at 0.2-0.5 at %, inclusive (including all 0.01% values and ranges therebetween). In various other examples, the graphitic carbon material comprises a metal (e.g., metal binding sites or active site). The metals may part of M-Nₓ groups, where M is a metal, such as, for example, Fe or Co and x is 1 to 10 (e.g., 1, 2, 3, 4, 5, 6, 7, 8, 9, 10, (e.g., 1-4)). An example of an M-Nₓ group is FeN₄. These groups may be formed from a derivatized ZIF-8 support material. For example, ZIF supports (e.g., ZIF-8) may be doped with iron (e.g., Fe³⁺) and pyrolyzed to form an Fe-doped ZIF support having FeN₄ active sites. Examples of graphitic carbon materials that are metal- and N-doped include ZIF derivatized materials as described herein.

In an aspect, the present disclosure provides compositions. A composition may comprise a graphitic carbon material of the present disclosure and a plurality of nanoparticles. The graphitic carbon material may be a graphitic carbon material as described herein.

The composition may comprise various nanoparticles. The metal nanoparticles may be an alloy of two or more metals. Non-limiting examples of metal nanoparticles include platinum nanoparticles, platinum/transition metal (TM) nanoparticles, and the like, and combinations thereof. A Pt/TM nanoparticle may comprise platinum atoms and one or more first row transition metal atoms(s), where the platinum atoms and first row transition metal atoms form an intermetallic structure. The intermetallic structure may be an ordered intermetallic structure. In various examples, the platinum atoms and first row transition metal atoms are not randomly oriented and/or disordered. Non-limiting examples of first row transition metal atoms include cobalt, iron, nickel, and the like, and combinations thereof. In various examples, the Pt/TM nanoparticle is a Pt/Co nanoparticle. The Pt/TM nanoparticle may be disposed on a carbon support material (e.g., a graphitic carbon material of the present disclosure). The nanoparticle may be spherical or the like. Non-limiting examples of platinum/TM nanoparticles include intermetallic L1₀ PtCo nanoparticles, L1₂ Pt₃Co nanoparticles, and the like, and combinations thereof. The nanoparticles may be present at 5 to 80% by weight (e.g., 10 to 70%, 10 to 80%, 15 to 55%, or 15 to 655% by weight) (based on the total weight of the carbon material and metal nanoparticles), including all 0.1% by weigh values and ranges therebetween. A nanoparticle has at least one dimension (which may be a longest dimension) of 1 to 10 nm, including all 0.1 nm values and ranges therebetween (e.g., 3 to 10 nm). The nanoparticle may have a cubic structure, tetragonal structure, or the like. The nanoparticles may have uniform size distribution. For example, the nanoparticles have a size of uniform distribution with an average size of 2-5 nm, inclusive (including all 0.1 nm values and ranges therebetween) (e.g., 2.4 nm or 4.2 nm).

The structure of intermetallic nanoparticles (e.g., Pt₃Co nanoparticles) may be controlled by its synthesis method. To control the intermetallic structures, a second step annealing process is utilized (e.g., annealing at 650° C. in an inert atmosphere (e.g., Ar atmosphere)). Excess cobalt of Pt₃Co nanoparticles may be removed using acid washes as described herein.

The composition may be referred to as a catalyst material. The catalyst materials may be used in devices such as, for example, fuel cells, electrolysis devices, batteries (which may be primary batteries or secondary batteries, such as, for example, an ion-conducting batteries (e.g., lithium-ion batteries), and the like. The compositions may be used in oxygen reduction reaction (ORR) applications. The catalyst materials may be ORR catalyst materials. The composition may have a conductivity of 1.5 to 2.5×10⁵ σ (S/m), inclusive (including all 0.01×10⁵ σ values and ranges therebetween).

In an aspect, the present disclosure provides a method of making a graphitic carbon material of the present disclosure. The graphitic carbon material may be used to make a composition of the present disclosure.

A method of making a graphitic carbon material of the present disclosure may comprise providing a mixture (e.g., a hydrogel comprising water) and thermally treating the mixture (e.g., heating the mixture to 1050-1110° C., inclusive (including all 0.1° C. values and ranges therebetween) (e.g., 1090-1110° C.). The reaction mixture may comprise one or more polyanilines; one or more polypyrroles; and a metal graphitization catalyst (e.g., Fe, Co, Ni, Mn, or the like). In various examples, the metal graphitization catalyst is Mn. The mixture may comprise crosslinked (e.g., highly crosslinked) polyaniline(s) and/or polypyrrole(s). The crosslinking may be intrachain crosslinking, interchain crosslinking, or a combination thereof. In various examples, the mixture is a network of crosslinked polyaniline(s) and polypyrrole(s). The mixture may comprise folded polymer nanostructures. Without intending to be bound by any particular theory, it is considered that the metal graphitization catalyst(s) provide(s) desirable graphitization during the thermal treatment of the mixture, which may be a hydrogel. In various examples, the mixture is a polyaniline-polypyrrole hydrogel. In various examples, the hydrogel comprises 60 to 80 wt % water (based on the total weight of the reaction mixture), including all 0.1 wt. % values and ranges therebetween. In various examples, the polyaniline(s) have a molecular weight (e.g., Mw and/or Mn) of 180,000 g/mol. The polyanilines and/or polypyrroles may be prepared in situ. The mixture may be prepared by providing a reaction mixture comprising aniline, pyrrole, a metal graphitization catalyst (e.g., Fe, Co, Ni, Mn, or the like) and, optionally, one or more polymerization catalysts, and, optionally, one or more solvents and the reaction mixture may be held at a temperature of 18-24° C., inclusive (including all 0.1° C. values and ranges therebetween), where the polyanilines and polypyrroles are formed. A polymerization catalyst may catalyze a radical polymerization, thermal polymerization, ionic polymerization, or the like. In various examples, a polymerization catalyst is a radical polymerization catalyst, a thermal polymerization catalyst, a ionic polymerization catalyst, or the like. Suitable examples of catalysts are known in the art. Non-limiting examples of polymerization catalysts include radical polymerization catalysts, such as, for example, persulfates (such as, for example, ammonium persulfate, and the like), hydrogen peroxide, metal ions (such as, for example, ferric ions (Fe⁺) and the like), and the like, and combinations thereof. In various examples, the polyaniline:polypyrrole ratio is from 4 to 2, including all 0.1 ratio values and ranges therebetween. Non-limiting examples of solvents include HCl solutions, H₂SO₄ solutions, and the like, and combinations thereof. A solution may be a dilute acid solution. A polymerization reaction may be carried out at room temperature (e.g., 18-24° C.) and/or for about 24 hours. The method further comprises removing a portion of water from the mixture (e.g., removing water from the hydrogel). The removed portion of water may be substantially all or all of the water of the hydrogel. By “substantially all” it is meant that at least 99%, at least 99.5%, or at least 99.9% of the water is removed from the hydrogel. The method may further comprise acid washing the graphitic carbon material. Acid washing may remove the metal graphitization catalyst. Following acid washing, the graphitic carbon material may be further thermally treated (e.g., heated at a temperature of 900-1110° C., inclusive (including all 0.1° C. values and ranges therebetween)).

The balance of porosity and graphitization may be tuned by adjusting the method parameters. For example, varying the ratio of PANI and PPy. Additionally, increasing the temperature during the method may increase the graphitic content while lowering the porosity, whereas decreasing the temperature may increase the porosity while decreasing the graphitic content.

In an aspect, the present disclosure provides methods of a making a composition. A composition may comprise a graphitic carbon material of the present disclosure and a plurality of nanoparticles.

A method of making a composition may comprise forming a reaction mixture, dehydrating the reaction mixture to form a powder, thermally treating the powder, and annealing the powder. The reaction mixture may comprise an aqueous solution of the graphitic carbon material and one or more nanoparticle sources (e.g., metal sources, such as, for example, a platinum source and/or a cobalt source). The thermally treating may be performed in a reducing atmosphere. In various examples, the Pt/TM nanoparticle/nanoparticles are formed in situ in the presence of the carbon material. Non-limiting examples of platinum sources include acids, such as, for example, hexachloroplatinic acid, and the like, and combinations thereof, platinum salts, and the like, and combinations thereof. The platinum source(s) may be water soluble. Non-limiting examples of cobalt sources include cobalt salts, such as, for example, cobalt(II) chloride, cobalt (II) nitrate, and the like, and combinations thereof. A cobalt salt may be a hydrate. The cobalt source(s) may be water soluble. Non-limiting examples of carbon materials include ZIF-8_Fe derived support materials, other carbon materials described herein, and the like, and combinations thereof. In various examples the platinum source:cobalt source molar ratio is from 0.33 to 0.5, inclusive (including all 0.01 ratio values and ranges therebetween). It may be desirable to have a molar excess of platinum source(s) relative to the amount of cobalt source(s). The dehydration may be carried out by freeze-drying, or the like. The Pt/TM nanoparticle/nanoparticles may be annealed in a gas atmosphere. Normal acid leaching may be conducted (e.g., to remove excess transition metal species), followed by post treatment under an inert atmosphere (e.g., under argon at 400° C. for 1 hour). The structure of intermetallic nanoparticles (e.g., Pt₃Co nanoparticles) may be controlled by its synthesis method. To control the intermetallic structures, a second step annealing process is utilized (e.g., annealing at 650° C. in an inert atmosphere (e.g., Ar atmosphere)). Excess cobalt of Pt₃Co nanoparticles may be removed using acid washes as described herein.

The thermal treatment of the powder is carried out in a reducing atmosphere. Non-limiting examples of reducing atmospheres include a hydrogen gas atmosphere, forming gas (a mixture of hydrogen and argon), and the like, and combinations thereof. In various examples, the thermal treatment is carried out at a temperature of 200 to 350° C., including all 0.1° C. values and ranges therebetween, and/or for 3-6 hours, including all 0.1 hour values and ranges therebetween.

Thermal treatment of the thermally-treated powder (e.g., annealing) may be carried out in an inert gas atmosphere (such as, for example, argon, or the like, or a combination thereof), a reducing gas atmosphere, or the like. In various examples, the thermal treatment of the thermally-treated powder is carried out at a temperature of 600° C. or less (e.g., 550° C. to 700° C.) and for 3-6 hours. Without intending to be bound by any particular theory, it is considered that selection of the gas of the gas atmosphere can provide desired nanoparticle structure. Normal acid leaching (e.g., using diluted HClO₄) may be conducted to remove excess transition metal species, followed by post treatment (e.g., under argon at 400° C. for 1 hour).

In various examples, nanoparticles may be applied to the graphitic carbon materials through deposition methods known in the art. For example, impregnation is used.

In an aspect, the present disclosure provides devices. The device may comprise a graphitic carbon material of the present disclosure or a composition of the present disclosure. For example the device may be an electrode. The electrode may comprise an electrolyte membrane, a gas diffusion membrane, or a combination thereof. In other examples, the device is a fuel cell, an electrolysis device, or a battery. A battery may be a primary battery or a secondary battery. Non-limiting examples of batteries include ion-conducting batteries, such as, for example, lithium-ion batteries, and the like.

The steps of the method described in the various examples disclosed herein are sufficient to carry out the methods of the present disclosure. Thus, in an example, a method consists essentially of a combination of steps of the methods disclosed herein. In another example, a method consists of such steps.

The following Examples provide various embodiments of the present disclosure:
Example A. A carbon material comprising a nitrogen-doped graphitic carbon, where the carbon material has hierarchical porosity and abundant specific surface area. In various examples, the carbon material further comprises amorphous carbon (e.g., the remainder of the carbon is amorphous carbon). A carbon material may be a plurality of carbon particles. The individual carbon particles may have a linear dimension (which may be a longest linear dimension) of 100 nm to 300 nm, including all 0.1 nm values and ranges therebetween. The carbon material may be a three-dimensional (3D) carbon material. In various examples, the carbon material is a monolith, a film, or the like. The carbon material may have curly multilayer structures, flower (rose)-like structures, or the like, or a combination thereof. The carbon material may be a carbon support material (e.g., a carbon support material for an electrode, such as, for example, an oxygen reduction reaction (ORR) electrode, which may be used in a device (e.g., a fuel cell, an electrolysis device, a battery (which may be a primary battery or a secondary battery, such as, for example, an ion-conducting battery (e.g., a lithium-ion battery), and the like). In various examples, a carbon material is made by a method of the present disclosure.
Example B. A carbon material according to Example A, where the carbon material comprises at least 85% (e.g., 85 to 95%, including all 0.1% values and ranges therebetween) graphitic carbon (based on the total amount of graphitic carbon and amorphous carbon) and may comprise 5 to 15%, including all 0.1% values and ranges therebetween, amorphous carbon (based on the total amount of graphitic carbon and amorphous carbon). The percentage may be percent by weight based on the total amount of graphitic carbon and amorphous carbon. In various examples, the amount of graphitic carbon is determined by the ratio of one or more peaks in the Raman spectroscopy of the carbon material). In various examples, the amount of graphitic carbon is determined by the peak intensity ratio (I_{(D)}/I_{(G)}) of the D band (e.g., peak maximum about 1350 cm⁻¹ (e.g., 1340-1360 cm⁻¹)) to the G band (e.g., peak maximum about 1590 cm⁻¹ (e.g., 1580-1600 cm⁻¹)). The peak intensities may be determined by methods known in the art, such as, for example, Raman mapping.
Example C. A carbon material according to Examples A or B, where the carbon material comprises a plurality of pores chosen from mesopores (2-50 nm in size), macropores (greater than 50 nm in size), micropores (less than 2 nm in size), or a combination thereof, and/or a specific surface area of 450±50 m²/g, and/or a cumulative pore volume of 0.70±0.1 cm³/g. The mesopores and/or macropores and/or micropores have an individual pore size (e.g., a linear dimension of the pore, which may be a longest dimension) as defined by IUPAC. In various examples, the carbon material also comprises pores formed by removal of the metal graphitization catalyst(s).
Example D. A carbon material according to any one of Examples A-D, the carbon material further comprising one or more nitrogen (N)-dopant(s). Non-limiting examples of N-dopant include graphitic N-dopants, pyridinic N-dopants, NOₓ species, and the like, and combinations thereof.
Example E. A carbon material according to Example D, where the N-dopants(s) is/are present at 0.2 to 0.5 at % (atomic conc. %), including all 0.01 values and ranges therebetween.
Example F. A carbon material according to any one of the preceding Examples, where the carbon material exhibits irregularly folded carbon layers, flower-like graphitic carbon structures, curly multilayer graphitic carbon structures, or the like, or a combination thereof.
Example G. A carbon material according to any one of Examples A-F, where the carbon material exhibits a conductivity of 1.5 to 2.5×10⁵ σ (S/m).
Example H. A carbon material according to any one of Examples A-G, where the carbon material comprises a plurality of metal nanoparticles disposed on at least a portion of a surface of the carbon material. The metal nanoparticles may be an alloy of two or more metals. Non-limiting examples of metal nanoparticles include platinum nanoparticles, platinum/TM metal nanoparticles (e.g., platinum/TM nanoparticles of the present disclosure, such as, for example, platinum/TM nanoparticles of any one of Examples T-V or platinum/TM nanoparticles made by a method of Examples W or X) of any one of Examples T-V), and the like, and combinations thereof. Non-limiting examples of platinum/TM nanoparticles including intermetallic L10 PtCo nanoparticles, L1₂ Pt₃Co nanoparticles, and the like, and combinations thereof. This carbon material may be referred to as a catalyst material. The catalyst materials may be used in devices such as, for example, fuel cells, electrolysis devices, batteries (which may be primary batteries or secondary batteries, such as, for example, an ion-conducting batteries (e.g., lithium-ion batteries), and the like.)
Example I. A carbon material according to any one of Examples A-H, where the metal nanoparticles are present at 5 to 80% by weight (e.g., 10 to 70%, 10 to 80%, 15 to 55%, or 15 to 65% by weight) (based on the total weight of the carbon material and metal nanoparticles), including all 0.1% by weight values and ranges therebetween.
Example J. A method of making a carbon material (e.g., a carbon material of the present disclosure, such as, for example, a carbon material of any one of Examples A-I) comprising: providing a mixture comprising one or more polyaniline(s), which, independently, may be a crosslinked polyaniline; one or more polypyrrole(s), which, independently, may be a crosslinked polypyrrole; and one or more metal graphitization catalyst(s); and thermally treating the mixture, where the carbon material (which may be referred to as a polyaniline-polypyrrole composite material) is formed. The mixture may comprise crosslinked (e.g., highly crosslinked) polyaniline(s) and/or polypyrrole(s). The crosslinking may be intrachain crosslinking, interchain crosslinking, or a combination thereof. In various examples, the mixture is a network of crosslinked polyaniline(s) and polypyrrole(s). The mixture may comprise folded polymer nanostructures. Without intending to be bound by any particular theory, it is considered that the metal graphitization catalyst(s) provide(s) desirable graphitization during the thermal treatment of the mixture, which may be a hydrogel. Non-limiting examples of metal graphitization catalyst(s) include Fe, Co, Ni, Mn, and the like, and combinations thereof. In various examples, the metal graphitization catalyst is Mn. In various examples, the mixture is a polyaniline-polypyrrole hydrogel. In various examples, the hydrogel comprises 60 to 80 wt % water (based on the total weight of the reaction mixture), including all 0.1 wt. % values and ranges therebetween. In various examples, the polyaniline(s) have a molecular weight (e.g., Mw and/or Mn) of 180,000 g/mol.
Example K. A method according to Example K, where one or more or all of the polyaniline(s) and/or one or more or all of the polypyrrole(s) are formed in situ.
Example L. A method according to Example K, where the mixture is formed by providing a reaction mixture comprising aniline, pyrrole, one or more metal graphitization catalyst(s), optionally, one or more polymerization catalyst(s), and optionally, one or more solvent(s); and holding the reaction mixture (e.g., at a selected time and temperature), where the polyaniline(s) and polypyrrole(s) are formed. A polymerization catalyst may catalyze a radical polymerization, thermal polymerization, ionic polymerization, or the like. In various examples, a polymerization catalyst is a radical polymerization catalyst, a thermal polymerization catalyst, a ionic polymerization catalyst, or the like. Suitable examples of catalysts are known in the art. Non-limiting examples of polymerization catalysts include radical polymerization catalysts, such as, for example, persulfates (such as, for example, ammonium persulfate, and the like), hydrogen peroxide, metal ions (such as, for example, ferric ions (Fe⁺) and the like), and the like, and combinations thereof. In various examples, the polyaniline:polypyrrole ratio is from 4 to 2, including all 0.1 ratio values and ranges therebetween. Non-limiting examples of solvents include HCl solutions, H₂SO₄ solutions, and the like, and combinations thereof. A solution may be a dilute acid solution. A polymerization reaction may be carried out at room temperature (e.g., 18-24° C.) and/or for about 24 hours.
Example M. A method according to any one of Examples J-L, where the mixture is a hydrogel comprising water, and the method further comprises removing at least a portion of, substantially all, or all of the water from the hydrogel. By “substantially all” it is meant that at least 99%, at least 99.5%, or at least 99.9% of the water is removed from the hydrogel.
Example N. A method according to any one of Examples J-M, where the thermal treatment comprises heating the mixture at a temperature of 1100° C. or less (e.g., 1090 to 1110° C., including all 0.1° C. values and ranges therebetween). The thermal treatment may be referred to as carbonization or graphitization. The thermal treatment may be carried out in an inert gas atmosphere (such as, for example, a nitrogen atmosphere, argon atmosphere, or the like, or a combination thereof). The dehydrated sample may be thermally treated under an inert atmosphere (e.g., an argon atmosphere, a nitrogen atmosphere, or the like).
Example O. A method according to any one of Examples J-N, the method further comprising acid washing the carbon material. Without intending to be bound by any particular theory, it is considered that the acid washing removes at least a portion of, substantially all, or all of the metal catalyst(s). By “substantially all” it is meant that at least 99%, at least 99.5%, or at least 99.9% of the metal is removed from the carbon material. In various examples, the acid washing is carried out by contacting the carbon material with one or more acid(s), such as, for example, HCl solutions, H₂SO₄ solution, HNO₃ solution, or the like, which may be dilute solutions.
Example P. A method according to any one of Examples J-O, the method further comprising thermally treating the carbon material. In various examples, the thermal treatment comprises heating the carbon material mixture at a temperature of 1090 to 1110° C., including all 0.1° C. values and ranges therebetween. The thermal treatment may be carried out under an inert atmosphere, such as, for example, an argon atmosphere, a nitrogen atmosphere, or the like. After acid leaching, the sample may be post thermally treated, for example, at 900° C. for 3 hours. Without intending to be bound by any particular theory, it is considered that the post thermal treatment removes oxygen-containing function groups, which may result from acid leaching.
Example Q. A catalyst material (which may be an ORR catalyst material) comprising a plurality of metal nanoparticles disposed on a carbon material of the present disclosure (e.g., a carbon material of any one of Examples A-I and/or a carbon material made by a method of any one of Examples J-P).
Example R. A catalyst material according to Example Q, where the metal nanoparticles are chosen from platinum nanoparticles, platinum alloy nanoparticles (such as, for example, PtCo alloy, PtNi alloy, PtFe alloy nanoparticles, and the like), Pt/TM nanoparticles (which may be Pt/TM nanoparticles of the present disclosure, such as for example, Pt/TM nanoparticles of any one of Examples T-V and/or Pt/TM nanoparticles made by a method of any one of Examples W-Y), and the like, and combinations thereof
Example S. A catalyst material according to Examples Q or R, where the metal nanoparticles are present at 5 to 80% by weight (e.g., 10 to 70%, 10 to 80%, 15 to 55%, or 15 to 655% by weight) (based on the total weight of the carbon material and metal nanoparticles), including all 0.1% by weigh values and ranges therebetween.
Example T. A Pt/transition metal (Pt/TM) nanoparticle comprising platinum atoms and one or more first row transition metal atoms(s), where the platinum atoms and first row transition metal atoms form an intermetallic structure. The intermetallic structure may be an ordered intermetallic structure. In various examples, the platinum atoms and first row transition metal atoms are not randomly oriented and/or disordered. Non-limiting examples of first row transition metal atoms include cobalt, iron, nickel, and the like, and combinations thereof. In various examples, the Pt/TM nanoparticle is a Pt/Co nanoparticle. The Pt/TM nanoparticle may be disposed on a carbon support material (e.g., a carbon material of the present disclosure). In various examples, a catalyst material (which may be an ORR catalyst material) comprises a plurality of the Pt/TM nanoparticles. The PT/TM nanoparticle may be spherical or the like.
Example U. A Pt/TM nanoparticle according to Example T, where the nanoparticle has at least one dimension (which may be longest dimension(s)) of 3 to 10 nm, including all 0.1 nm values and ranges therebetween.
Example V. A Pt/TM nanoparticle according to Examples T or U, where the nanoparticle has a cubic structure, tetragonal structure, or the like.
Example W. A method of making a Pt/TM nanoparticle (e.g., a Pt/TM nanoparticle or nanoparticles of the present disclosure, such as, for example, a Pt/TM nanoparticle or nanoparticles of any one of Examples T-V) comprising: forming a Pt/TM nanoparticle/nanoparticle (e.g., under forming gas at 200° C.); and annealing the Pt/TM nanoparticle/nanoparticles (e.g., at up to 650° C. in a certain gas atmosphere). In various examples, the annealing is carried out at a temperature of 700° C. or less (e.g., 500° C. to 700° C.), for example, for 3 to 6 hours). In various examples, the Pt/TM nanoparticle/nanoparticles are formed in situ in the presence of a carbon support material, such as, for example, a ZIF-8_Fe derived support material, and the Pt/TM nanoparticle/nanoparticles are disposed on the ZIF-8_Fe derived support material.
Example X. A method of making a Pt/TM nanoparticle according to Example W, where the gas of the gas atmosphere is an inert gas (such as, for example, argon, or the like, or a combination thereof), forming gas, or the like. Without intending to be bound by any particular theory, it is considered that selection of the gas of the gas atmosphere can provide desired nanoparticle structure.
Example Y. A catalyst material (which may be an ORR catalyst material) comprising a plurality of Pt/TM nanoparticles of the present disclosure (e.g., Pt/TM nanoparticles of any one of Examples T-V and/or a Pt/TM nanoparticle made by a method of any one of Examples W-X) disposed on a carbon material. A carbon material may comprise a plurality of iron-based active sites (e.g., FeNₓ and the like). Non-limiting examples of carbon materials include ZIF-8_Fe derived support materials, polyaniline hydrogel-derived carbon materials, and the like, and combinations thereof. A ZIF-8_Fe derived support material is formed by carbonization of a ZIF-8_Fe material. A ZIF-8_Fe derived support material may comprise nanoparticles (e.g., nanoparticles having a size (e.g., at least one dimension, which may be a longest dimension, or all dimensions of from 20 to 500 nm).
Example Z. A catalyst material of Example Y, where carbon material is a carbon material of the present disclosure (e.g., a carbon material of any one of Examples A-I and/or a carbon material made by a method of any one of Examples J-P).
Example AA. A method of making a catalyst material (e.g., a catalyst material of the present disclosure, such as, for example, a catalyst material according to Examples X or Z) comprising forming reaction mixture comprising an aqueous suspension of a carbon material, a platinum source, and a cobalt source; dehydrating the reaction mixture to form a powder; thermally treating the powder in a gas atmosphere; thermally treating (which may be referred to as annealing) the thermally-treated powder in a gas atmosphere, where the catalyst material is formed. In various examples, the gas of the gas atmosphere is forming gas, an inert atmosphere (e.g., argon atmosphere, nitrogen atmosphere, or the like), or the like. In various examples, the Pt/TM nanoparticle/nanoparticles are formed in situ in the presence of the carbon material. Non-limiting examples of platinum sources include acids, such as, for example, hexachloroplatinic acid, and the like, and combinations thereof, platinum salts, and the like, and combinations thereof. The platinum source(s) may be water soluble. Non-limiting examples of cobalt sources include cobalt salts, such as, for example, cobalt(II) chloride, cobalt (II) nitrate, and the like, and combinations thereof. A cobalt salt may be a hydrate. The cobalt source(s) may be water soluble. Non-limiting examples of carbon materials include ZIF-8_Fe derived support materials, other carbon materials described herein, and the like, and combinations thereof. In various examples the platinum source:cobalt source molar ratio is from 0.33 to 0.5. It may be desirable to have a molar excess of platinum source(s) relative to the amount of cobalt source(s). The dehydration may be carried out by freeze-drying, or the like. The Pt/TM nanoparticle/nanoparticles may be annealed in a gas atmosphere. Normal acid leaching may be conducted (e.g., to remove excess transition metal species), followed by post treatment under an inert atmosphere (e.g., under argon at 400° C. for 1 hour).
Example AB. A method according to Example AA, where the thermal treatment of the powder is carried out in a reducing atmosphere. Non-limiting examples of reducing atmospheres include a hydrogen gas atmosphere, forming gas (a mixture of hydrogen and argon), and the like, and combinations thereof. In various examples, the thermal treatment is carried out at a temperature of 200 to 350° C., including all 0.1° C. values and ranges therebetween, and/or for 3-6 hours, including all 0.1 hour values and ranges therebetween.
Example AC. A method according to Examples AA or AB, where the thermal treatment of the thermally-treated powder (e.g., annealing) is carried out in an inert gas atmosphere (such as, for example, argon, or the like, or a combination thereof), a reducing gas atmosphere, or the like. In various examples, the thermal treatment of the thermally-treated powder is carried out at a temperature of 600° C. or less (e.g., 550° C. to 700° C.) and/or for 3-6 hours. Without intending to be bound by any particular theory, it is considered that selection of the gas of the gas atmosphere can provide desired nanoparticle structure. Normal acid leaching (e.g., using diluted HClO₄) may be conducted to remove excess transition metal species, followed by post treatment (e.g., under argon at 400° C. for 1 hour).
Example AD. An electrode comprising one or more, any combination of, or all of the following: i) One or more carbon material(s) of the present disclosure (e.g., one or more carbon material(s) of any one of Examples A-I and/or one or more carbon material(s) made by a method of any one of Examples J-P); and/or ii) One or more catalyst material(s) (which may be ORR catalyst material(s)) of the present disclosure (e.g., one or more catalyst material(s) of any one of Examples Q-S); and/or iii) One or more Pt/TM nanoparticle(s) of the present disclosure (e.g., one or more Pt/TM nanoparticle(s) of any one of Examples T-V), which may be disposed on at least a portion of a surface of one or more carbon material(s) of the present disclosure (e.g., one or more carbon material(s) of any one of Examples A-I and/or one or more carbon material(s) made by a method of any one of Examples J-P). The electrode, which may be an ORR electrode, may be a fuel cell electrode.
Example AE. An electrode according to Example AD, where the electrode further comprises an electrolyte membrane (such as, for example, a polymer electrolyte membrane and the like), a gas diffusion membrane (such as, for example, carbon paper and the like), or the like, or a combination thereof.
Example AF. A device comprising one or more electrode of the present disclosure (e.g., an electrode of Examples AD or AE).
Example AG. A device according to Example AF, where the device is a fuel cell, an electrolysis device, a battery. A battery may be a primary battery or a secondary battery. Non-limiting examples of batteries include ion-conducting batteries, such as, for example, lithium-ion batteries, and the like.
Example AH. A composition, comprising a graphitic carbon material having a plurality of pores. The graphitic carbon material has a hierarchical porosity. The graphitic carbon material has a specific surface area of 350-550 m²/g, inclusive (including all 0.1 m²/g values and ranges therebetween), and an I_{(D)}/I_{(G)} of 1-10, inclusive (e.g., 1, 2, 3, 4, 5, 6, 7, 8, 9, or 10), and where the graphitic carbon material is at least 90 at % carbon. The graphitic carbon material has a plurality of nanoparticles disposed on a surface of the graphitic carbon material. The graphitic carbon material has a cumulative pore volume of 0.7±0.1 cm³/g. Each pore of the plurality of pores has a longest linear dimension or diameter of 1-75 nm, inclusive (including all 0.1 nm values and ranges therebetween).
Example AI. A composition according to Example AH, where the plurality of nanoparticles are present at a concentration of 5 to 80% by weight of the total weight of the composition. In various embodiments, the percent by weight is 10 to 70%, 10 to 80%, 15 to 55%, or 15 to 65% by weight.
Example AJ. A composition according to Example AH or AI, wherein the graphitic carbon material is nitrogen-doped with one or more N-dopants. The one or more N-dopants are chosen from graphitic N-dopants, pyridinic N-dopants, NOₓ species, and the like, combinations thereof. The N-dopant is present at 0.2-0.5 at %. The graphitic carbon material is formed from heating a mixture of polymerized aniline, pyrrole, and manganese.
Example AK. A composition according to Example AH-AJ, where the plurality of nanoparticles are platinum nanoparticles or platinum cobalt nanoparticles. The platinum cobalt nanoparticles are L1₀ PtCo nanoparticles or L1₂ Pt₃Co nanoparticles or a combination thereof.
Example AL. A composition according to AH or AI, wherein the graphitic carbon material further comprises iron. The graphitic carbon material comprises a plurality of FeNₓ groups, wherein x is 1 to 4. x may be 4. The plurality of nanoparticles are platinum nanoparticles or platinum cobalt nanoparticles or a combination thereof. The platinum cobalt nanoparticles are L1₀ PtCo nanoparticles or L1₂ Pt₃Co nanoparticles.
Example AM. A graphitic carbon material with a hierarchal porosity. The graphitic material has a plurality of pores, a specific surface area of 350-550 m²/g, and an I_{(D)}/I_{(G)} of 1-10, and is at least 90 at % carbon. The graphitic carbon material has a cumulative pore volume of 0.7±0.1 cm³/g. Each pore of the plurality of pores has a longest linear dimension or diameter of 1-75 nm, inclusive (including all 0.1 nm values and ranges therebetween).
Example AN. A graphitic carbon material according to Example AM, where the graphitic carbon material is nitrogen-doped with one or more N-dopants. The one or more N-dopants are chosen from graphitic N-dopants, pyridinic N-dopants, NOₓ species, and the like, and combinations thereof. The N-dopant is present at 0.2-0.5 at %. The graphitic carbon material is formed from heating a mixture of polymerized aniline, pyrrole, and manganese.
Example AO. A graphitic carbon material according to Example AM, where the graphitic carbon material further comprises iron. The graphitic carbon material can comprise a plurality of FeN₄ groups.
Example AP. A method of making a graphitic carbon material according to Example AM, comprising: providing a mixture comprising: one or more polyanilines; one or more polypyrroles; and manganese; and thermally treating the mixture, wherein the graphitic material is formed. A portion of the polyanilines and/or a portion of the polypyrroles are formed in situ. The mixture is formed by: providing a reaction mixture comprising: aniline, pyrrole, manganese, optionally, one or more polymerization catalysts, and optionally, one or more solvents, and holding the reaction mixture at a temperature of 18-24° C., inclusive (including all 0.1° C. values and ranges therebetween), where the polyanilines and polypyrroles are formed. The mixture is a hydrogel comprising water and the method further comprises removing at least a portion of the water. The ratio of polyaniline to polypyrrole is 4 to 2, inclusive (including all 0.1 ratio values and ranges therebetween). Thermally treating comprises heating the mixture to a temperature of 1050-1110° C., inclusive (including all 0.1° C. values and ranges therebetween) (e.g., 1090-1110° C., inclusive). The method may further comprise acid washing the graphitic carbon material. The method may further comprising thermally treating the graphitic carbon material following acid washing, wherein the thermally treating comprises heating the graphitic carbon material at a temperature of 900-1110° C., inclusive (including all 0.1° C. values and ranges therebetween).
Example AQ. A method of making a composition according to Example AH, comprising: forming a reaction mixture comprising: an aqueous solution of the graphitic carbon material, a platinum source, and a cobalt source, dehydrating the reaction mixture to form a powder; thermally treating the powder; annealing the powder, where the composition according to Example AH is formed. The thermally treating is performed in a reducing atmosphere. The annealing is performed in an inert atmosphere. The annealing is performed at a temperature of 550-770° C., inclusive (including all 0.1° C. values and ranges therebetween).
Example AR. A device comprising the composition according to Example AH. The device may be an electrode. The electrode further comprises an electrolyte membrane, a gas diffusion membrane, or a combination thereof. A device may comprise a plurality of the electrodes. The device may be a fuel cell, electrolysis device, or a battery.
Example AS. A device comprising the graphitic carbon material according to Example AM. The device may be an electrode. The electrode further comprises an electrolyte membrane, a gas diffusion membrane, or a combination thereof. A device may comprise a plurality of the electrodes. The device may be a fuel cell, electrolysis device, or a battery.

The following examples are presented to illustrate the present disclosure. They are not intended to be limiting in any matter.

### Example 1

This example provides a description of carbon materials and catalyst materials of the present disclosure and methods of making same. Additionally, characterization and use of the carbon materials and catalyst materials are described.

In this example, a highly durable and active Pt catalyst supported on a three-dimensional (3D) porous graphitic carbon (PGC) derived from polymer hydrogel is described. Hydrogels, which have a 3D network of crosslinked polymer chains containing large amounts of water, has been extensively studied as a carbon precursor. The hydrogel precursors yield porous support architectures, which provide improvements in active site density, mass/charge transfer, and structural integrity. The polymers selected to prepare the hydrogel were crosslinked polyaniline (PANI) and polypyrrole (PPy), which have been proved to be effective nitrogen/carbon precursors for catalysts. In particular, PANI is rich in aromatic structures similar to graphitized carbon, and abundant carbon and nitrogen sources help direct conversion to graphitized carbon. By adding pyrrole, highly folded and contorted graphitic structures with high uniformity and porosity can be produced from PANI-PPy composite. The PANI-PPy hydrogel composite was used to facilitate increased nitrogen doping in the resulting PGC, which is believed to provide significant improvements of activity and stability for Pt/C catalysts. In addition, metal precursors including Fe, Co, Ni, or Mn were introduced into the polymerization process to take advantage of metal-catalyzed graphitization. Among these metals, Mn is the most suitable for fuel cell applications since it does not cause degradation processes associated with the Fenton reactions. At the same time, Mn was demonstrated to be an effective catalyst for graphitization of polymer-derived carbon. Whereas conventional high temperature treatment typically requires temperatures up to 3000° C. to produce highly graphitized carbon, the Mn-assisted hydrogel method is able to achieve a high degree of graphitization at only 1100° C., making this method attractive from a manufacturing standpoint. Deposition of Pt nanoparticles onto the hydrogel-derived PGC resulted in a catalyst with dramatically enhanced electrochemical stability compared to commercial Pt/C catalysts, including TEC10V20E (Vulcan support), TEC10EA20E (graphitized carbon support) and TEC10E20E (high-surface-area carbon black). The present disclosure demonstrates highly graphitized and porous carbon may have exceptional stability and performance under real fuel cell operating conditions. Without intending to be bound by any particular theory, it is considered that these PGCs address carbon corrosion issues that have limited widespread deployment of PEMFCs and other electrochemical technologies.)

Results and Discussion.

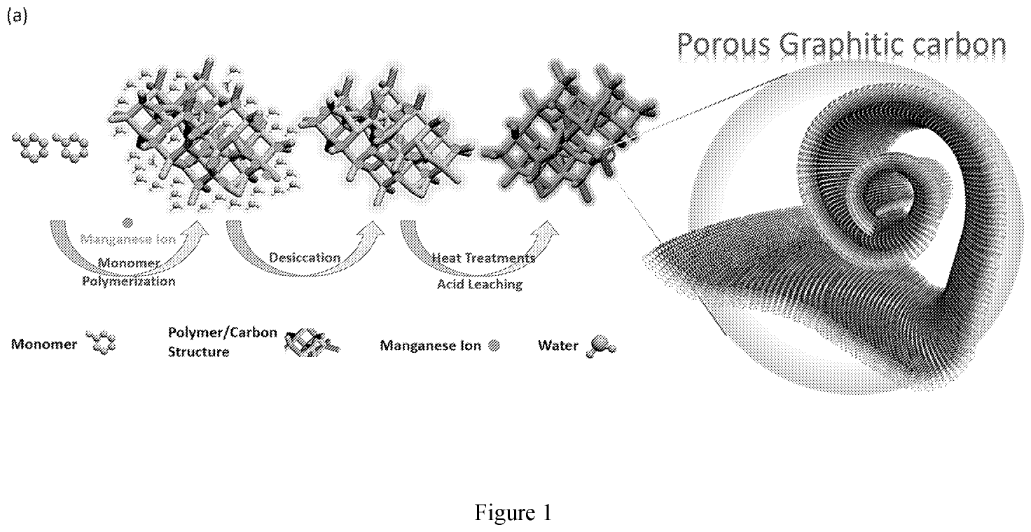

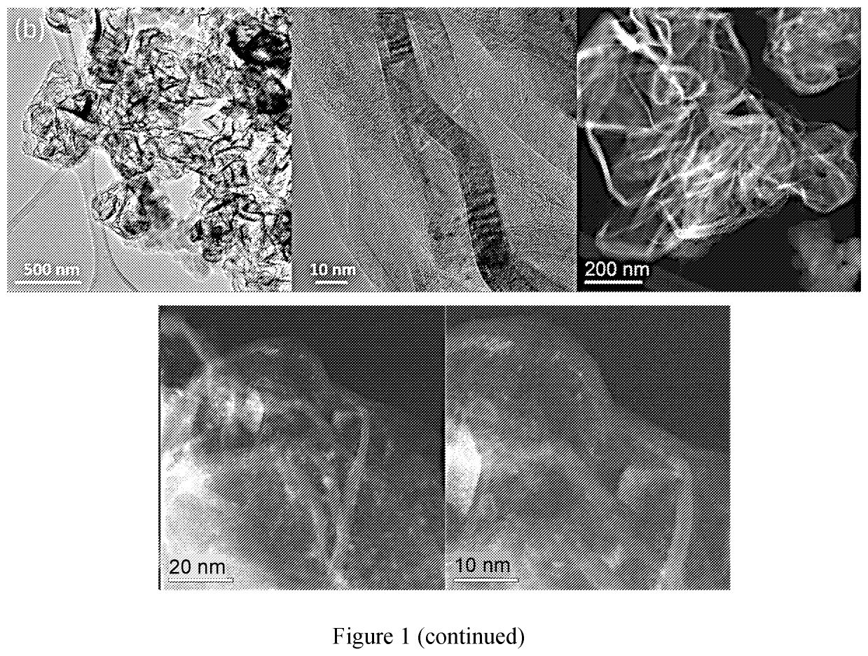

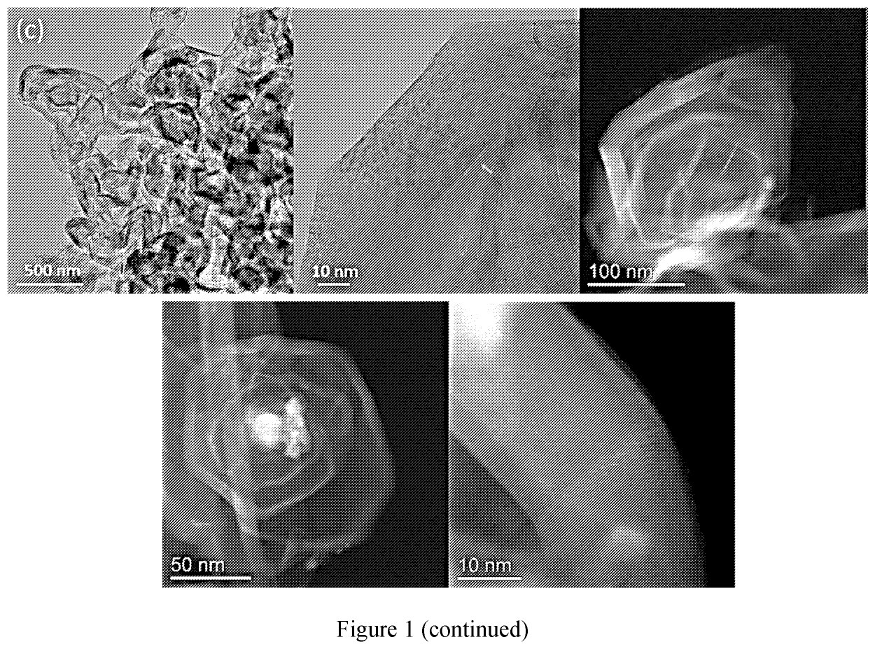

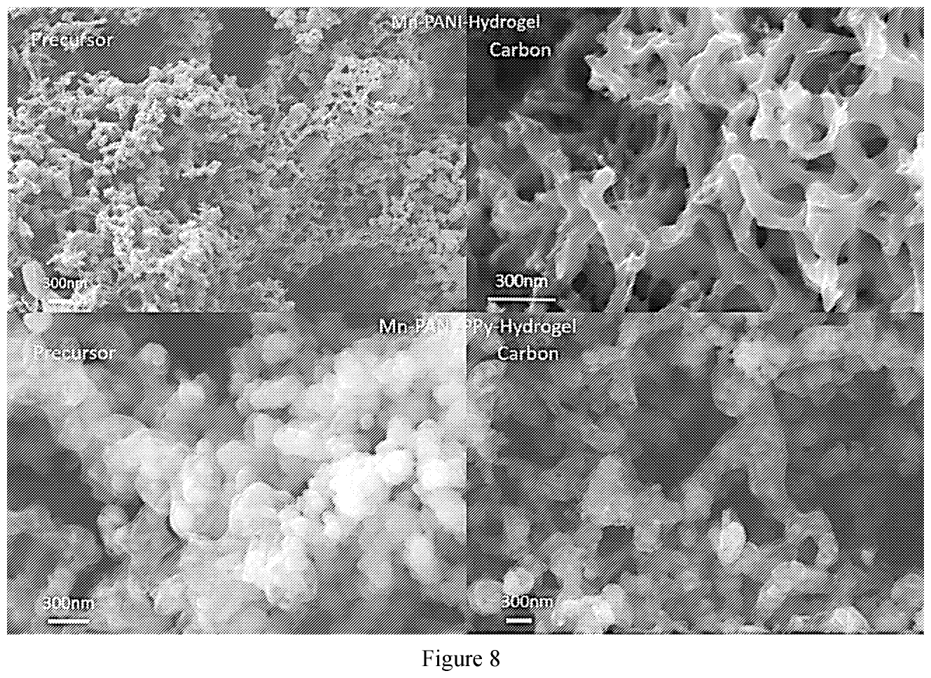

Synthesis, structure, and morphology of PGC supports and Pt catalysts. The polymer hydrogel approach to preparing PGC supports is illustrated in FIG. 1a. During the synthesis, ammonium persulfate was applied as an initiator for the polymerization of aniline and pyrrole to produce highly crosslinked and folded polymer nanostructures. After removing water from the hydrogel precursor, the first heat treatment was applied to fully carbonize precursors to highly graphitized carbon with the assistance of manganese. In order to purify the carbon, acid leaching was used to remove metal aggregates in the resulting carbon structure. A second heat treatment was used to further stabilize and reconstruct the carbon by removing oxygen containing functional groups formed during acid leaching. SEM images shown in FIG. 8 provide a comparison of different hydrogel-Mn precursors (PANT vs. PANI+PPy) and their corresponding carbon. During the transition from precursors to carbon supports, the 3D porous structure was well maintained and became even more open. After adding pyrrole, the diameter of the short fibers increased and the structure became more disordered. This highly porous morphology is important for providing enough surface area for depositing Pt nanoparticles. TEM and STEM images shown in FIGS. 1b and c demonstrate that flower-like graphitic carbon structures with high irregularity are apparent in PGCs derived from the individual PANI and the binary PANI+PPy, respectively. Compared to the Mn-PANI precursor-derived carbon, the one from Mn-PANI-PPy exhibits thicker carbon layers folded irregularly, indicating a higher graphitic carbon content and higher porosity.

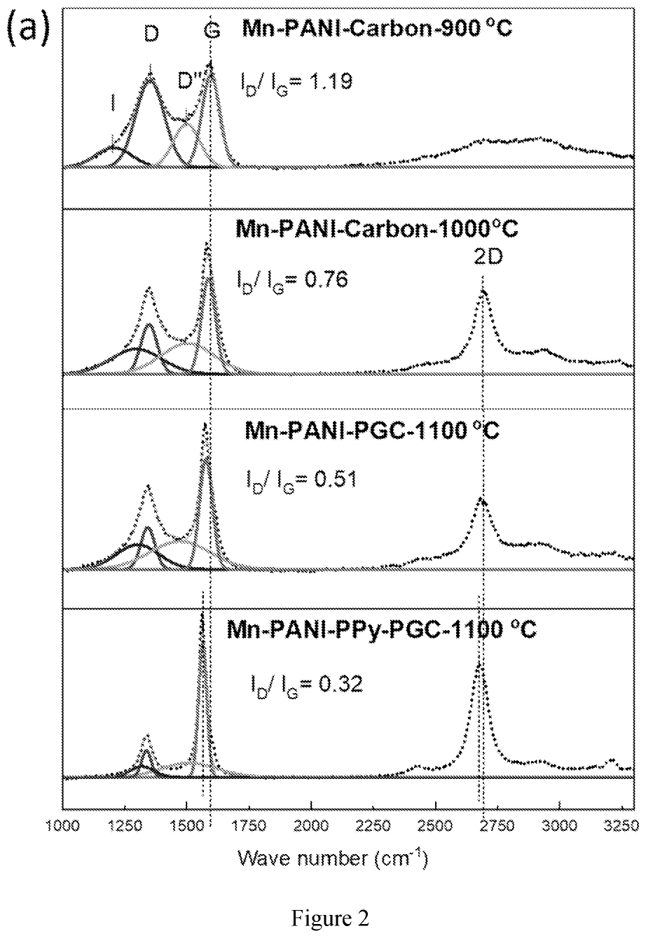

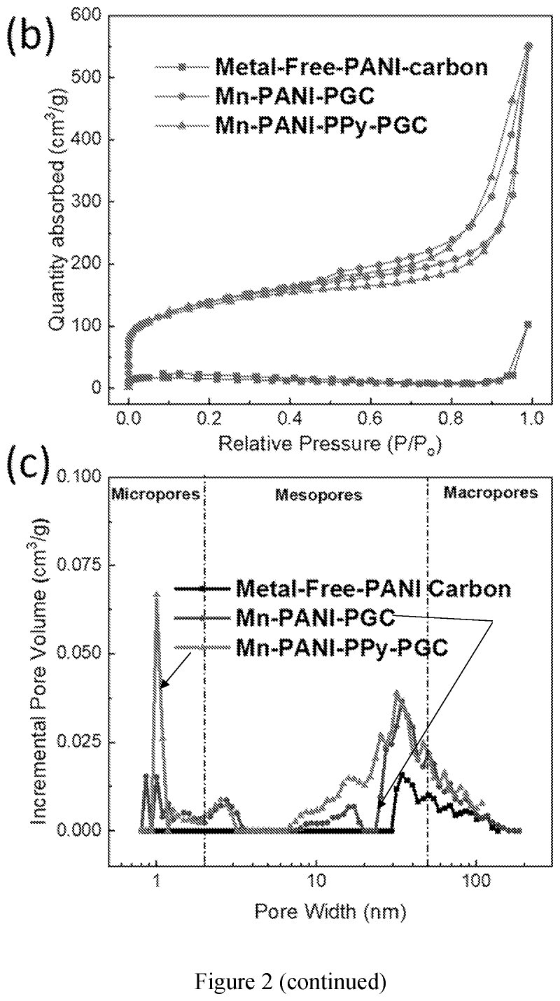

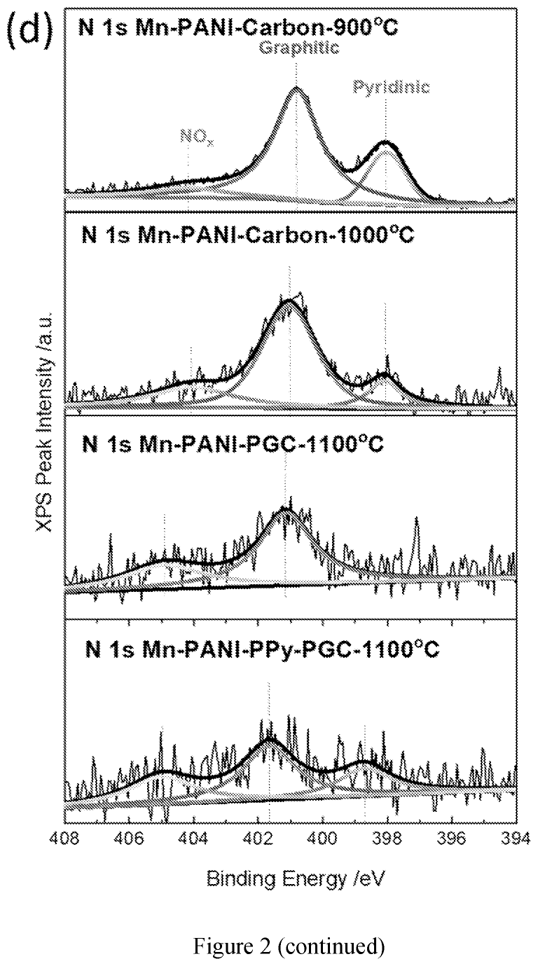

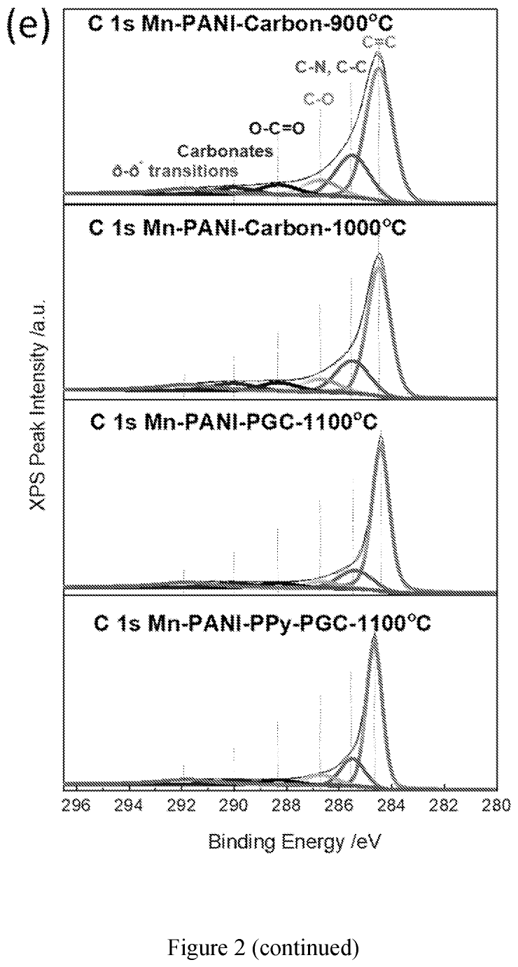

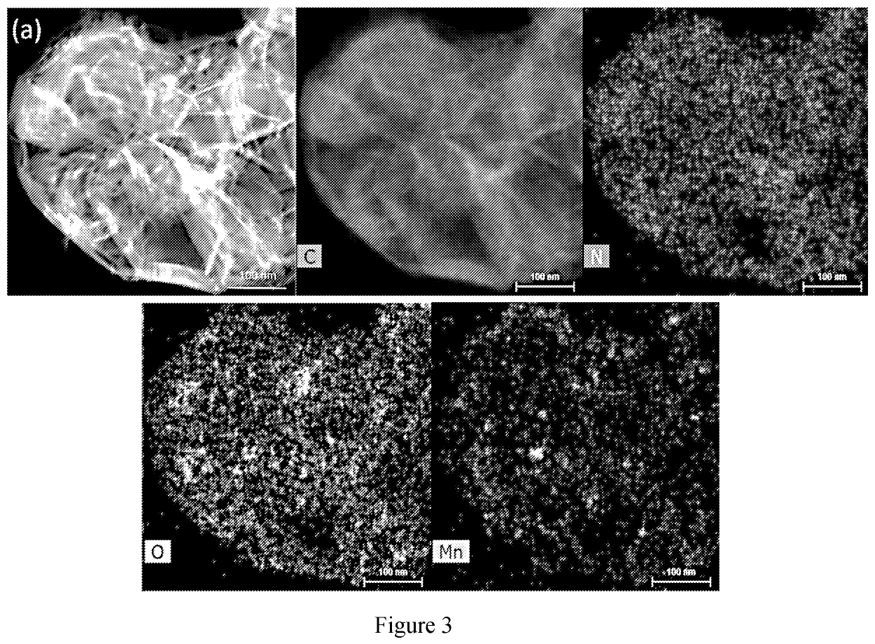

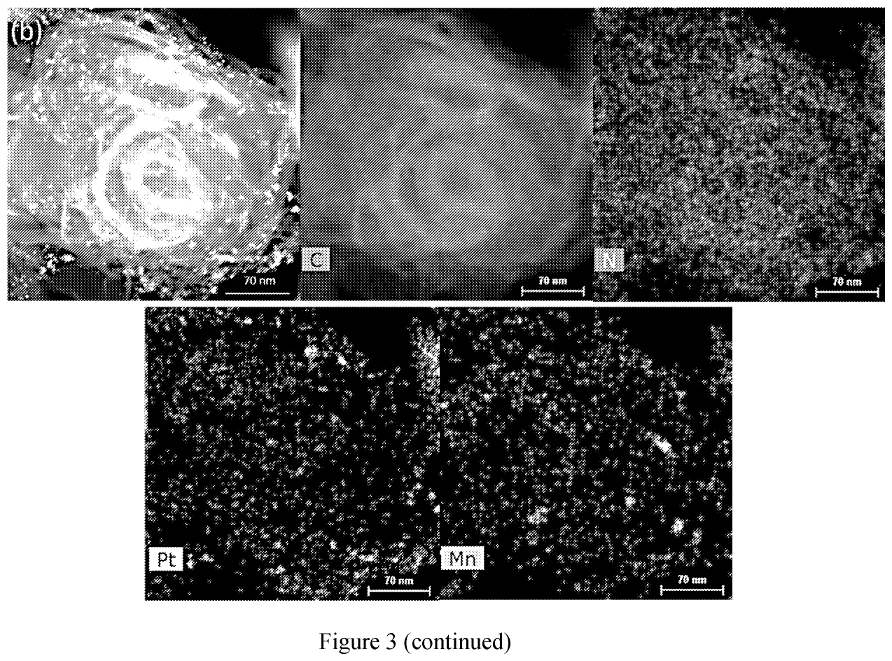

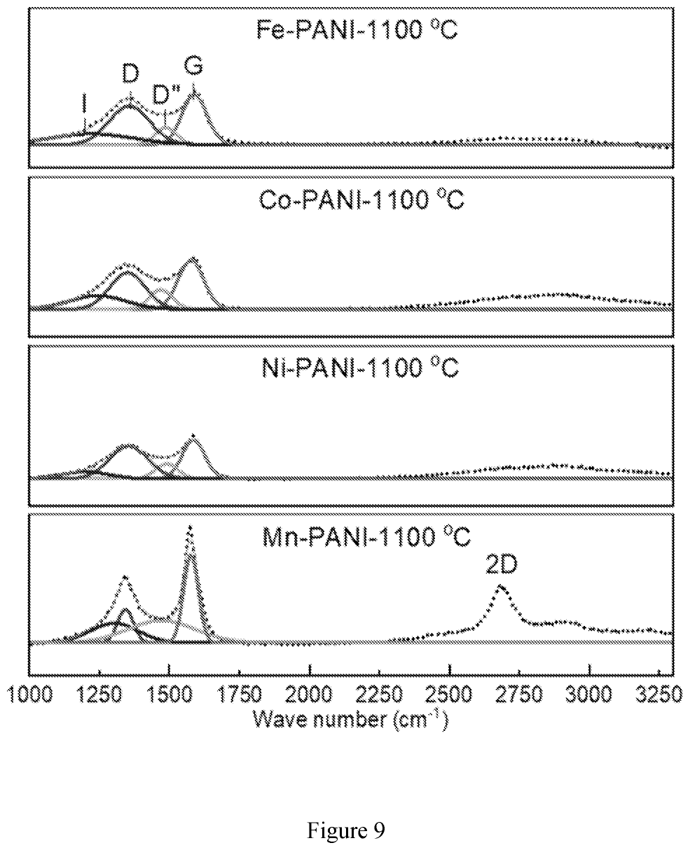

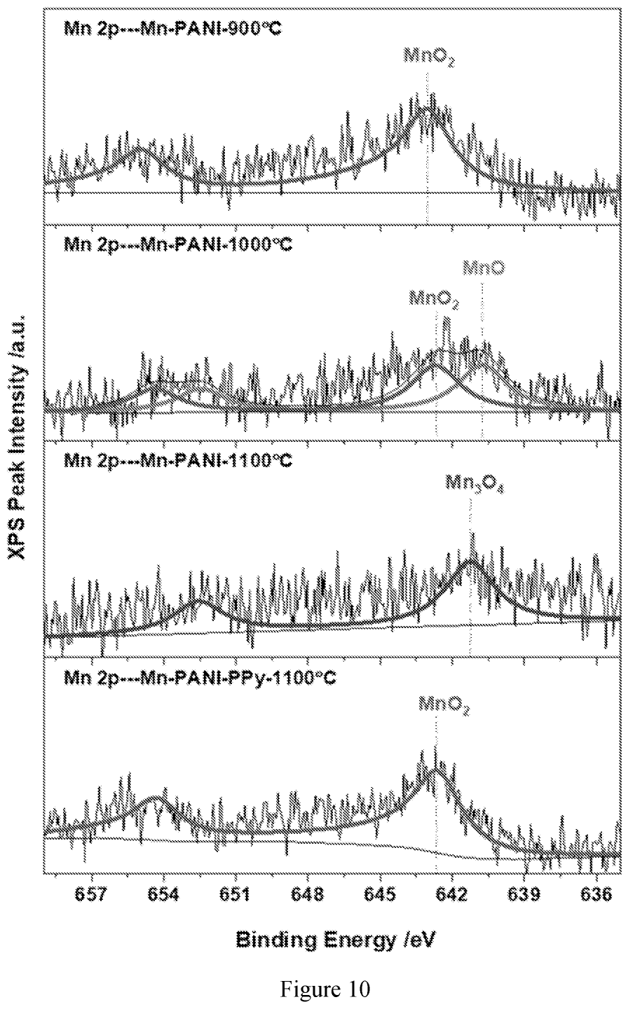

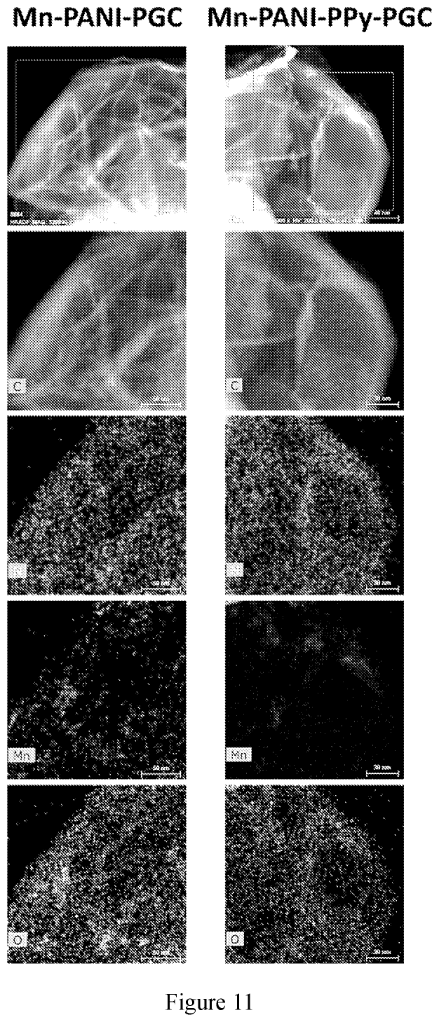

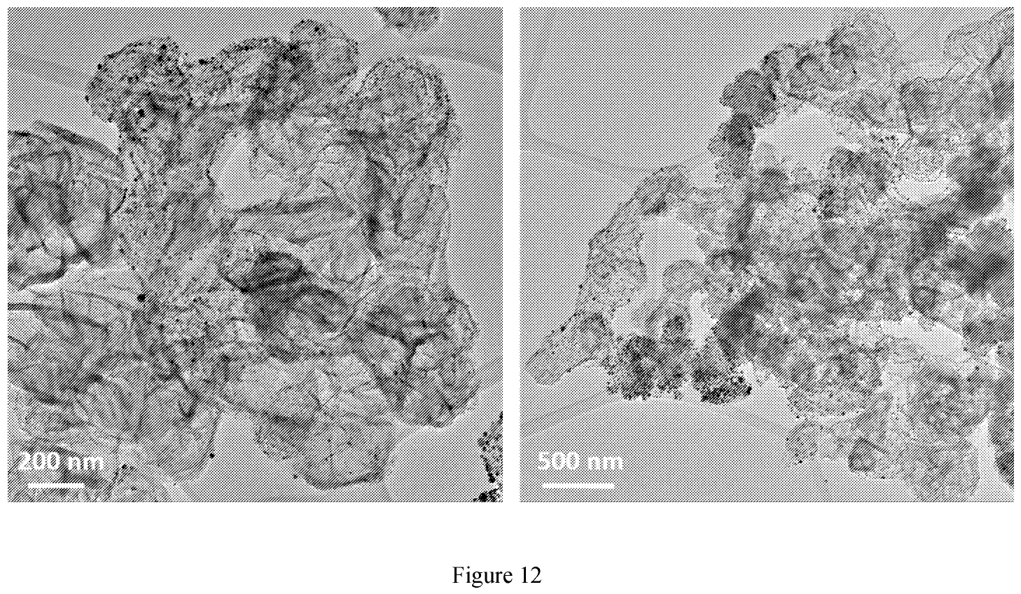

To study the carbon structure and the degree of graphitization, Raman spectra for relevant carbon samples are compared in FIG. 2a. Peak fitting was performed following the procedure outlined in previous literature. The peak intensity ratio (I_{(D)}/I_{(G)}) of the D (˜1350 cm⁻¹) and G (˜1590 cm⁻¹) bands was chosen to determine the degree of graphitization, with lower values of I_{(D)})/I_{(G)} indicating a higher degree of graphitization. It is apparent that higher heating temperature leads to decreased value of I_{(D)}/I_{(G)}, indicating increased degree of graphitization. At the same heating temperature of 1100° C., addition of PPy is able to further increase the degree of graphitization, as evidenced by decreased I_{(D)}/I_{(G)} of 0.32 and more separated D and G peaks when compared to that of individual PANI-derived carbon. A continuous shifting of G peak from 1596 to 1563 cm⁻¹ was observed when the heating temperature was increased from 900 to 1100° C. According to previous widely accepted knowledge, this is evidence for decreased doping level and defect density, which is in accordance with increased graphitization degree. In addition to D and G bands, the I band observed at a wide range (˜1180-1290 cm⁻¹) and the D″ band at ˜1500 cm⁻¹ are indications of the disorder in the graphitic lattice and the presence of amorphous carbon, respectively. The nearly vanished I and D″ peaks in the case of Mn-PANI-PPy-PGC-1100 carbon are also indicative of the further improved graphitization degree. Also, the second order of the D peak, noted as 2D peak, appeared when the heating temperature increased higher than 1000° C., and becomes even sharper in the case of Mn-PANI-PPy-PGC-1100. This is further evidence of graphitic features. For a comparison to Mn, was also evaluated carbon samples derived from PANI hydrogel combined with different metals including Fe, Co, or Ni, and the metal-free scenario. Their Raman spectra are shown in FIG. 9. Only Mn-derived carbon had relatively sharp G and 2D peaks, indicating its significant advantages to achieve high graphitization degree. BET analysis (FIGS. 2b and c) was carried out to characterize the specific surface area and porosity of the hydrogel-derived PGCs. A very low surface area of 45 m²/g was measured with the metal-free PANI hydrogel derived carbon. Addition of Mn into the hydrogel precursors provided an increase in surface area to 477 m²/g with cumulative pore volume of 0.53 cm³/g, which are more than 10 times higher than the metal-free hydrogel-derived carbon sample. Adding pyrrole to the precursors does not significantly change the surface area, which remains at 458 m²/g. However, the cumulative pore volume increased substantially to 0.70 cm³/g. This could be due to the short fiber structures with lower aspect ratios of PANI-PPy hydrogel, which leads to a highly folded morphology possessing more favorable porosity, especially mesopores. Both Mn-PANI and Mn-PANI-PPy derived PGCs have abundant pores at different sizes, but a higher volume of mesopores and micropores was only observed with the Mn-PANI-PPy-PGC. Without intending to be bound by any particular theory, it is considered that the pores in the PGCs are likely created by two mechanisms. One type of pore is due to the removal of Mn aggregates during acid leaching; the other is related to the highly folded carbon layer structures resulting from the porous hydrogel. Previously, mesopores were found to be crucial as sites for Pt deposition with facile mass transport. Thus, the higher mesoporosity of Mn-PANI-PPy-PGC makes it favorable as the support in Pt/C catalysts. The chemical states in surface layers of PGCs obtained at different heating temperatures were characterized by using XPS. Their corresponding N1s and C1s spectra are represented in FIGS. 2d and e, respectively. Three types of doped N atoms were observed in these PGCs, including pyridinic-N (398.4 eV) at edges of carbon planes, graphitic-N doped in the interior of the graphitic planes (401 eV), and oxidized pyridinic-N (404.8 eV) associated with oxygen. The absence of pyrrolic-N related to five-sided rings could be due to its instability at the elevated temperatures used in the synthesis (>800° C.). Pyridinic-N was a minor component in the PANI-Mn-PGC treated at 1100° C., which is in agreement with Raman in term of the decreased defect density. However, incorporation of PPy in the synthesis caused pyridinic-N to become apparent in PANI-PPy-Mn-PGC samples treated at 1100° C., which is one of the advantages of using binary PANI and PPy polymer hydrogel. Deconvolution of the high-resolution XPS C is peak revealed six different components due to the existence of various carbon moieties and π-π* interactions in the graphitic structure. With increasing temperature, more dominant and narrower peaks for C—C were observed, suggesting a higher degree of graphitization, which is consistent with Raman results. The Mn 2p spectra are also shown in FIG. 10. Due to the low Mn content, the spectra are somewhat vague and only trace levels of MnOₓ were observed. These data suggested that most Mn was removed during the acid-leaching step and only very low amounts remain in the graphitic structure, which is further confirmed by EDS mapping images in FIG. 3a. The elemental quantification determined by XPS for these PGCs is summarized in Table 1, which shows only trace amounts of Mn in all the samples and decreased nitrogen content when the temperature of heat treatment was increased. In addition, uniform nitrogen doping was also confirmed by STEM-EDS mapping (FIG. 3a and FIG. 11). After depositing Pt nanoparticles on the PGCs, a post annealing treatment was applied to further remove unstable components and strengthen interactions between Pt and the PGC support. The TEM images shown in FIG. 12 demonstrated that most of the Pt nanoparticles were well dispersed on the Mn-PANI-PPy-PGC, which was further verified by using STEM-EDS elemental mapping (FIG. 3b).

TABLE 1
XPS summary for different PGCs derived
from different temperature.

| | S (at %) | C (at %) | N (at %) | O (at %) | Mn (at %) |
|---|---|---|---|---|---|
| Carbon-Mn- | 0.3 | 95.1 | 2.0 | 2.4 | 0.2 |
| PANI-900° C. | | | | | |
| Carbon-Mn- | 0.2 | 96.3 | 1.0 | 2.2 | 0.2 |
| PANI-1000° C. | | | | | |
| Mn-PANI- | 0.1 | 97.8 | 0.7 | 1.1 | 0.3 |
| PGC-1100° C. | | | | | |
| Mn-PANI- | 0.1 | 97.8 | 0.7 | 1.0 | 0.4 |
| PPy-PGC- | | | | | |
| 1100° C. | | | | | |

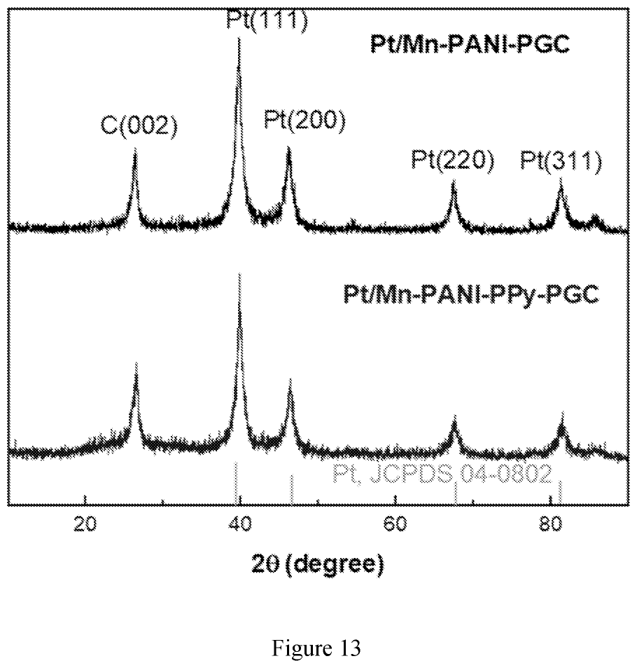

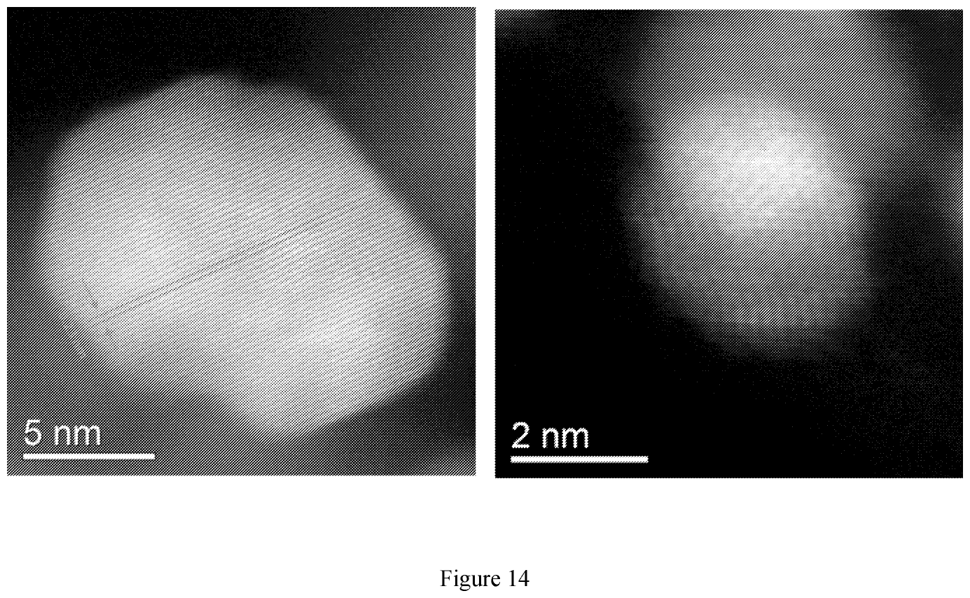

Rose-like graphitic carbon nanostructures were dominant, which is in agreement with the morphology of PGC in STEM images (FIG. 1c). Nitrogen was found dispersed uniformly throughout the carbon, while Mn was detected sparsely, in agreement with XPS results. The XRD patterns for Pt nanoparticles deposited onto two different PGCs derived from PANI-Mn and PANI-PPy-Mn are shown in FIG. 13. Both samples exhibited four diffraction peaks at 2θ=39.76°, 46.24°, 67.45° and 81.41°, which are consistent with those of Pt metals with an fcc structure, corresponding to the (111), (200), (220) and (311) planes. No peak shifting was observed, indicating that negligible alloying with manganese occurred even during the post annealing treatment (FIG. 14). The sharp peak observed in each sample at 2θ=26.45° corresponds to the (002) diffraction of graphitic carbon, which provides further evidence for highly graphitic carbon structures in these Pt/PGC catalysts.

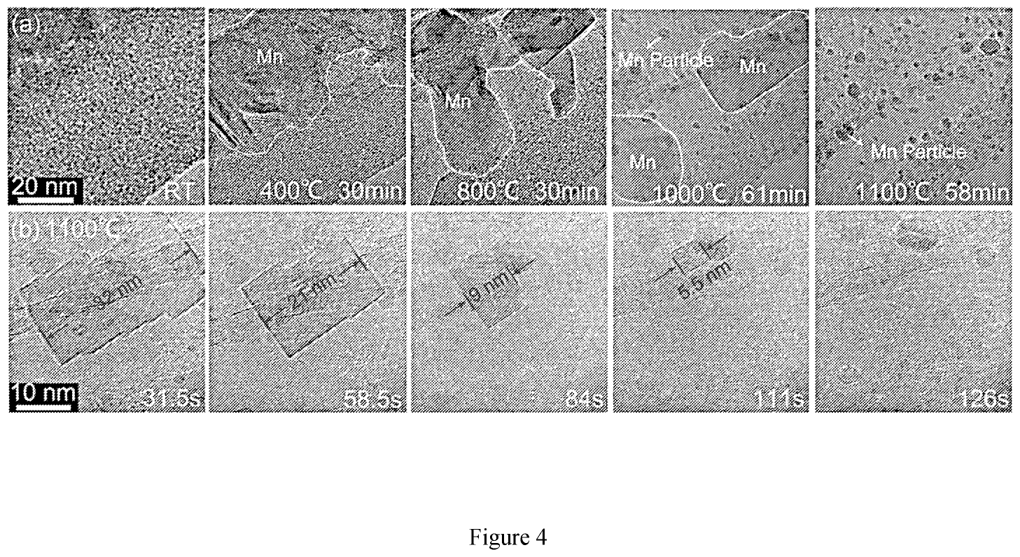

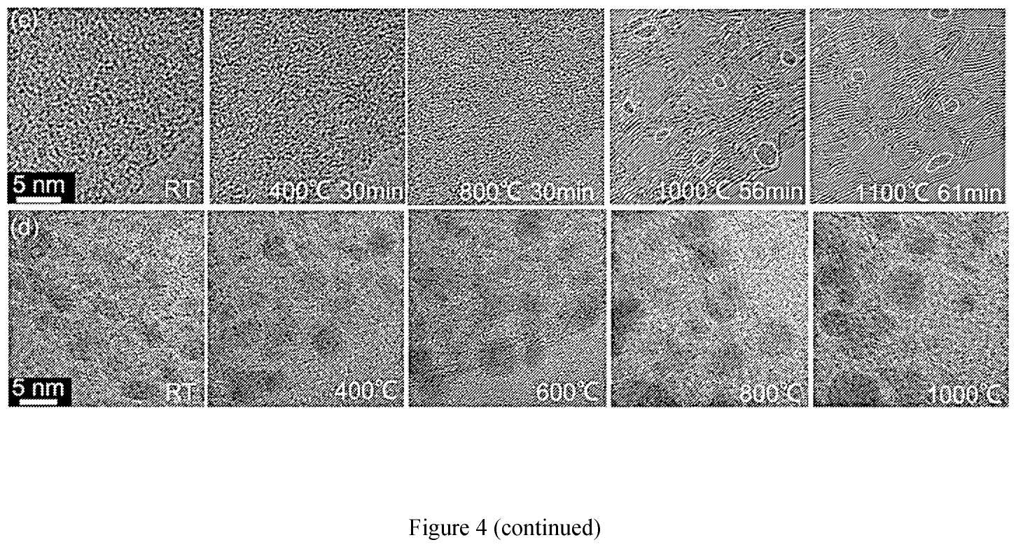

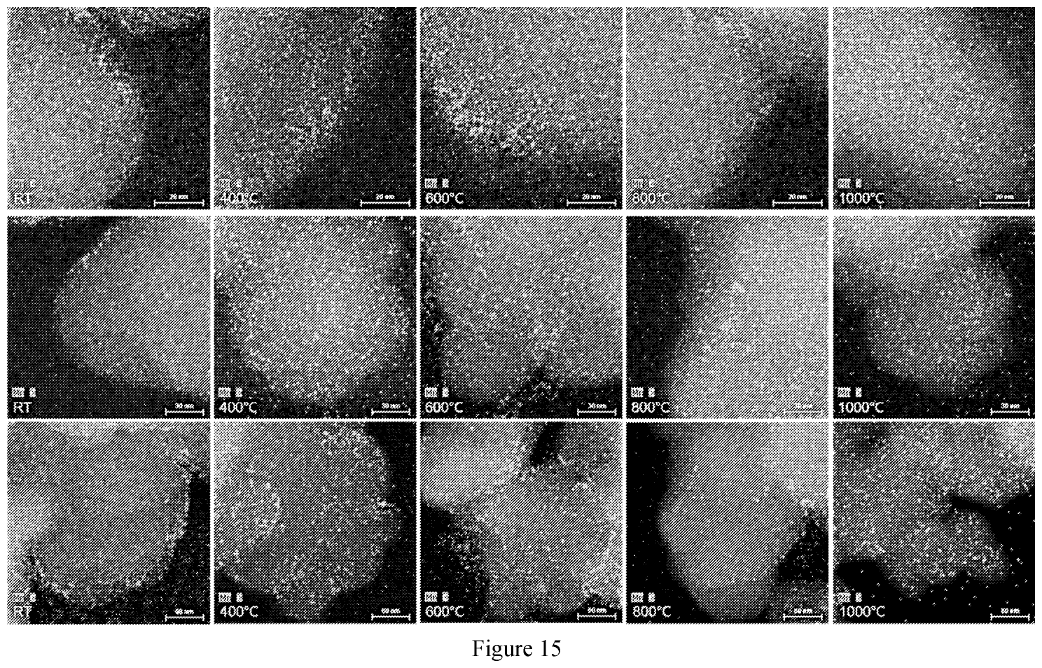

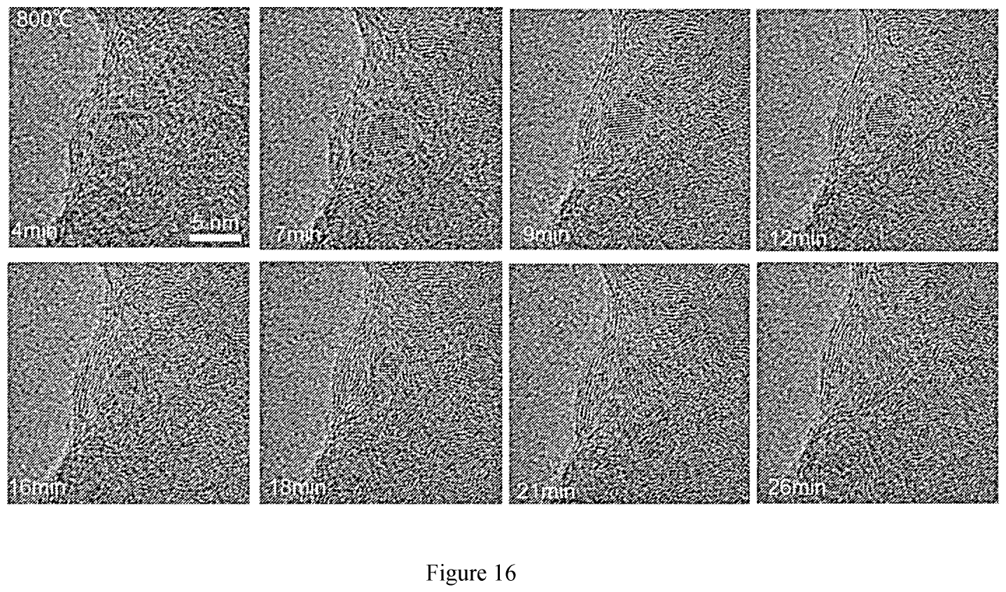

To dynamically study the evolution of Mn-PANI-PPy hydrogel from precursor to carbon material in real time, in-situ HRTEM and STEM-EDS analysis was performed and simulated the heat treatment conditions to monitor the carbonization process. FIG. 4a shows the changing distribution of Mn during a gradual increase in temperatures up to 1100° C. At the room temperature, Mn species were found to be distributed evenly at the edge of samples and then gradually agglomerated after 30 min heating at 400° C. Recrystallization process of Mn species was observed when heating at 800° C. and 1000° C. Along with the recrystallization process, crystallized Mn particles were observed well distributed in the carbon matrix. As shown in FIG. 4b, the large crystalized Mn particle with size of 32 nm was gradually decomposed in 126 s at 1100° C. Finally, small crystallized Mn particles were uniformly dispersed in the carbon matrix. This evolution was also observed in EDS maps with different resolutions shown in FIG. 15. This finding contrasts with previous studies of metal particle (e.g., Fe) movement, in which the particles continue to enlarge with increased temperatures. The highly dispersed Mn species at 1100° C. are involved in catalyzing the formation of graphitized carbon. In-situ HR-TEM images shown in FIG. 4c illustrate the process through which graphitization occurred as the temperature was increased, with layered graphitic domains becoming apparent at 1000° C. and 1100° C. with uniformly districted crystallized Mn particles. In-situ HR-TEM images shown in FIG. 16 demonstrate that longer duration of pyrolysis results in more uniform Mn dispersion and increased graphitization. The Pt nanoparticles deposited onto the Mn-PANI-PPy-PGC support were also studied by using in-situ HRTEM to mimic the post annealing treatment, which was found to be a critical step in improving catalytic activity and stability. Average particle size increased from around 3 to 5 nm when the annealing temperature was increased to 1100° C. (FIG. 4c), which could help to stabilize the nanoparticles and reduce agglomeration.

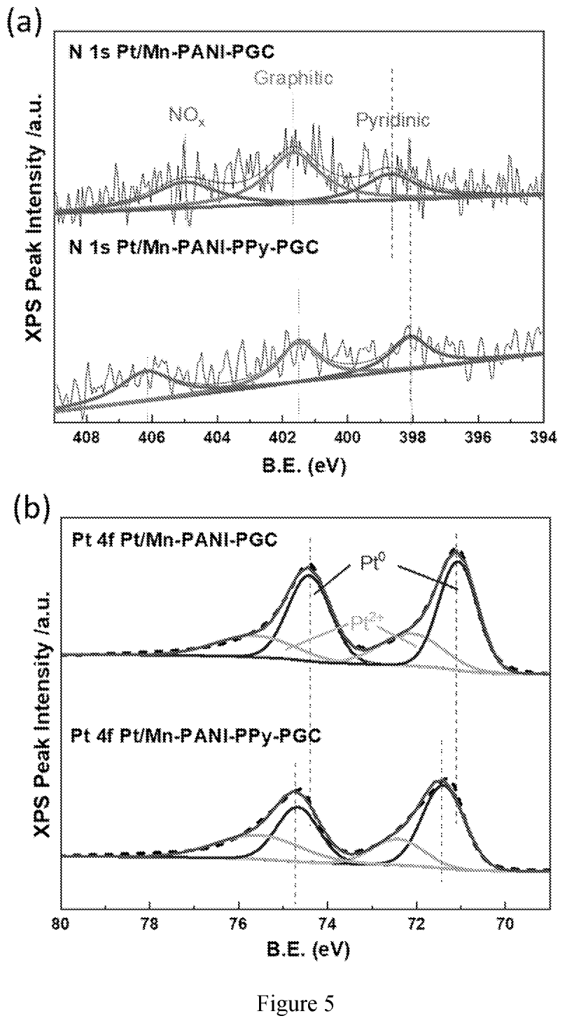

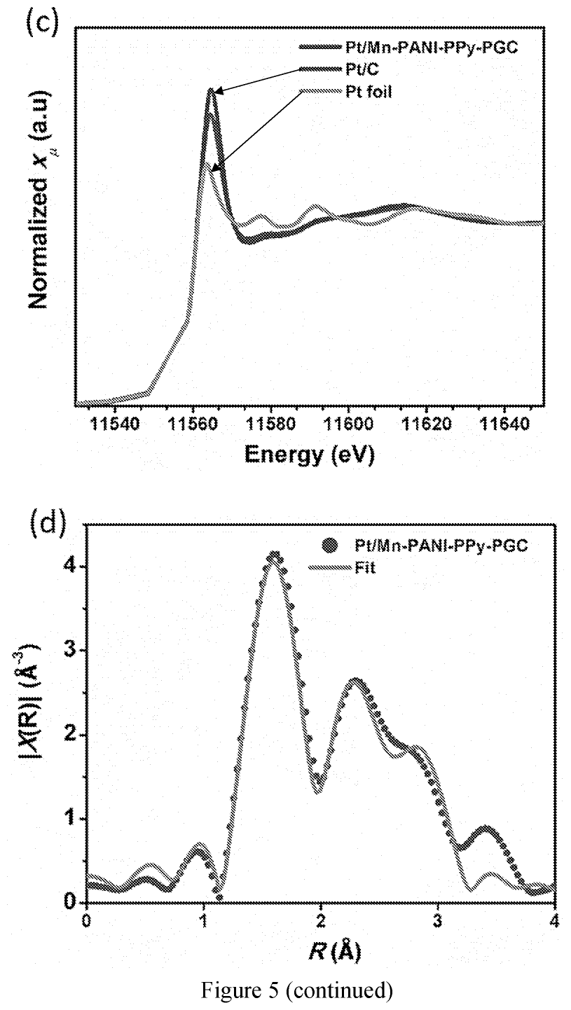

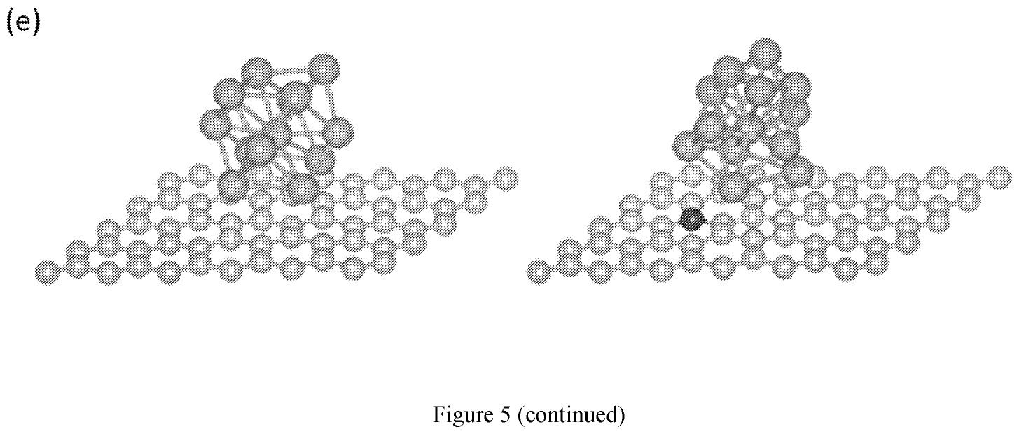

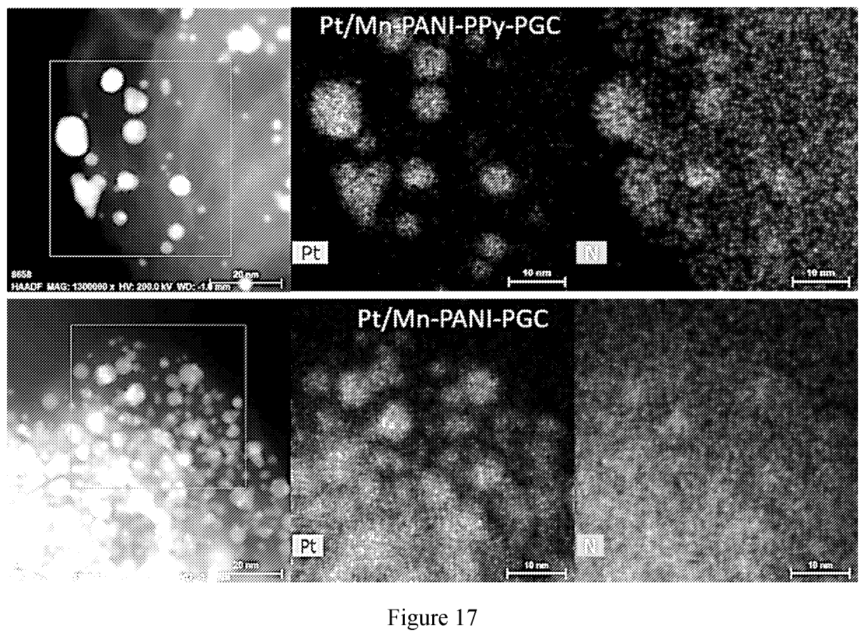

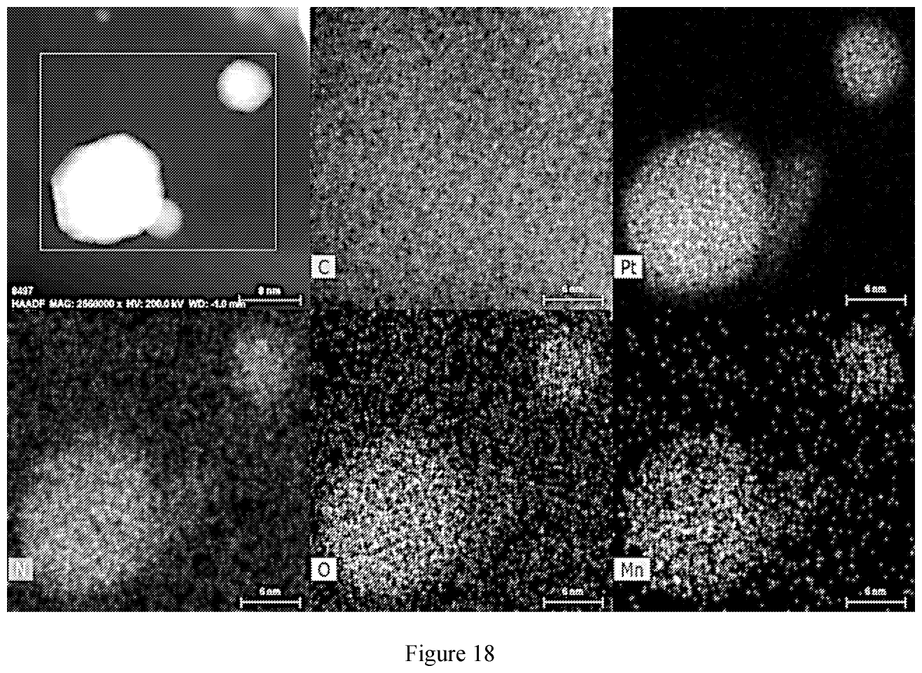

Promotional role of N doping in strengthening metal-support interactions. The XPS N 1s and Pt 4f spectra are shown in FIGS. 5a and b, respectively, for Pt catalysts deposited onto Mn-PANI-PGC and Mn-PANI-PPy-PGC supports. The Pt 4f spectra show that Pt is primarily in the metallic state. In addition, a slight shift of the Pt 4f peaks to higher binding energy and a shift of the N 1s peaks toward lower binding energy for the Pt/Mn-PANI-PPy-PGC were simultaneously observed when compared to those of Pt/Mn-PANI-PGC. These shifts in binding energy could be ascribed to electronic transfer from the deposited Pt nanoparticles to N dopants in PGC, likely strengthening their interaction. Also, such a transfer would affect the electronic structure of the surface Pt atoms. The resulting electron deficiency on Pt would further weaken the adsorption of O₂ during the ORR, which is potentially contributing to the improvement of catalytic activity and stability for the ORR. More STEM-EDS elemental mapping results are shown in FIG. 17 to identify the possible interactions between N and Pt, suggesting an apparent co-location of Pt and N at the nanoscale (FIG. 18).

Further characterization of local structure through XAS was used to provide increased understanding of the improved activity and stability of Pt/Mn-PANI-PPy-PGC in comparison to conventional Pt/C. Examination of normalized Pt-L₃ edge XANES spectra for Pt/Mn-PANI-PPy-PGC and Pt/C (FIG. 5c) reveals that the white line intensity, sensitive to the density of unoccupied d orbitals, is higher for both Pt/Mn-PANI-PPy-PGC and Pt/C than for Pt foil, indicating a higher oxidation state due to increased electron donation from Pt to N or O atoms in the vicinity. The higher white line intensity of Pt/C than Pt/Mn-PANI-PPy-PGC indicates a lower oxidation state of Pt in Pt/Mn-PANI-PPy-PGC, suggesting a possible role of N dopant in decreasing the adsorption of O-containing species on the Pt surface.

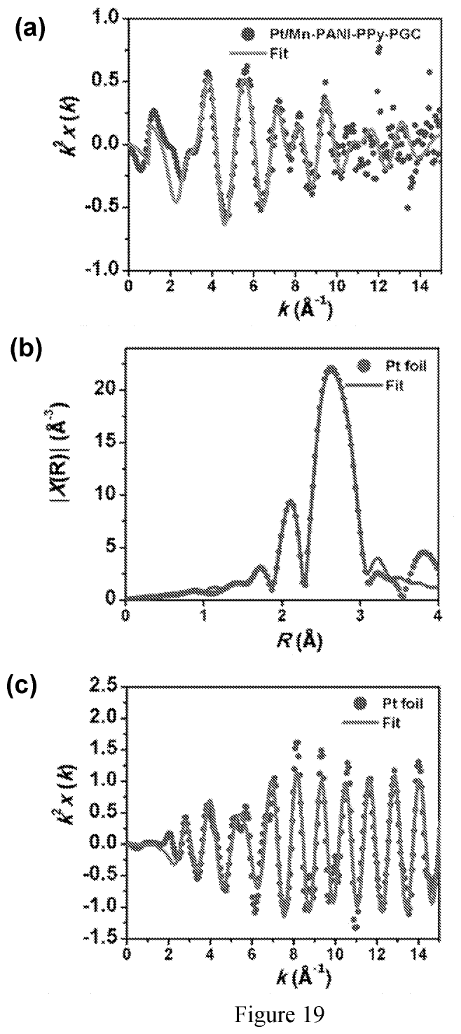

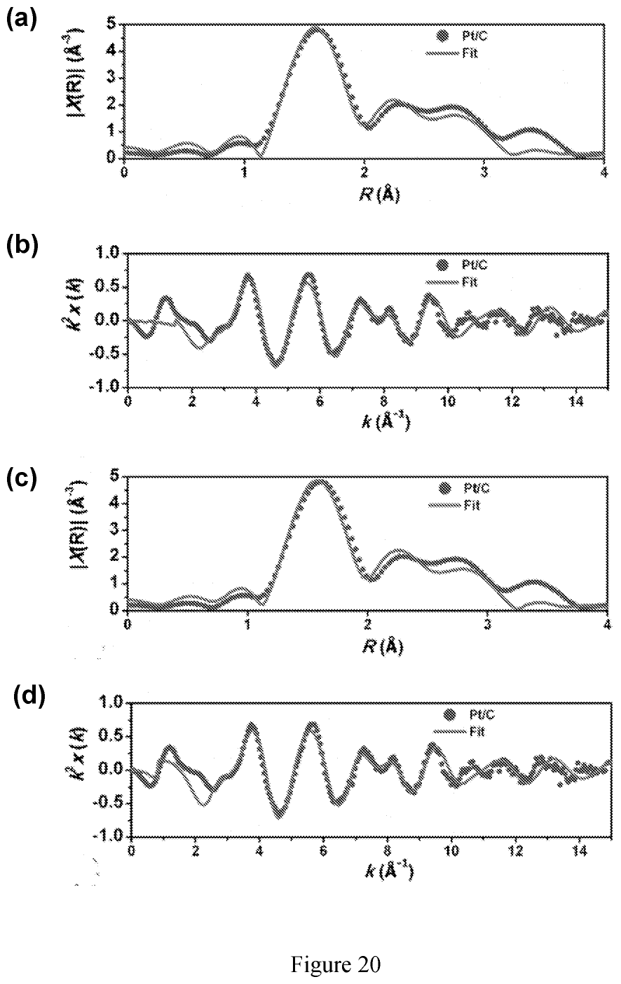

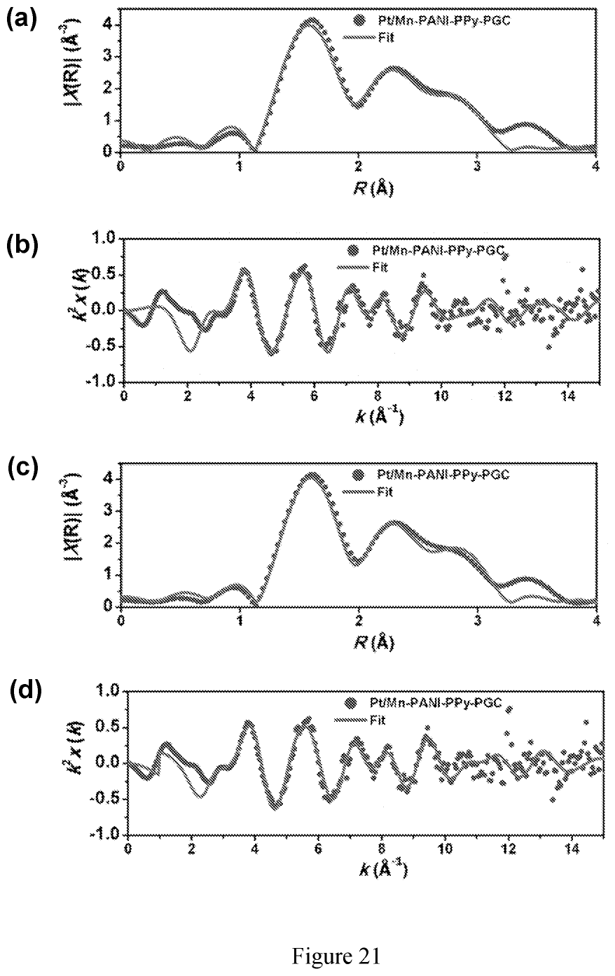

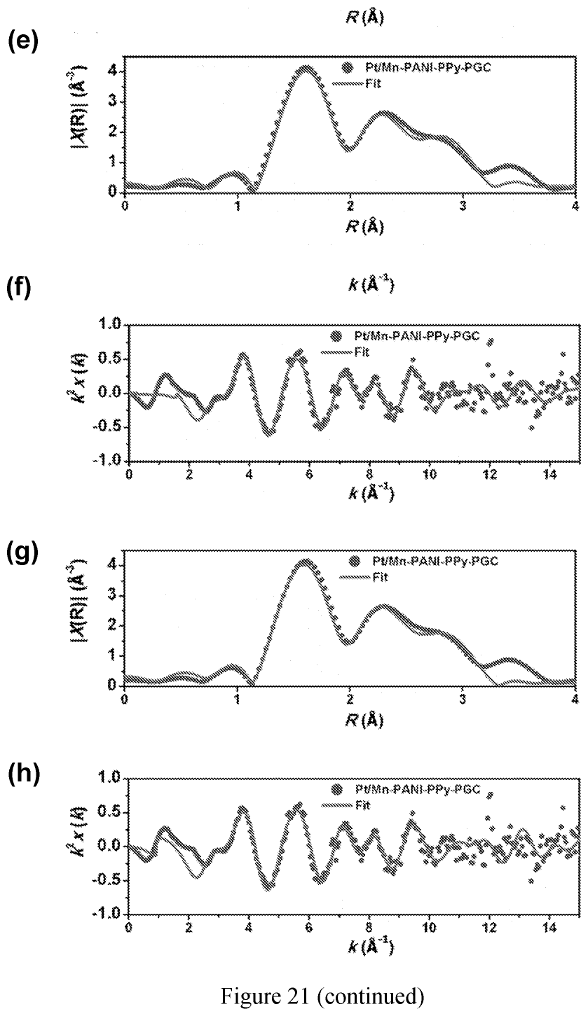

A series of EXAFS fittings were performed to characterize the local Pt structure of Pt/Mn-PANI-PPy-PGC and Pt/C using combinations of Pt—Pt, Pt—N, Pt—C and Pt—O scattering paths (FIG. 5d, FIGS. 19, 20, and 21). Because there is no N doping in Pt/C, only Pt—Pt, Pt—C, and Pt—O scattering paths were chosen to fit its EXAFS spectrum. The results (Table 2) suggest that Pt—Pt and Pt—O are the major coordination interactions for Pt/C, which is consistent with previous studies. In contrast, results for Pt/Mn-PANI-PPy-PGC (Table 3) show that Pt—N is highly favoured in the catalyst described herein, as the reduced χ² value (the soundness of fitting) is minimized by using the model containing only Pt—Pt and Pt—N scattering paths. The lower-coordinated Pt—Pt bonds (6.9 compared to 12 in fully coordinated Pt bulk, Table 3) is also indicative of Pt nanoparticles, which is consistent with TEM images. In addition, the possibility of Pt—O and Pt—C coordination was investigated by performing several independent EXAFS fittings, which show that Pt—O coordination is also possible, while Pt—C coordination does not appear significant (FIG. 21, Table 3). Although it is hard to completely exclude the existence of Pt—O, the comparison of EXAFS fitting results for Pt/Mn-PANI-PPy-PGC and Pt/C suggest that Pt—N coordination predominates in Pt/Mn-PANI-PPy-PGC. This interpretation is further supported by the difference in the white line intensity in XANES spectra. As shown in FIG. 5c, the white line intensity of Pt in Pt/C is higher than that of Pt in Pt/Mn-PANI-PPy-PGC, which can be attributed to decreased filling of the d band in Pt/C due to the higher electronegativity of oxygen relative to nitrogen. These XANES and EXAFS fitting results collectively suggest a high likelihood of Pt—N interaction in Pt/Mn-PANI-PPy-PGC (FIG. 5d), in agreement with the XPS and the STEM-EDS elemental mapping results. This Pt—N interaction appears to contribute to the increased stability and activity of this catalyst compared to non-doped commercial Pt/C catalysts.

TABLE 2
EXAFS fitting results for Pt/C using different combinations of scattering paths. N, coordination number,
R, the distance between the absorber and scatterer atoms, σ², Debye-Waller factor to account for thermal
and structural disorders, ΔE₀, inner potential correction. Fitting range, 2.5 ≤ k(Å⁻¹) ≤
10 and 1 ≤ R(Å) ≤ 3.2; Fixed N according to the crystal structure. Error bounds
indicated in parenthesis are full errors for N and last digit errors for other parameters.

| | | Pt—Pt | | | | Pt—O | | | | Pt—C | | | |
|---|---|---|---|---|---|---|---|---|---|---|---|---|---|
| Paths | | | R | σ² | ΔE₀ | | R | σ² | ΔE₀ | | R | σ² | ΔE₀ |
| Fit | χ² | N | (Å) | (Å²) | (eV) | N | (Å) | (Å²) | (eV) | N | (Å) | (Å²) | (eV) |
| 1 | 986 | 6.6(2.0) | 2.70(3) | 0.013(6) | 1.5(6) | 1.8(0.3) | 3.02(2) | 0.001(1) | 8.5(1) | — | — | — | — |
| 2 | 1544 | 23.3(7.0) | 2.69(4) | 0.027(7) | −2.2(4) | — | — | — | — | 7.2(1.8) | 1.52(2) | 0.001(1) | −2.2(4) |

TABLE 3
EXAFS fitting results for Pt/Mn-PANI-PPy-PGC using different combinations of scattering
paths. N, coordination number, R, the distance between the absorber and scatterer atoms,
σ², Debye-Waller factor to account for thermal and structural disorders, ΔE₀, inner
potential correction. Fitting range, 2.5 ≤ k(Å⁻¹) ≤ 10 and 1 ≤
R(Å) ≤ 3.2; Fixed N according to the crystal structure. Error bounds indicated
in parenthesis are full errors for N and last digit errors for other parameters

| Paths | | Pt—Pt | | | | Pt—N | | | |
|---|---|---|---|---|---|---|---|---|---|
| Fit | χ² | N | R | σ² | ΔE₀ | N | R | σ² | ΔE₀ |
| 1 | 80.6 | 6.9(1.8) | 2.72(2) | 0.012(3) | 3.6(5) | 1.8(0.2) | 2.00(1) | 0.001(1) | 3.6(5) |
| 2 | 93.2 | 6.3(0.4) | 2.71(2) | 0.011(3) | 3.4(9) | — | — | — | — |
| 3 | 129.7 | 12.5(0.4) | 2.68(3) | 0.017(6) | −1.5(3) | — | — | — | — |
| 4 | 201.7 | 6.9(0.4) | 2.71(3) | 0.012(4) | 3.6(5) | 1.8(0.1) | 2.00(3) | 0.008(1) | 3.6(5) |
| 5 | 170.1 | 6.9(0.4) | 2.71(3) | 0.012(5) | 3.2(8) | 1.8(0.1) | 2.00(2) | 0.001(1) | 3.2(8) |

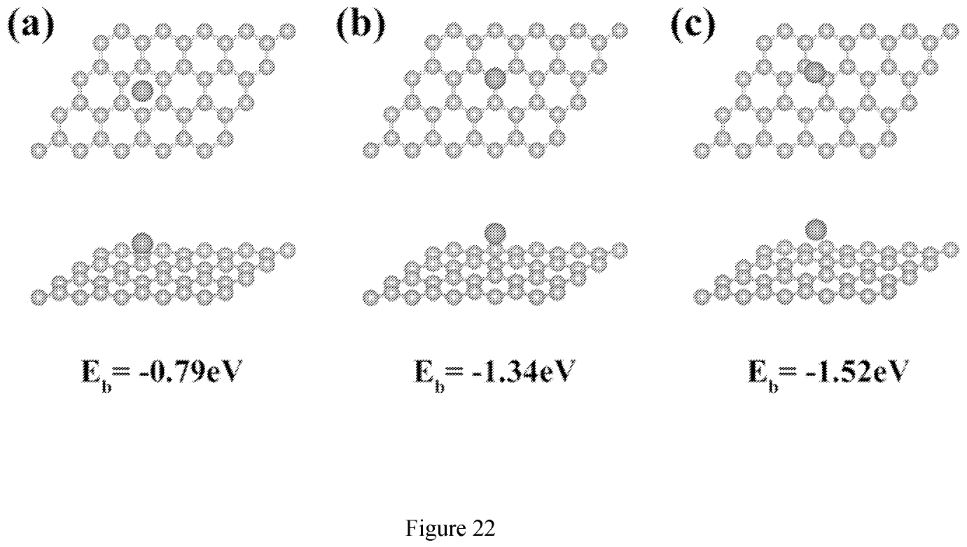

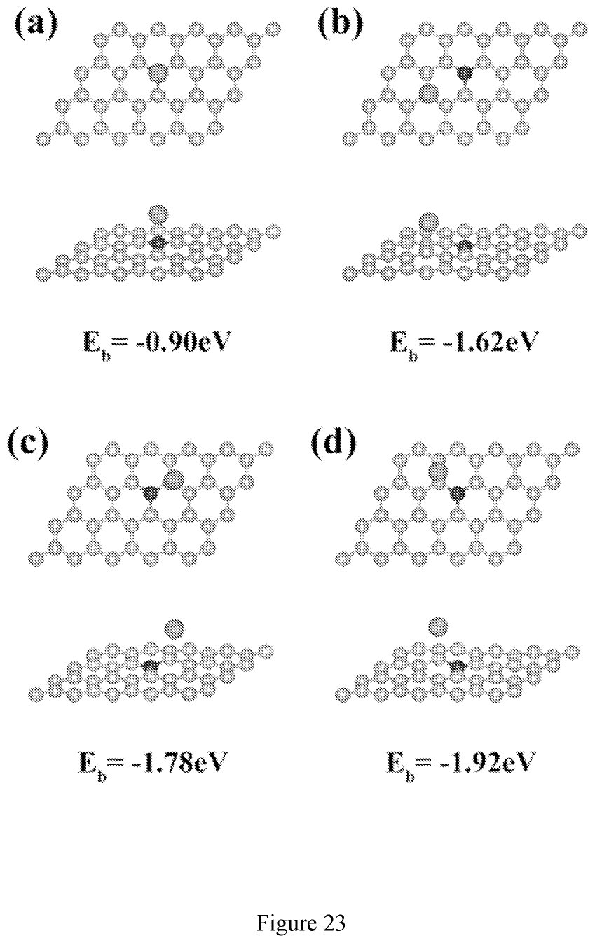

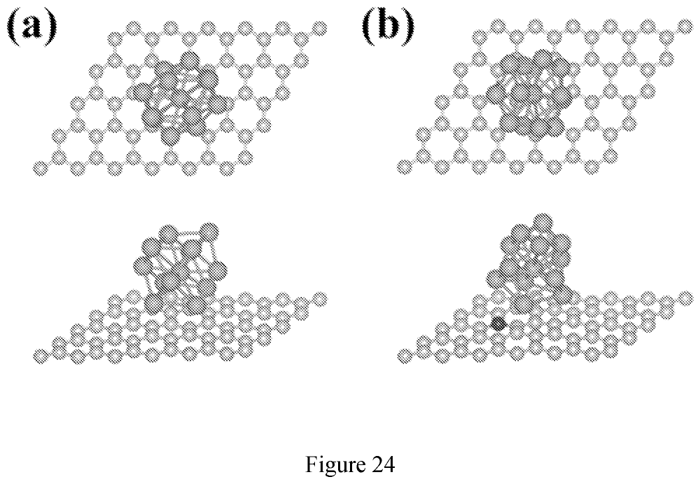

Density functional theory (DFT) calculations were performed to provide atomistic/electronic insights into the effects of N doping on the interaction between Pt and carbon supports. A model system consisting of a single Pt atom and a graphene layer with or structures of various possible adsorption configurations and the corresponding binding energies of a Pt atom on the graphene are shown in FIGS. 5e, 22, and 23. The calculated binding energies are negative for all the configurations, indicating that it is energetically favorable for a single Pt atom to be adsorbed on a graphene layer. For both pristine and N-doped graphene layers, the bridge site (right above a C—C bond) was found to be the most favorable adsorption site of a Pt atom on graphene. Moreover, DFT results showed that the bridge site adjacent to the N dopant was more attractive to the Pt atom as compared to those in the pristine graphene layer. The binding energy difference ΔE_{b} is calculated to be −0.40 eV, suggesting a strengthening effect somewhat stronger than the previously reported value of −0.23 eV. To further verify the anchoring effect of N dopant, the same strengthening parameter was evaluated for a cuboctahedral Pt₁₃ cluster adsorbed on the graphene layer, for which optimized structures are shown in FIG. 24. The N-doped graphene was found to bind the Pt₁₃ cluster more strongly than pristine graphene, with ΔE_{b} calculated to be −0.46 eV. Hence, these DFT predictions support the obtained experimental observations and spectroscopy results from both XPS and XAS, demonstrating how N dopant in the carbon support can improve the stability of Pt/C catalysts by binding Pt particles more strongly to the support.

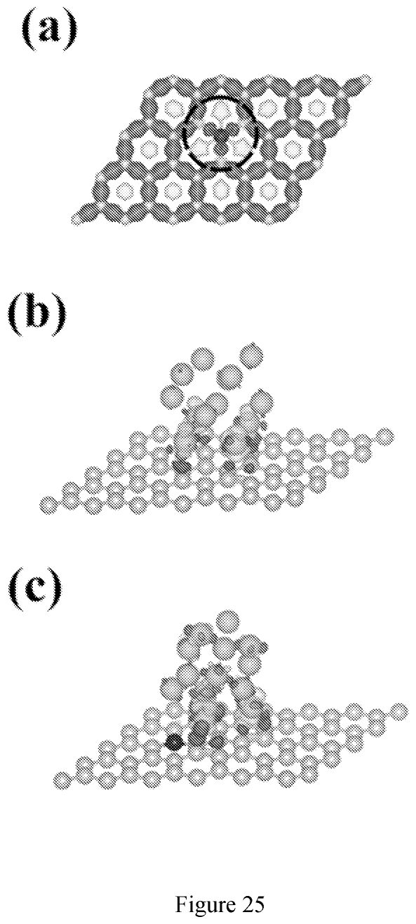

Point defects in graphene, such as graphitic N, are known to modify the local electronic structure. The charge density difference of an N-doped graphene layer is plotted in FIG. 25a. Nitrogen is more electronegative than carbon. Consequently, some amount of electron density is transferred from the adjacent C atoms to the N dopant, as can be observed in FIG. 25a. This leads to a positively charged region around C atoms and negatively charged region around the N dopant. Because the Pt₁₃ cluster acts as an electron donor (FIGS. 25b and c), these positively charged C atoms would increase the electron transfer from the Pt₁₃ cluster to the N-doped graphene layer indirectly, strengthening the interaction with the Pt₁₃ cluster. In this way, the binding strength between Pt clusters and the N-doped graphene would be enhanced.

Factors to stability enhancement of PGCs. To fully elucidate the key factors to the encouraging stability enhancement observed with the PGC support, the synthetic chemistry of PGCs was studied and assessed correlations among synthesis, structure, and properties. The parameters examined during the synthesis include carbonization temperature, type of metals (Fe, Co, Ni, or Mn) as catalysts, heat treatment temperature (800-1100° C.), duration (1 to 3 hours), and the post annealing treatment.

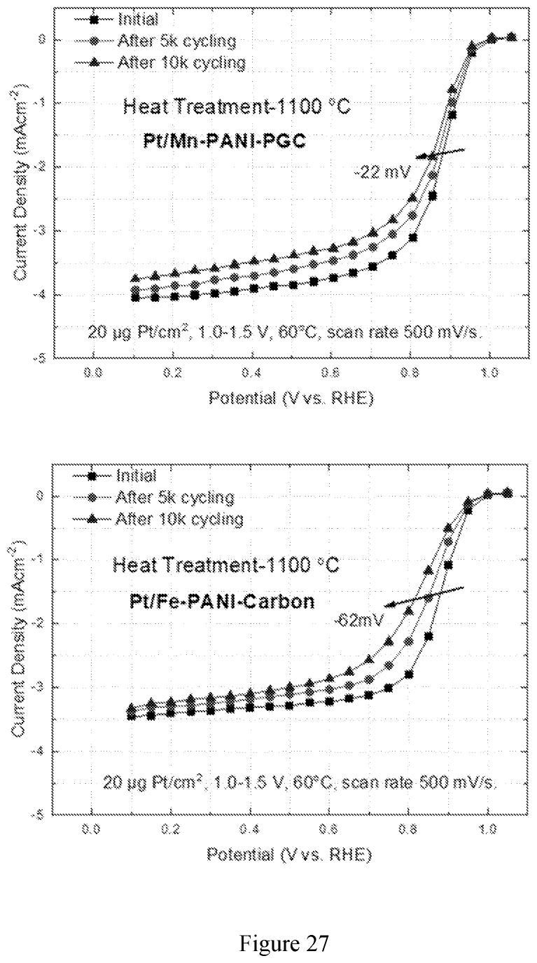

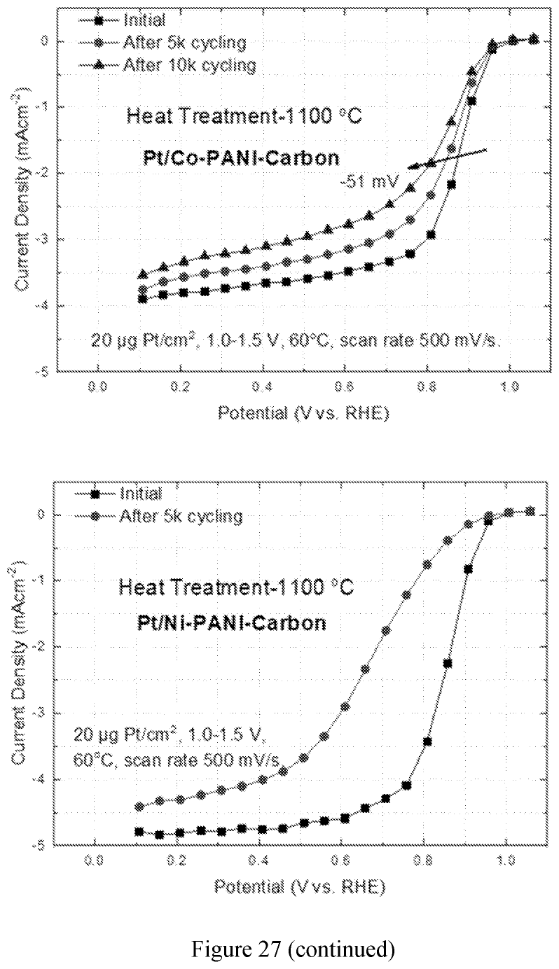

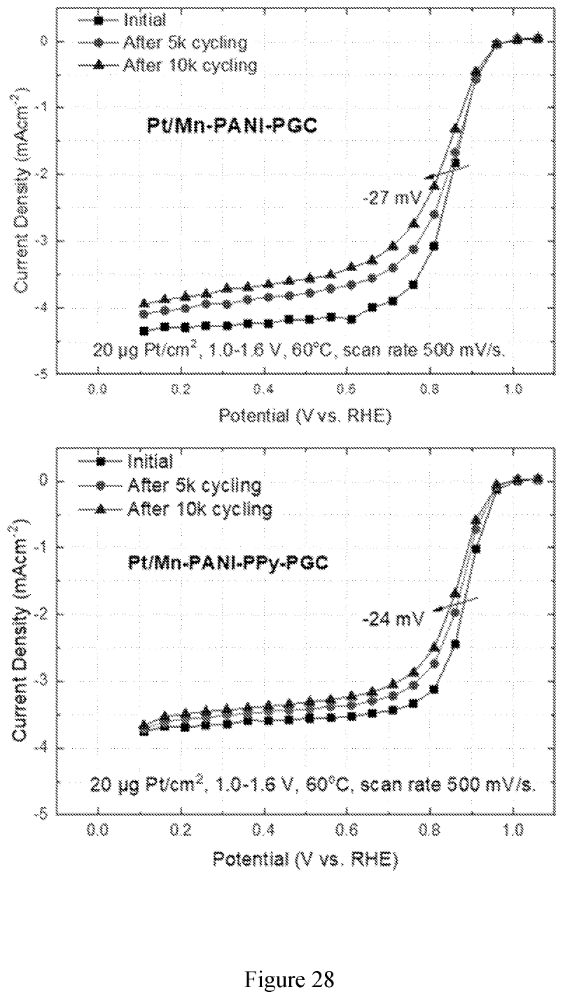

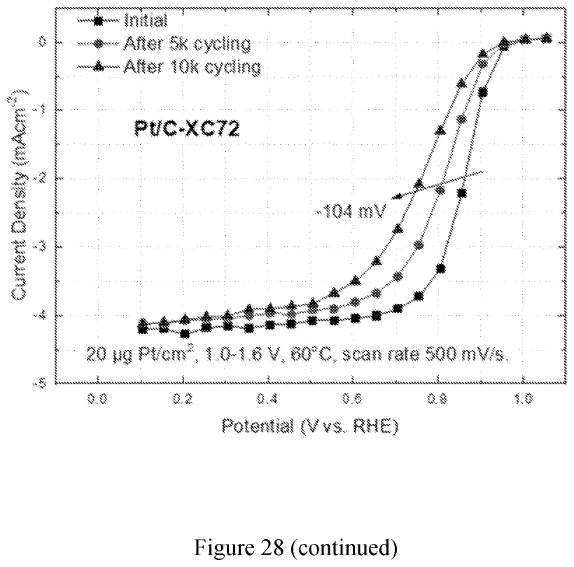

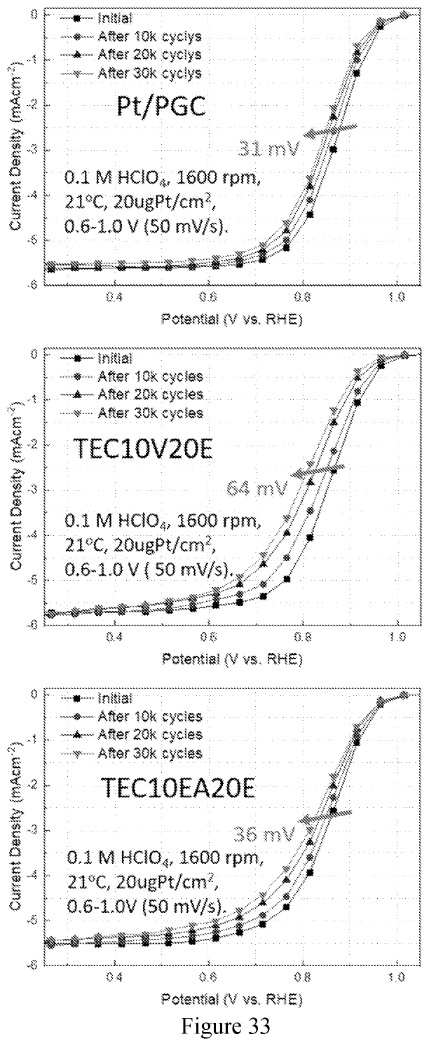

As the first heat treatment temperature can influence graphitization and morphology of carbon, the stability of PANI-Mn-derived PGC-supported Pt catalysts was compared as a function of heating temperature from 900° C. to 1100° C. (FIG. 33). Enhanced stability was observed with increasing heat treatment temperature up to 1100° C., in good agreement with the increased graphitization observed in Raman spectra (FIG. 2a). To study the role of Mn in catalyzing the graphitization process, the stability of Pt catalysts supported by Fe, Co, and Ni derived hydrogel carbon was compared (FIG. 27). These were synthesized by identical methods. Only Mn provided high stability by producing highly graphitized carbon, in agreement with Raman analysis (FIG. 9). These data confirm the important role of graphitization in determining the stability of PGC-supported Pt catalysts. Under even higher potential range cycling (1.0-1.6 V), PGC-supported Pt catalysts are still able to maintain good performance for 10,000 cycles. While 104 mV E_{1/2} loss was observed with the TEC10V20E, the best performing Pt/Mn-PANI-PPy-PGC only lost 24 mV under identical cycling conditions (FIG. 28).

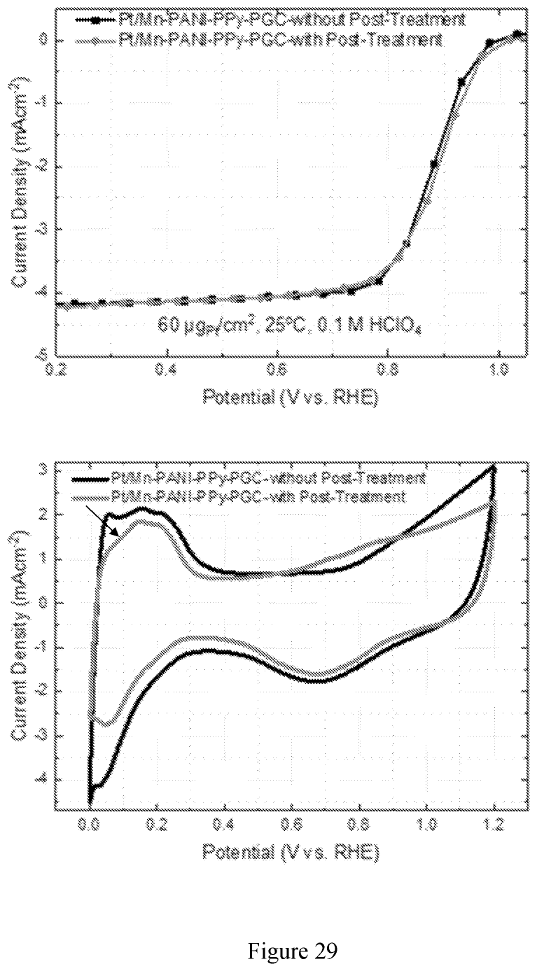

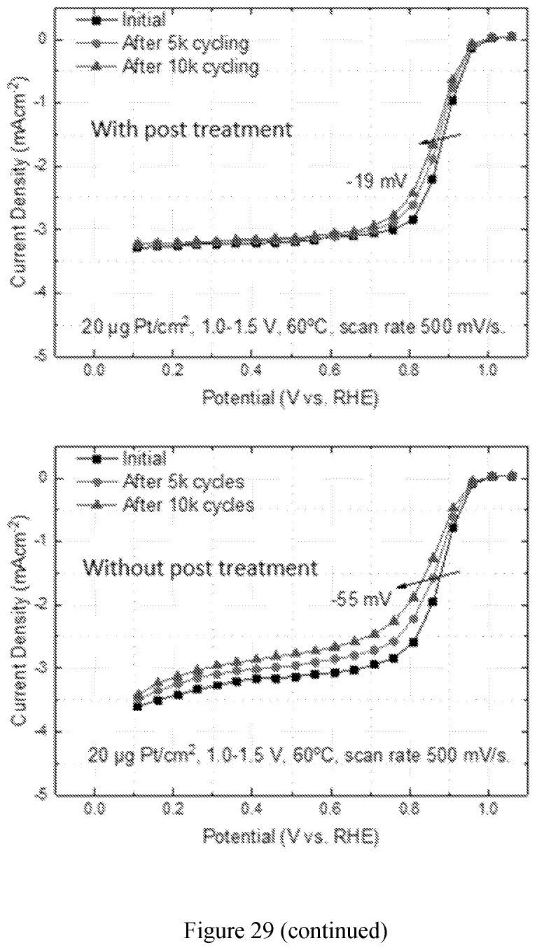

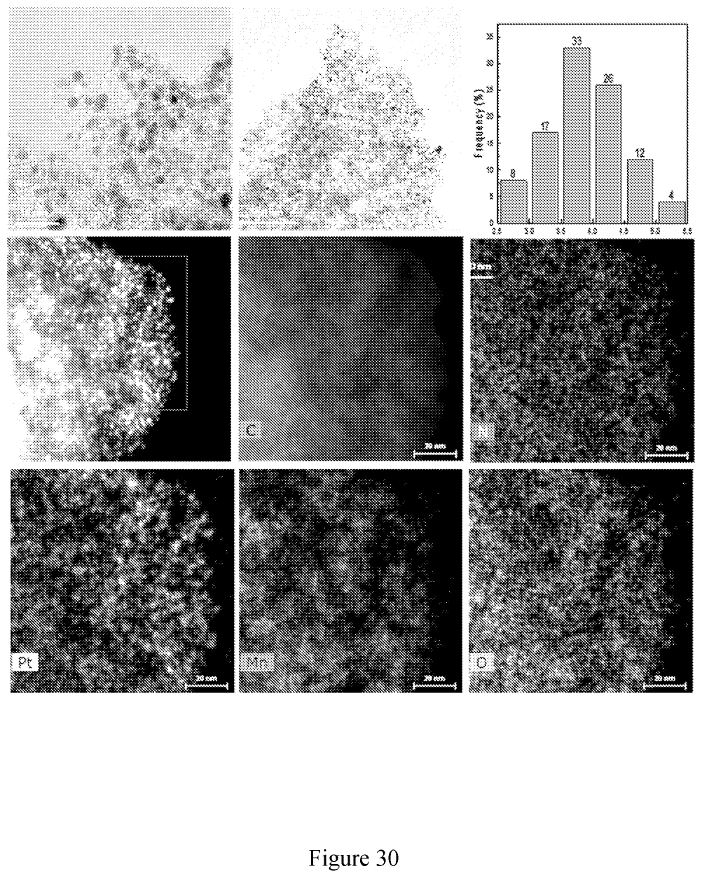

Post annealing treatment at 800° C. was applied to further stabilize the PGC-supported Pt catalysts. After post annealing treatment, the activity of Pt/Mn-PANI-PPy-PGC was improved slightly (FIG. 29), especially in the kinetic range. Importantly, the stability was enhanced significantly. A careful comparison of mapping images between FIG. 17 and FIG. 30 suggests that these improvements are caused by enhanced interactions between Pt and support induced by N doping. As identified by using in-situ HR-TEM, the slightly increased size of Pt nanoparticles from 3 to 5 nm during the annealing may also further stabilize the Pt catalysts.

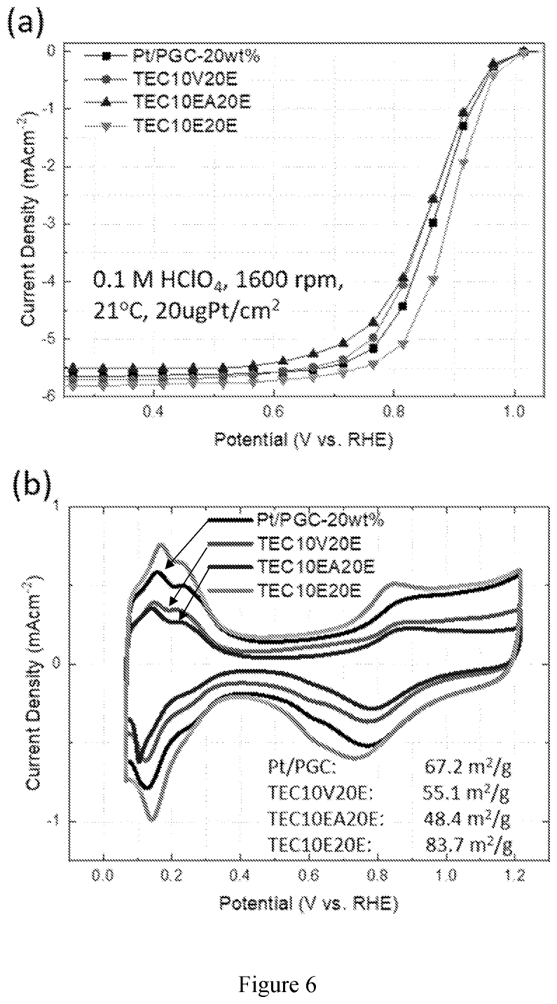

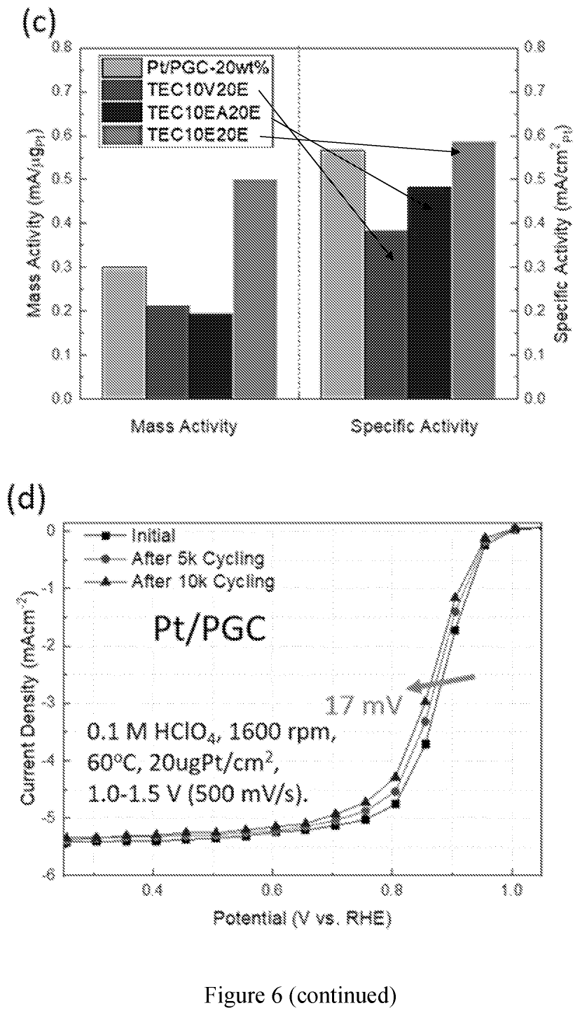

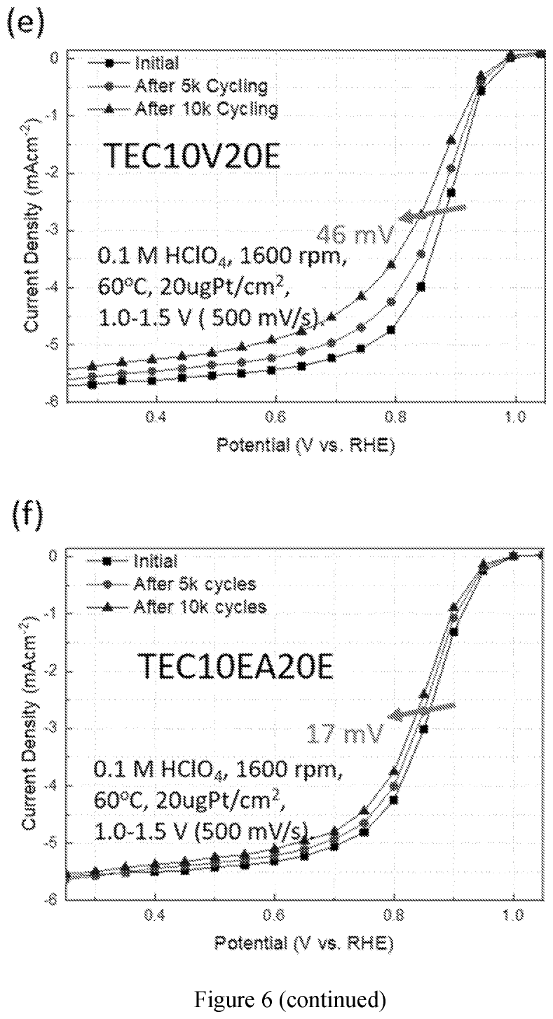

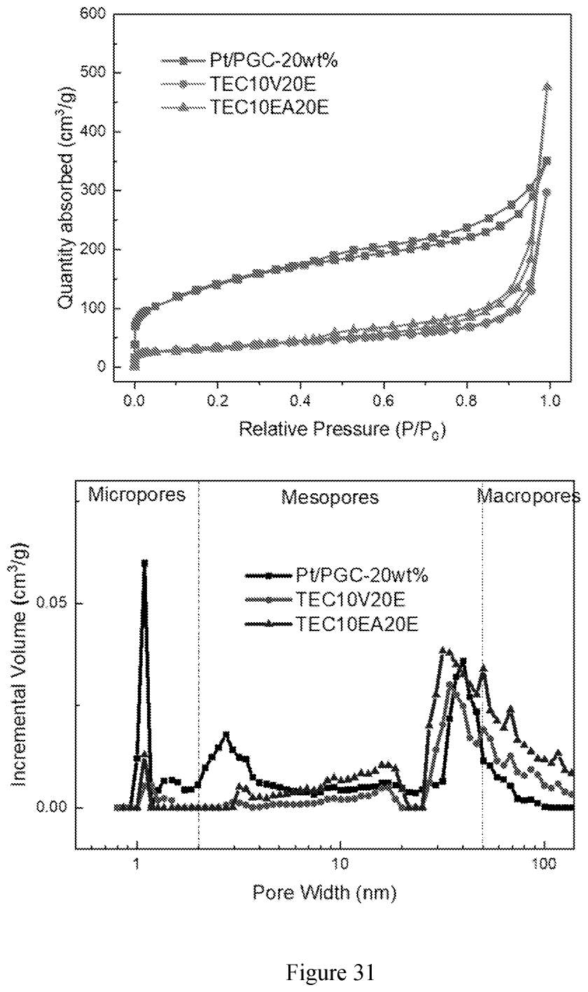

Catalyst activity and stability for the ORR. Electrochemical performance of the PGC-supported Pt and various commercial Pt/C catalysts, including TEC10V20E (Vulcan support), TEC10EA20E (graphitized carbon support), and TEC10E20E (high-surface-area carbon black), were measured in 0.1 M HClO₄ solution using a rotating disk electrode (RDE) for the ORR (FIG. 6a-c). Except for the TEC10E20E catalyst, which is supported on high-surface area carbon with highest electrochemical active surface area (ECSA) of Pt (83.7 m²/g), the Pt/PGC catalyst shows enhanced kinetic activity demonstrated by the positive shift of half-wave potential (E_{1/2}) when compared to TEC10V20E and TEC10EA20E. This is in good agreement with the increased ECSA of Pt deposited on PGC up to 67.2 m²/g_{Pt} vs TEC10V20E (55.1 m²/g_{Pt}) and TEC10EA20E (48.4 m²/g_{Pt}) (FIG. 6b). The increased ECSA of the Pt/PGC catalyst is likely due to more uniform dispersion of Pt nanoparticles on the PGC support, which is due to its higher BET surface area and unique hierarchical porosity shown in FIG. 31. A detailed comparison of various Pt catalysts in terms of their ECSA and Pt particle sizes was tabulated in Table 4. It should be noted that the measured limiting current densities for the various Pt/C catalysts are very close to the theoretical value calculated at a rotation speed of 1600 rpm. The mass activity, calculated from kinetic current densities with IR correction at 0.9 V, is listed in FIG. 6c. In a good agreement with the measurement of E_{1/2}, TEC10E20E exhibits the highest value around 500 mA/μg_{Pt}, followed by the Pt/PGC (300 mA/μg_{Pt}), TEC10V20E (210 mA/μg_{Pt}), and TEC10EA20E (190 mA/μg_{Pt}) catalysts. The lower mass activity of Pt/PGC relative to high-surface area TEC10E20E is probably due to larger Pt particle size and lower ECSA. However, the Pt/PGC specific activity is comparable to that of TEC10E20E, indicating a high intrinsic ORR activity. The comprehensive comparison of all studied Pt/C catalysts in terms of their steady-state polarization plots, ECSAs, mass activity, and specific activity demonstrate the favorable properties of PGC in enabling good ORR kinetics.

TABLE 4
Average particles size of Pt and their ECSA for different Pt/C catalysts.

| | Pt/C | | | | |
|---|---|---|---|---|---|
| | | Pt/PGC | | | |
| | | (Without post | | | |
| Properties | Pt/PGC | treatment) | TEC10V20E | TEC10EA20E | TEC10E20E |
| Average Pt | 5.61 | 3.83 | 3.4 | 3.87 | 2.94 |
| particles size- | | | | | |
| nm | | | | | |
| ECSA-m²/g | 67.2 | 74.6 | 55.1 | 38.4 | 83.7 |
| (H_{upd} analysis) | | | | | |

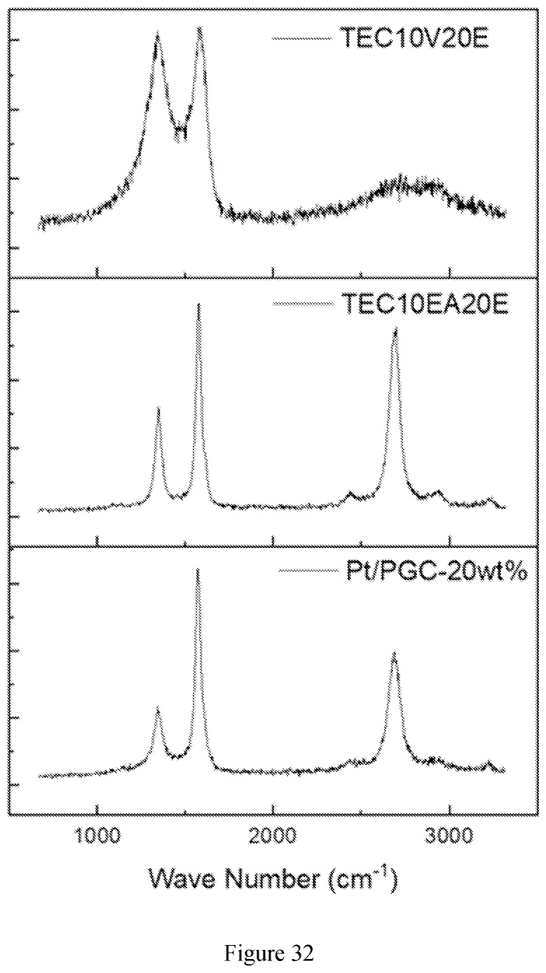

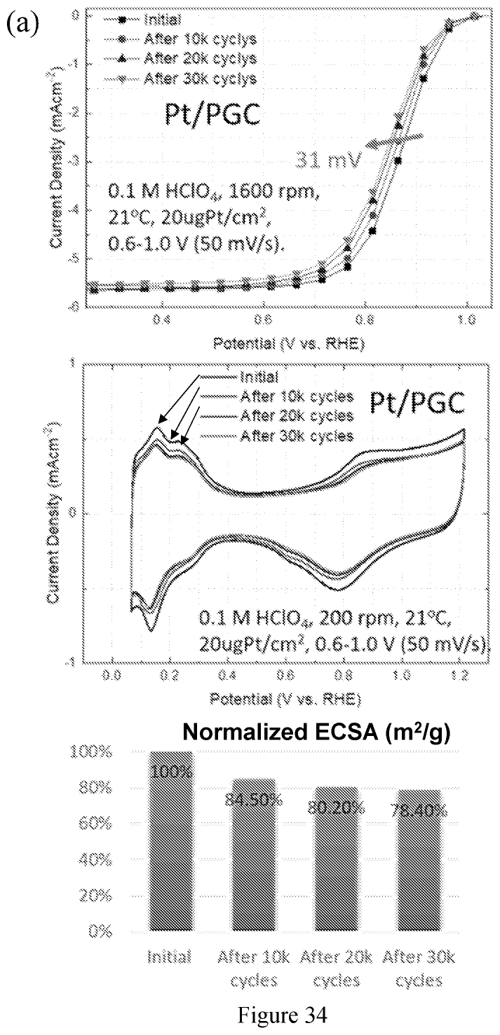

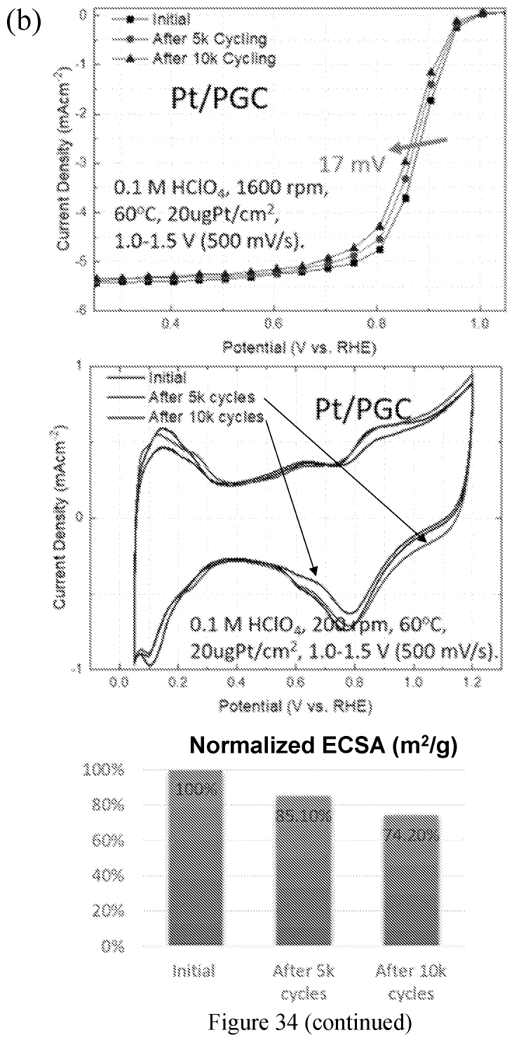

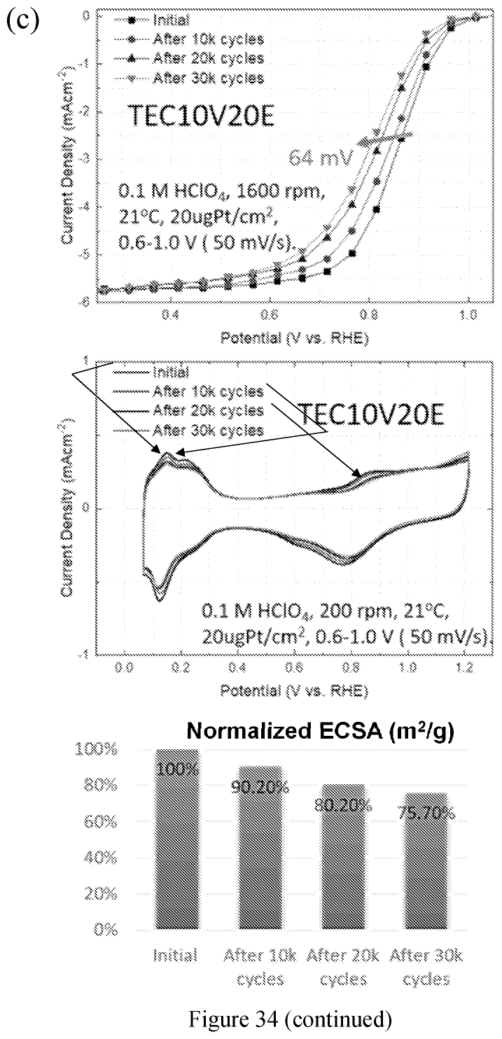

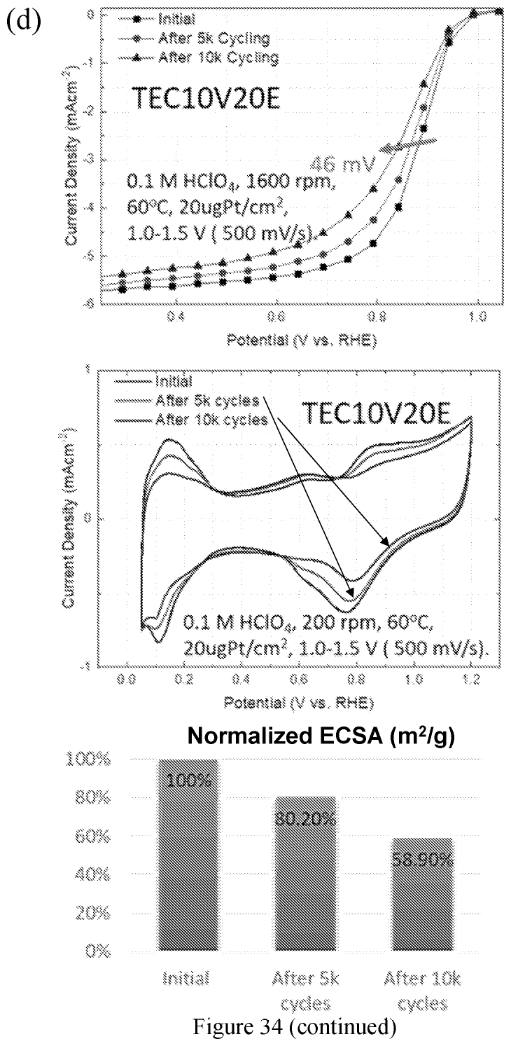

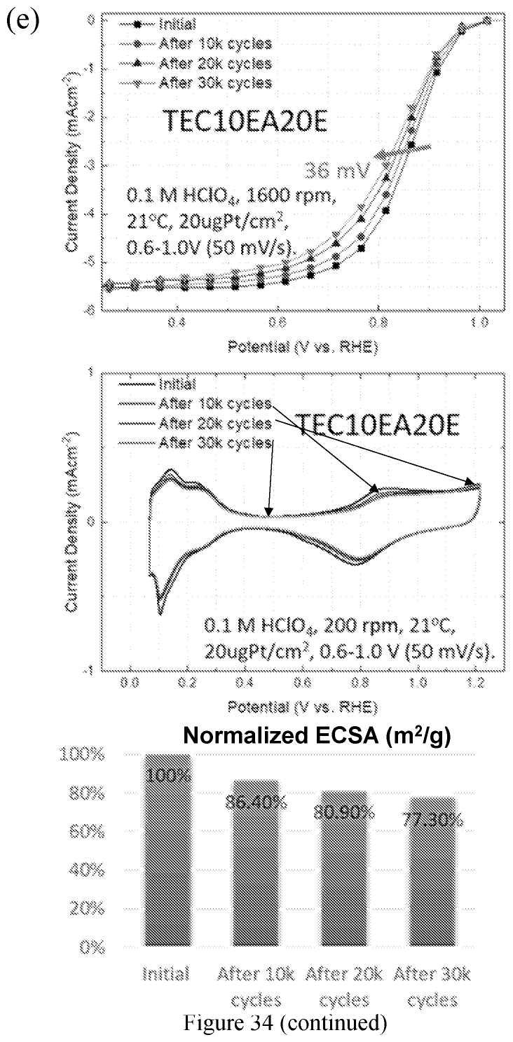

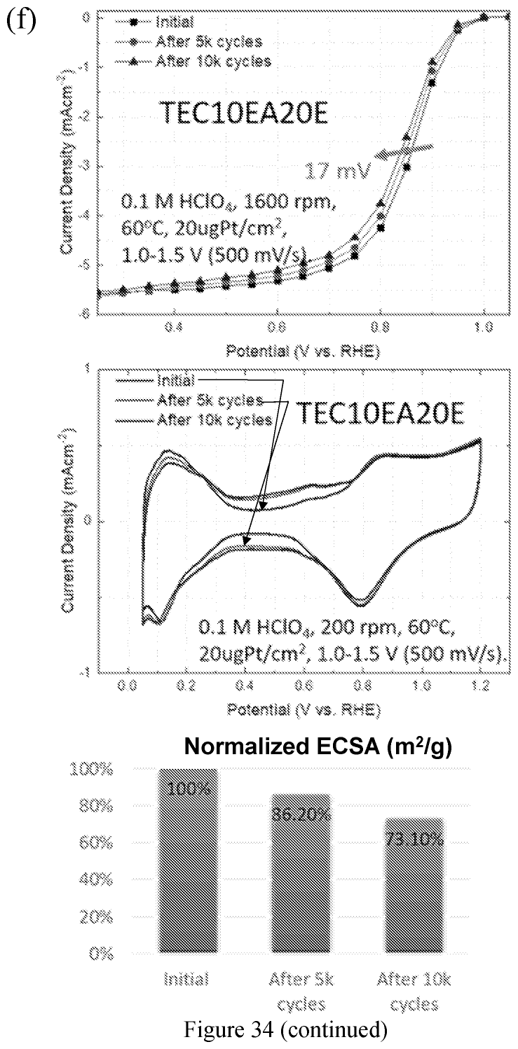

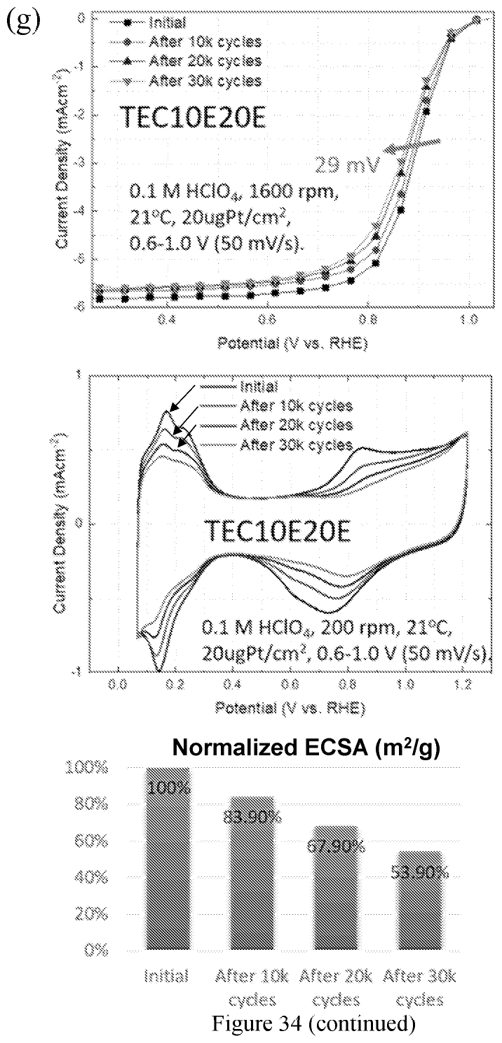

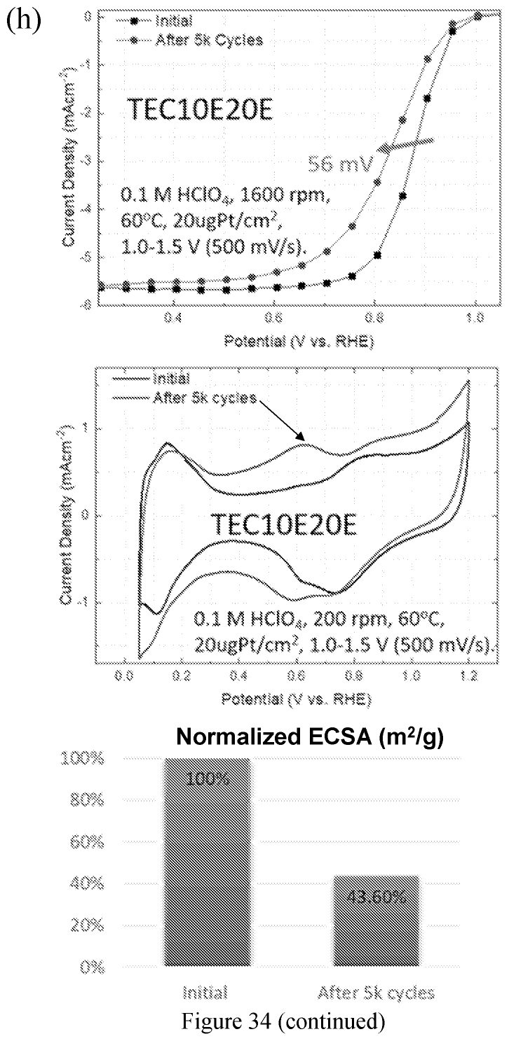

Accelerated stress tests (ASTs) were conducted on RDEs with a Pt loading of 20 μg_{Pt}/cm² by cycling the potentials in both low (0.6-1.0 V, 50 mV/s) and high (1.0-1.5 V, 500 mV/s) potential ranges to evaluate degradation of the Pt nanoparticles and the carbon support, respectively. To simulate the harsh environment in a fuel cell, electrolyte temperature was increased to 60° C. to study the carbon corrosion in high potential ranges. FIG. 6d-f compare the carbon support stability after 10,000 cycles from 1.0 to 1.5 V for various Pt catalysts. While 46 mV E_{1/2} loss was measured with the Vulcan carbon-based TEC10V20E, only 17 mV E_{1/2} loss was observed with both Pt/PGC and the graphitized TEC10EA20E catalysts. This indicates that, similar to the highly graphitized carbon support, the PGC can provide excellent carbon support stability under harsh oxidative conditions. This desirable carbon corrosion resistance for both PGC and highly graphitized carbon is in agreement with the Raman spectra in FIG. 32. In addition, FIG. 33 further compares the catalytic stability after 30,000 cycles at low potential cycles (0.6-1.0 V) to study the activity loss due to possible Pt particle agglomeration. Under this AST, the enhanced Pt catalyst stability on the PGC support (31 mV loss) was apparent compared to Vulcan, high-surface-area carbon and graphitized carbon supported Pt catalysts with losses of E_{1/2} of 64, 29 and 36 mV, respectively. The comparison also suggests that PGC provides strong interactions between Pt nanoparticle and support to hinder Pt agglomeration, likely due to the promotional role of N doping and the unique hierarchical porosity. A comprehensive comparison of stability tests for each of the Pt catalysts is provided in FIG. 34. Compared to the Vulcan support, the PGC provides significant stability improvement for both Pt nanoparticles and support. As for the highly graphitized carbon in the TEC10EA20E catalyst, even though they have comparable stability during high potential cycles, the PGC provides much higher Pt ECSA and higher ORR activity.

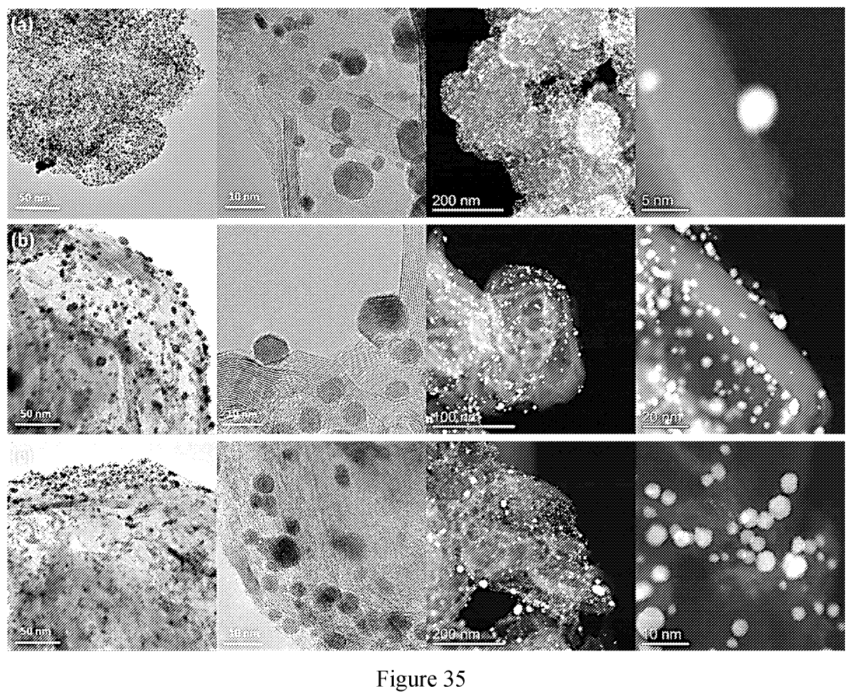

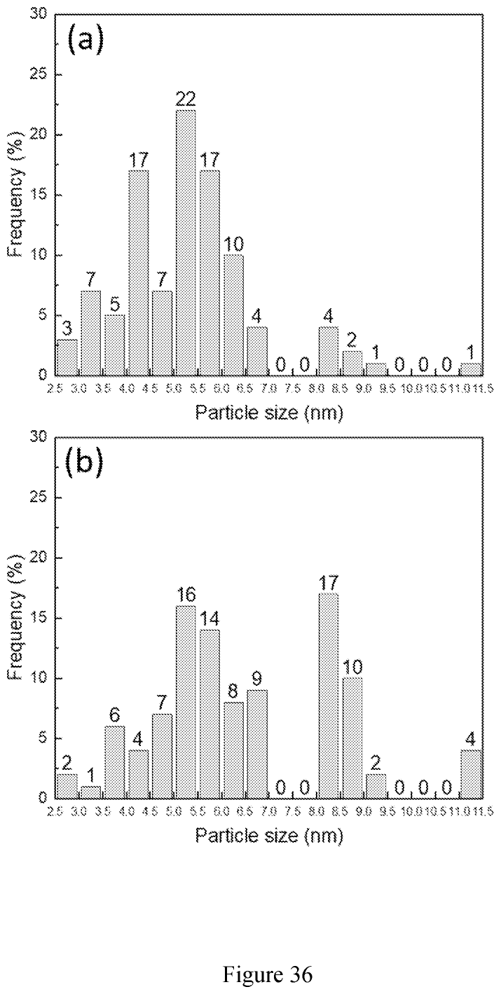

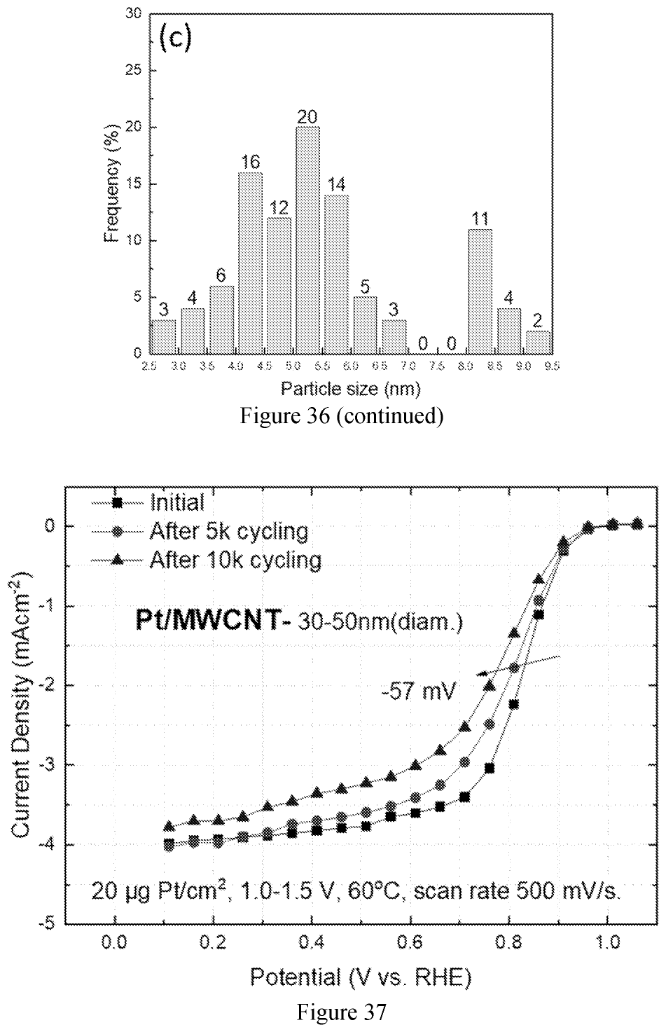

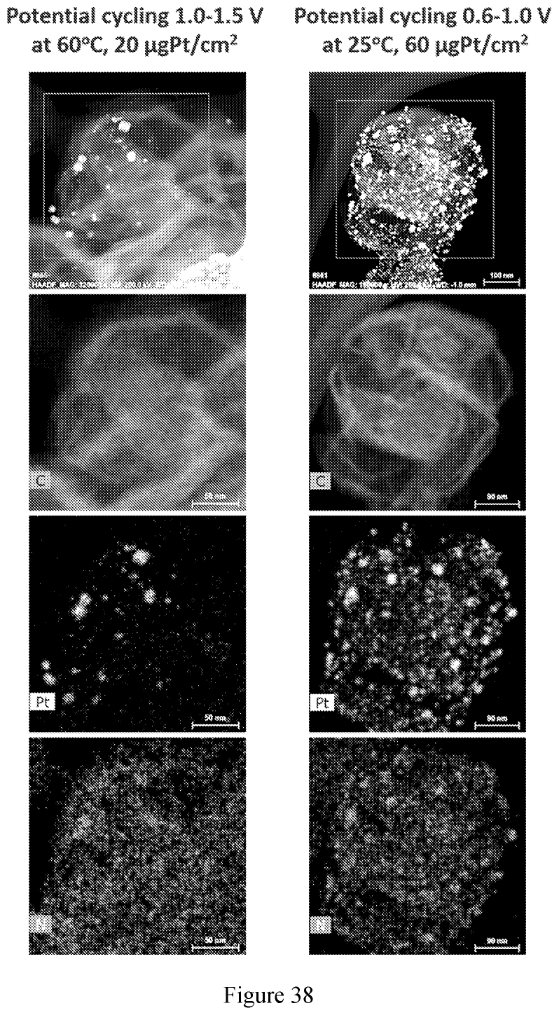

TEM and STEM images of the Pt/Mn-PANI-PPy-PGC catalyst after various ASTs, including both high and low potential cycling, are shown in FIG. 35. Before the ASTs, the mean Pt particle size was about 5.6 nm (FIG. 36a). A wide distribution of Pt particle size may result from the post annealing treatment. It should be noted that the mean Pt particle size for the Pt/Mn-PANI-PPy-PGC without post treatment is about 3.8 nm (FIG. 30), indicating that post treatment indeed increases the particle size (FIG. 4d), which benefits the catalyst stability (FIG. 29). While high potential ASTs lead to an increase of Pt particle size slightly from 5.6 to 7.2 nm (FIGS. 35 and 36) the graphitic carbon structure appeared unchanged. Due to the strengthened Pt and support interaction, Pt particle size distribution is nearly retained after low-potential ASTs except for the formation of some large particles up to 8.0-8.5 nm (FIG. 36). The Pt particles remained well dispersed on the graphitic carbon structure (FIG. 35c), indicating that this unique structure and morphology of PGC support was able to stabilize Pt particles. For a comparison, the same method to deposit Pt on nitrogen-doped multi-walled carbon nanotubes (MWCNTs) was used, which are representative of graphitized carbon material used previously. The poor stability of Pt/MWCNT shown in FIG. 37 suggests that, in addition to high graphitization degree, the unique porosity of PGC supports derived from polymer hydrogel provides further stabilization of Pt nanoparticles. In addition, after low potential ASTs, the mean Pt particle size remained nearly unchanged at 5.9 nm. Unlike the low surface area Vulcan carbon (250 m²/g), the enhancement of stability might be ascribed to the structural features of PGC, i.e., high surface area and porosity, which hinder the Pt growth. In particular, the highly folded graphitic structure might limit the movement of Pt particles. Thus, PGC with appropriate porosity, folded morphology, and high degree of graphitization enhances stability of Pt nanoparticles during the low potential range AST. Elemental mapping and overall morphologies of Pt/Mn-PANI-PPy-PGC after various ASTs are depicted in FIG. 38, showing that the carbon structures and the nitrogen doping are retained, and Pt nanoparticle growth is insignificant after low potential cycling.

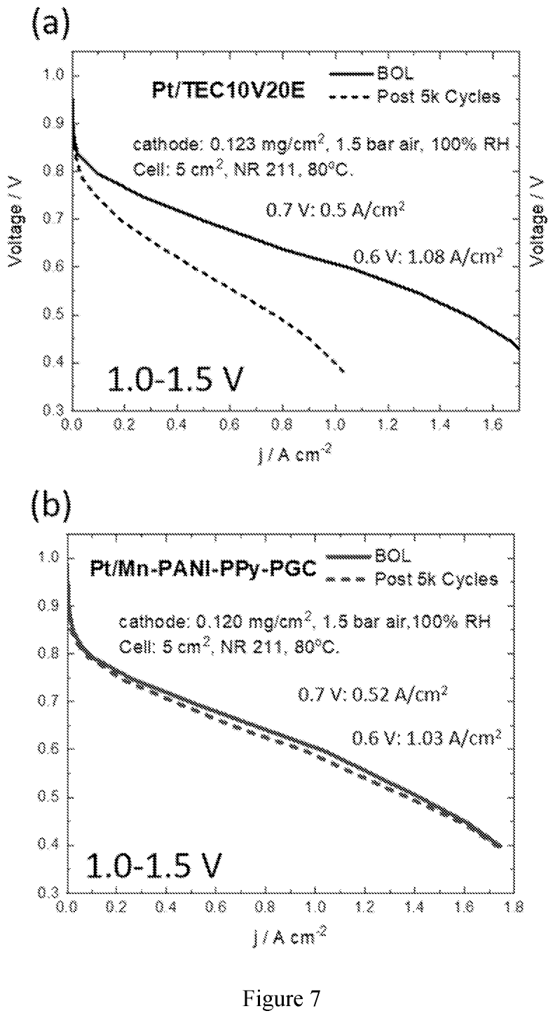

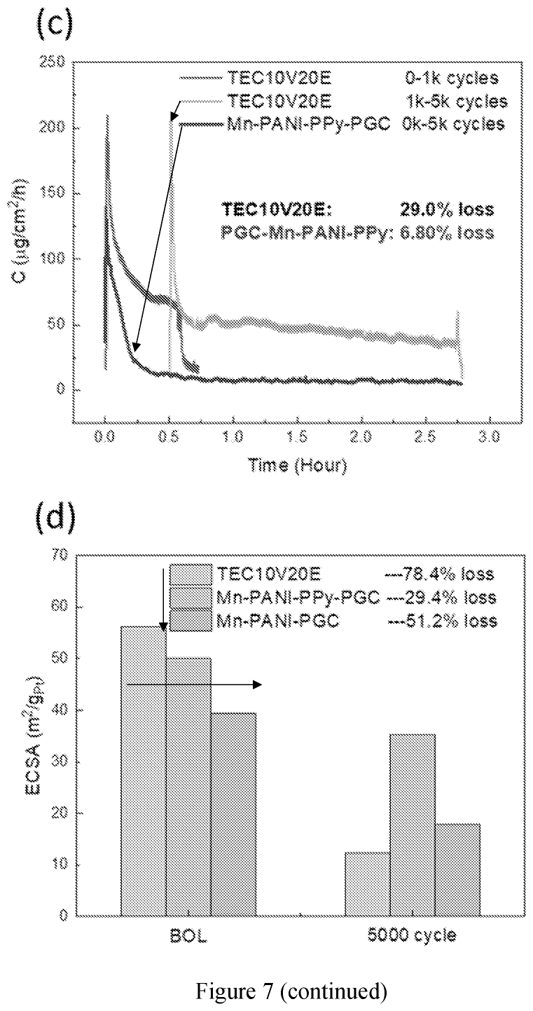

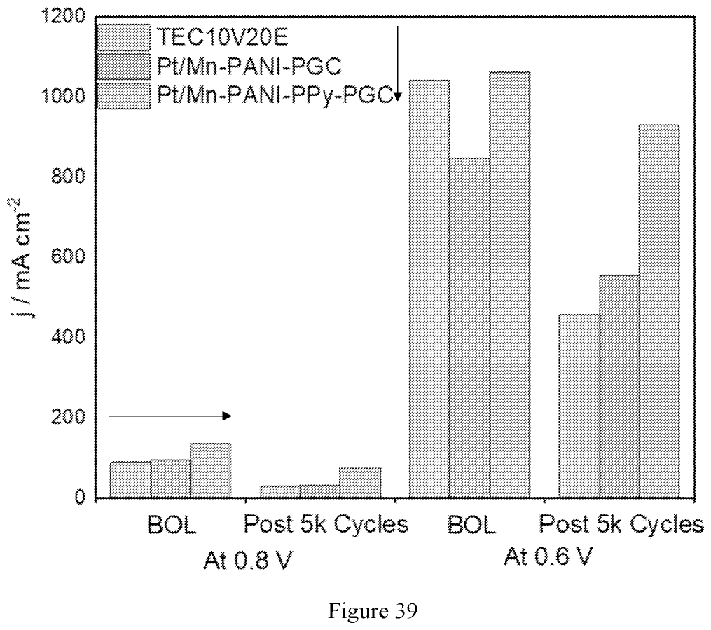

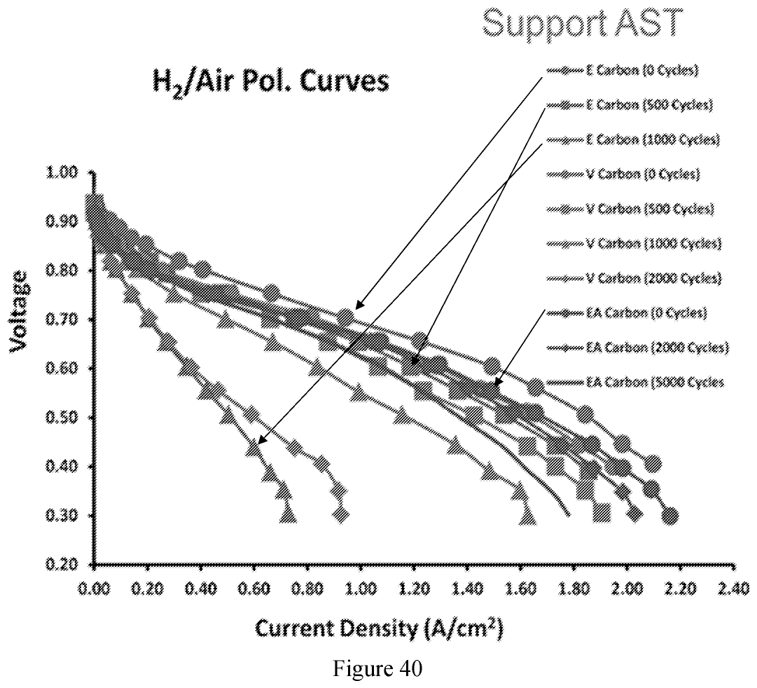

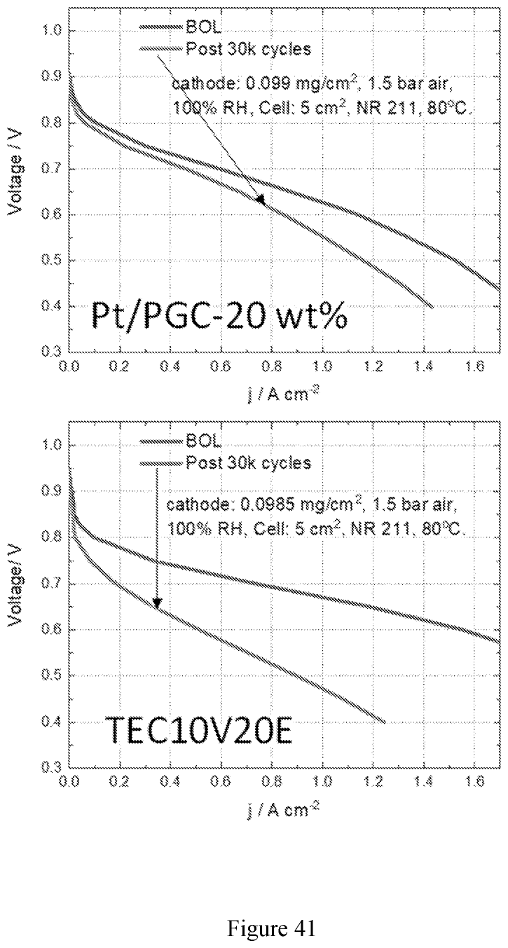

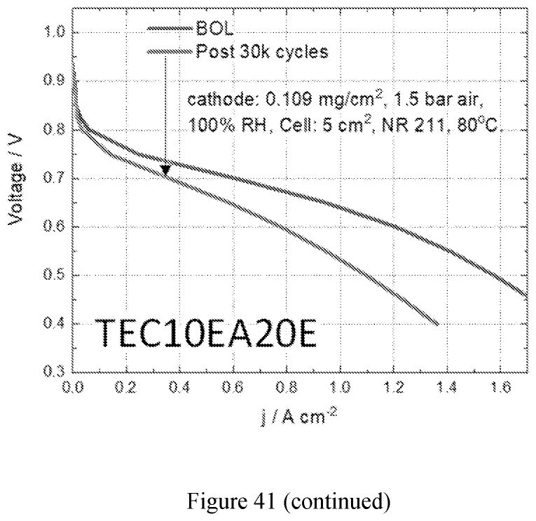

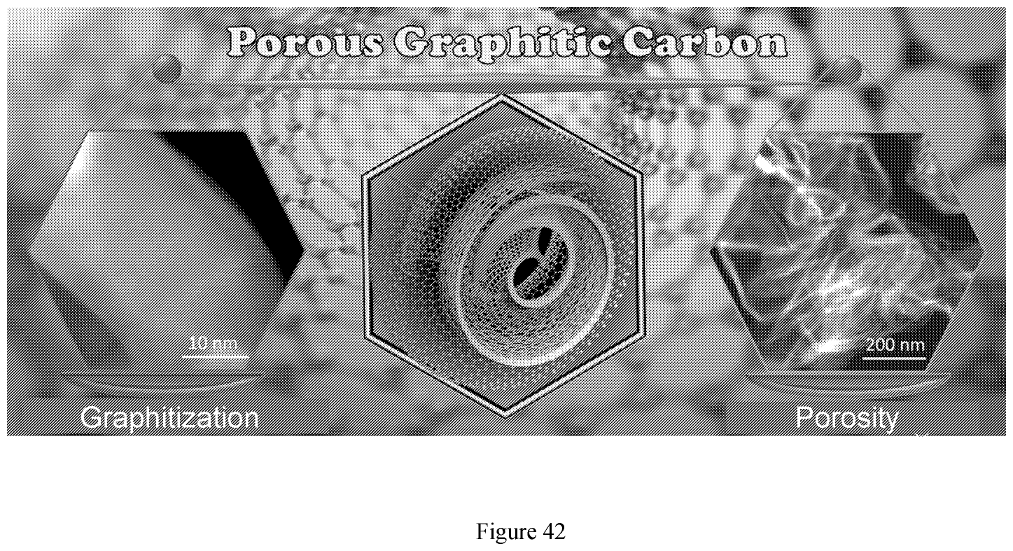

Fuel cell stability evaluation and carbon corrosion analysis. Given the significant difference of conditions between traditional RDE and fuel cells, the PGC-supported Pt catalysts were carefully evaluated in MEAS under a real fuel cell environment and compared with commercially available Pt/C catalysts. Polarization performance was measured in H₂/air, and ASTs were applied under H₂/N₂ in both high (1.0-1.5 V) and low (0.6-0.95 V) potential ranges at 80° C. and 100% RH. In addition to slightly enhanced initial fuel cell performance, the PGC-supported Pt catalyst, especially the Pt/Mn-PANI-PPy-PGC, exhibited significantly enhanced stability. In particular, after 5000 cycles from 1.0-1.5 V, the commercial Pt/C cathode (TEC10V20E) suffers from a serious degradation at a current density of 1.5 A/cm² (FIG. 7a) In contrast, the Pt/Mn-PANI-PPy-PGC catalyst demonstrated exceptionally high stability, with only 9 mV loss (FIG. 7b), easily meeting the DOE target of less than 30 mV loss. The performance losses summarized in FIG. 39 demonstrate the durability advantages of the Mn-PANI-PPy-PGC support in fuel cells. Carbon corrosion analysis shown in FIG. 7c demonstrates that carbon loss from TEC10V20E is almost five times higher than that of Pt/Mn-PANI-PPy-PGC under the same conditions. This is also in good agreement with the ECSA analysis carried out under fuel cell conditions (FIG. 7d), indicating a much smaller loss of ECSA for Pt/Mn-PANI-PPy-PGC (34.4%) relative to TEC10V20E (74.4%). The Pt/PGC catalyst is also superior to the highly graphitized carbon-based TEC10EA20E previously tested at Los Alamos National Laboratory in FIG. 40. These results demonstrate the excellent resistance to carbon corrosion and the high durability of Mn-PANI-PPy-PGC support, which significantly surpasses that of commercial carbons. For the low potential (0.6-0.95 V) range cycling, the performance of Pt/Mn-PANI-PPy-PGC is retained well, especially in the kinetic range when compared to other commercially available Pt/C catalysts (FIG. 41), which is in agreement with RDE testing results. The fuel cell testing results further confirm the significantly enhanced stability due to the use of the Mn-PANI-PPy hydrogel-derived carbon. Table 5 further provides a detailed comparison of the unique properties and performance of the newly developed PGC with commercial Pt/C catalysts based on various carbon supports for fuel cell applications.

TABLE 5
A detailed comparison of properties and performance enhancement between the developed
PGC and the state of the art XC-72 carbon and other studied carbon supports.

| | | | RDE measurements (20 μg/cm²) | | | | | |
|---|---|---|---|---|---|---|---|---|
| | | | | | | Stability-Degradation of | | |
| | | | | | | E_{1/2}, (V vs. RHE) | | |
| | | | | Mass | Specific | Catalyst | Support | |
| | | | | Activity | Activity | AST | AST | |
| Catalysts | | BET | | @ 0.9 V | @ 0.9 V | (25° C., | (60° C., | |
| properties | I_{(D)}/I_{(G)} in | Surface | | (mA/μg_{Pt}) | (mA/μg_{Pt}) | 0.6-1.0 V, | 1.0-1.5 V, | |
| and | Raman | area | E_{1/2} (V | (IR | (IR | 50 mV/s) | 500 mV/s) | EASA |
| performance | Spectra | (m²/g)_{—} | vs. RHE) | correction) | correction) | 30k cycles | 10k cycles | (m²/g) |
| Pt/PGC | 0.32 | 388 | 0.878 | 0.301 | 0.567 | −31 | −17 | 67.2 |
| TEC10V20E | 0.81 | 153 | 0.851 | 0.211 | 0.383 | −64 | −46 | 55.1 |
| TEC10EA20E | 0.51 | 113 | 0.848 | 0.193 | 0.482 | −36 | −17 | 38.4 |
| Nitrogen- | 0.71 | 89 | 0.887 | 0.02 | 0.04 | −35 | −66 | 40.1 |
| doped | | | | | | | | |
| graphene | | | | | | | | |
| tubes | | | | | | | | |
| supported Pt | | | | | | | | |
| Nitrogen | 0.34 | 101 | 0.876 | 0.02 | 0.04 | — | −57 | 43.4 |
| doped | | | | | | | | |
| MWCNTs | | | | | | | | |
| supported Pt | | | | | | | | |

| | MEA measurements (0.12 mg/cm²) | | | | | |
|---|---|---|---|---|---|---|
| | | | | | EASA | Carbon |
| | | | Stability Degradation at | | loss after | loss after |
| | | | 0.8 A/cm², (mV) | | support | support |
| | | | Catalyst | Support | AST | AST |
| Catalysts | Mass | Mass | AST | AST | (80° C., | (80° C., |
| properties | Activity | Activity | (80° C., | (80° C., | 1.0-1.5 V) | 1.0-1.5 V) |
| and | @0.9 V | @0.7 V | 0.6-0.95 V) | 1.0-1.5 V) | 5k cycles | 5k cycles |
| performance | (mA/μg_{Pt}) | (mA/μg_{Pt}) | 30k cycles | 5k cycles | (%) | (%) |
| Pt/PGC | 0.373 | 4.62 | −59 | −16 | 34.4 | 6.8 |
| TEC10V20E | 0.234 | 4.07 | −150 | −200 | 78.4 | 29 |
| TEC10EA20E | — | — | — | −29 | — | — |
| Nitrogen- | 0.177 | 2.85 | — | 52 | 40.7 | 11.2 |
| doped | | | | | | |
| graphene | | | | | | |
| tubes | | | | | | |
| supported Pt | | | | | | |
| Nitrogen | — | — | — | | — | — |
| doped | | | | | | |
| MWCNTs | | | | | | |
| supported Pt | | | | | | |

To address the grand stability challenges of Pt/C catalysts for fuel cell applications, a highly stable and favorable carbon support for Pt nanoparticles based on a polymer composite hydrogel precursor comprising PANI and PPy as carbon/nitrogen sources in combination with Mn as a graphitization catalyst was developed. The stability enhancement was carefully and comprehensively evaluated in both aqueous acidic electrolyte-based RDE and real fuel cell conditions by using a variety of accelerated stress test protocols recommended by U.S. DOE. The Mn-PANI-PPy hydrogel-derived carbon provides high graphitization degree and good morphology (e.g., sufficient surface area, and porosity), enabling exceptional catalytic stability. Among many findings, the importance of binary PANI and PPy polymer hydrogel was discovered and the unique role of Mn during the carbonization, which yield dramatically increased degree of graphitization and favorable hierarchical pore morphology for increased Pt utilization and strengthened metal-support interactions. Compared to other possible metals (e.g., Fe, Co, or Ni) as catalysts during the graphitization process, Mn was found to play an indispensable role in forming the highest degree of graphitization at optimized temperature and duration of the carbonization process. In addition to their excellent electrochemical properties as catalyst supports, these PGC materials are more suitable for low-cost manufacturing, since temperatures of only 1100° C. are needed, compared with heat treatments up to 3000° C. required for conventional graphitized carbons. In-situ HR-TEM and STEM further reveal that Mn is able to be uniformly dispersed into the hydrogel precursors at high temperature and effectively catalyze the graphitization process. Unlike other transition metals, Mn itself does not alloy with Pt and can be removed during the subsequent acidic leaching treatment. Post annealing treatment was found to strengthen Pt-support interactions, further enhancing stability. Importantly, the promotional role of nitrogen doping in facilitating the activity and stability enhancement was validated through high-resolution microscopy and X-ray absorption spectra in combination with theoretical DFT calculations. A high likelihood of Pt—N interaction is due to the possible electron transfer from Pt nanoparticles to N dopant in carbon support, leading to strengthened interactions of metal and supports by binding Pt atoms strongly to the graphitic N, while electron transfer from C to adjacent N atoms results in stronger interaction between Pt and C.

The high surface area, abundant porosity, and N doping present in PGCs create a favorable environment to disperse Pt nanoparticles and prevent agglomeration. Meanwhile, the remarkably improved degree of graphitization enhances carbon corrosion resistance in fuel cell cathodes. The well balanced porosity and graphitization of PGCs provide unique structural and morphological advantages to produce highly active and stable carbon supported Pt catalysts for PEMFCs. This new type of PGC-supported Pt catalyst significantly surpasses the state-of-the-art Pt/C and provides exceptionally enhanced stability with minimized carbon loss at high potentials. The advanced PGC represents a new class of carbon for fuel cells with extraordinarily enhanced durability.

Experimental Details.

Synthesis of Mn-hydrogel derived porous graphitic carbons. To prepare Mn-PANI hydrogel-derived PGC, 1.32 g (14.16 mmol) aniline and 1.62 g (7.08 mmol) ammonium persulfate (APS) was dissolved in separate 2.0 M hydrochloric acid (HCl) solutions (6 mL each). These two solutions were denoted as solution A (aniline solution) and solution B (APS solution). Subsequently, 2.8 g (14.16 mmol) manganese chloride tetrahydrate was dissolved into solution A. Then, solution B was gradually added into solution A, and shaken gently in a vial for 30 seconds. The resulting gel-like mixture was aged at room temperature for 24 h. Freeze-drying was used to remove solvent while retaining the porous structure of the PANI hydrogel composite. The resulting solid powder was processed by thorough grinding followed by a heat treatment at 900, 1000, or 1100° C. for 1 h under nitrogen (N₂) flow with a ramp rate of 3° C./min. The pyrolyzed solid powder was leached with 0.5 M H₂SO₄ at 80° C. for 5 h and then dried at 60° C. in a vacuum oven for 12 h. A second heat treatment was then carried out at 900° C. for 3 h under N₂ flow with a ramp rate of 3° C./min. The obtained sample heated at 1100° C. (the first heat treatment) is denoted as Mn-PANI-PGC. For Mn-PANI-PPy-PGC, 0.47 g (7.08 mmol) pyrrole was added together with aniline in solution A, and other steps and procedures remained the same.

Method to deposit Pt nanoparticles. Pt nanoparticle deposition onto the Mn-hydrogel-derived PGC supports was performed through an ethylene glycol (EG) reduction method with a controlled Pt mass loading of 20 wt %. The carbon support powder was dispersed in EG by sonication for 1 hour to form a homogeneous complex suspension. Then, a given amount of hexachloroplatinic acid solution (10 mg/mL) was added into EG solution under stirring for 20 minutes with N₂ bubbling. The suspension was refluxed for 4 hours at 130° C. under continuous stirring. The catalysts were washed with Millipore water until no Cl⁻ could be detected by AgNO₃ solution and dried at 60° C. in a vacuum oven for 12 hours. The as-prepared samples were subsequently heat-treated in N₂ at 800° C. for 30 mins. The final catalysts were identified as Pt/Mn-PANI-PGC or Pt/Mn-PANI-PPy-PGC when Mn-PANI and Mn-PANI-PPy hydrogel were used for carbon preparation, respectively.

Physical characterization. Raman spectra were collected on a Renishaw Raman system at 514 nm laser source to analyze carbon structures. Excitation power was held constant at ˜150 μW for all samples, which were prepared as powders on a glass surface. The excitation laser was focused through a 100× microscope objective for a total interrogation spot size of ˜1 micron diameter. Scattered light was collected in backscatter configuration into an optical fiber and then dispersed through the Renishaw spectrometer and projected onto a CCD camera. Brunauer-Emmett-Teller (BET) surface area and porosity were measured by using N₂ adsorption/desorption at 77 K on a Micromeritics Tri Star II. Scanning electron microscopy (SEM) images were obtained on a Hitachi SU 70 microscope at a working voltage of 5 kV. Bright field and high-resolution transmission electron microscopy (HRTEM) images, and scanning TEM-energy dispersive spectroscopy (STEM-EDS) elemental maps were obtained with a Talos F200X (Thermo Fisher Scientific) at an accelerating voltage of 200 kV.

For in-situ analysis, samples were firstly dispersed in methanol and the suspension was deposited directly onto a thermal chip (DENS Solutions). The temperature was controlled with a MEMS heating stage from DENS Solutions. The in-situ electron microscopy was performed on an aberration-corrected transmission electron microscopy (FEI Titan 80/300), operating at 300 kV. The beam was blanked during the in-situ heating processes and the samples were only exposed to the beam during date setup and acquisition processes. The element mapping was conducted on a high-resolution analytical scanning/transmission electron microscope (S/TEM, FEI Talos F200X) operating at 200 keV. The elemental mappings were acquired with a four-quadrant 0.9-sr energy dispersive X-ray spectrometer (Super EDS).

X-ray diffraction (XRD) was conducted by using a Rigaku Ultima IV diffractometer with Cu K-α X-rays. X-ray photoelectron spectroscopy (XPS) was performed with a Kratos AXIS Ultra DLD XPS equipped with a hemispherical energy analyzer and a monochromatic Al Kα source operated at 15 keV and 150 W and pass energy was fixed at 40 eV for the high-resolution scans. Samples were prepared as pressed powder supported on a metal bar for the measurements. The FWHM of the major XPS peaks ranged from 0.3 eV to 1.7 eV for the relevant elements. All the instrument parameters were constant including FWHMs, peak shapes, instrument design factors, chemical shifts, experimental settings and sample factors. The binding energy of Au was used as the reference. Pt particle size distributions were measured by TEM images of more than 200 particles for different catalysts. Pt L₃-edge X-ray absorption spectroscopy (XAS) including X-ray absorption near edge structure (XANES) and extended X-ray absorption fine structure (EXAFS) experiments were carried out at beamline 20-BM at the Advanced Photon Source, Argonne National Laboratory. The EXAFS data were collected in transmission mode and the energy scale was using a Pt foil. Data analysis was performed using the Athena and Artemis software packages.

Electrochemical measurements. All electrochemical measurements were performed on a CHI Electrochemical Station (Model 760b) equipped with high-speed rotators from Pine Instruments. A rotating ring disk electrode (RRDE) from Pine Research Instrumentation (model: AFE7R9GCPT, USA) was used as the working electrode, containing glassy carbon disk and platinum ring: disk OD=5.61 mm; ring OD=7.92 mm; ID=6.25 mm. An Hg/HgSO₄ reference electrode and a graphite rod counter electrode with a diameter of 0.250 inches and a length of 12 inches were used to complete the cell. To prepare the working electrode, 10 mg catalyst was dispersed ultrasonically in a 1.0 mL mixture of isopropanol and Nafion (5 wt. %) solution to form an ink. Then the ink was drop-casted on the disk electrode with a designed loading of 20 μg_{Pt}/cm² or 60 μg_{Pt}/cm² and dried at room temperature to yield a thin-film electrode. All the cyclic voltammetry (CV) and ORR polarization curves were recorded in 0.1 M HClO₄ and the ORR activity was measured in 0.1 M HClO₄ saturated with O₂ at 900 rpm or 1600 rpm using steady-state polarization plots by holding each potential for 30 s (s=second(s)) with potential step of 30 mV. The accelerated stress tests (ASTs) were applied to evaluate catalyst stability by cycling the potentials in both low (0.6-1.0 V, 50 mV/s, 25° C.) and high (1.0-1.5 fd V, 500 mV/s, 60° C.) potential ranges in 0.1 M HClO₄ saturated with N₂ by using RDE. All reference potentials have been converted to reversible hydrogen electrode (RHE). As comparison, three kinds of Pt/C catalyst from TKK were studied regarding to activity and durability, including TEC10V20E, TEC10EA20E and TEC10E20E.

Fuel Cell Fabrication and Testing. Catalysts were incorporated into MEAs by spraying of a water/n-propanol based ink onto a 5 cm² area of a Nafion 211 membrane. Each electrode was prepared with Pt loading of 0.1 mgPt/cm², and 29BC gas diffusion layers (SGL Carbon) were used on both anode and cathode. H₂-air fuel cell testing was carried out in a single cell using a commercial fuel cell test system (Fuel Cell Technologies Inc.). The MEA was sandwiched between two graphite plates with straight parallel flow channels machined in them. The cell was operated at 80° C., with 150 kPa_{abs} H₂/air or H₂/O₂, and a gas flow rate of 500/2000 sccm for anode/cathode, respectively. Catalyst mass activity was measured via the DOE/FCTT protocol (potential step from 0.6 V to 0.9 V and 15 min hold, current averaged during last 1 min) in 150 kPa_{abs} H₂/O₂ (80° C., 100% RH, 500/2000 sccm) with correction for measured H₂ crossover. The ECSA was obtained by calculating H adsorption charge in CV curves between 0.1-0.4 V (0.45-0.55 V background subtracted) at 30-35° C. with 500 sccm H₂ on the anode and stagnant N₂ on the cathode, assuming a value 210 μC/cm² for the adsorption of a H monolayer on Pt. The low-potential catalyst AST was conducted by using trapezoidal wave cycling from 0.6 V to 0.95 V with 0.5 s rise time and 2.5 s hold time, while the high-potential support AST was conducted using triangle wave cycling from 1.0 to 1.5 V (150 kPa_{abs} H₂/N₂, 80° C., 100% RH, 200/200 sccm H₂/N₂). Carbon corrosion rates were determined through measurement of CO₂ concentration in the cathode effluent gas by non-dispersive infrared spectroscopy.

Computational methods. The spin-polarized density functional theory (DFT) calculations were performed using plane wave basis and Projector Augmented Wave (PAW) formalism, as implemented in the Vienna Ab-initio Simulation Package (VASP). The generalized-gradient approximation (GGA) in the form of Perdew-Burke-Ernzerhof (PBE) functionals were employed to evaluate the exchange-correlation energy. The kinetic energy cutoff of 500 eV was used for plane wave expansion and the total energy was converged to 10⁻⁶ eV. The structures were optimized until the force acting on each atom was below 0.01 eV/A. The carbon support was modeled using a hexagonal 7×7 supercell of graphene layer containing 98 carbon atoms, with the in-plane lattice constant equal to the optimized value of 2.468 Å. The Brillouin zone was sampled using a Gamma centered k-point mesh of 2×2×1. A vacuum layer of 20 Å was added above the graphene layer to avoid the interaction between periodic images. One N atom was doped into the modeled graphene layer, giving a nominal doping concentration of about 1 at %. Single Pt atom and Pt₁₃ cluster were allowed to adsorb on the undoped and N-doped graphene (N—C) layer. The binding energy E_{b} is defined as

E_{b}(Pt/C)=E_{Pt/C}−E_{Pt}−E_{C}

where E_{Pt/C} is the total energy of the Pt/graphene system, E_{Pt} is the total energy of Pt atom or Pt cluster, and E_{C} is the total energy of the graphene layer. The metric adopted to evaluate the relative stability of Pt adsorption is the binding energy difference between the defective graphene E_{b}(Pt/N−C) and pristine graphene E_{b}(Pt/C), which was calculated as follows

$$\begin{matrix}Δ {E}_{b} = {E}_{b} ( Pt / N - C ) - {E}_{b} ( P t / C ) \\ = ( {E}_{Pt / N - C} - {E}_{N - C} ) - ( {E}_{Pt / C} - {E}_{C} )\end{matrix}$$

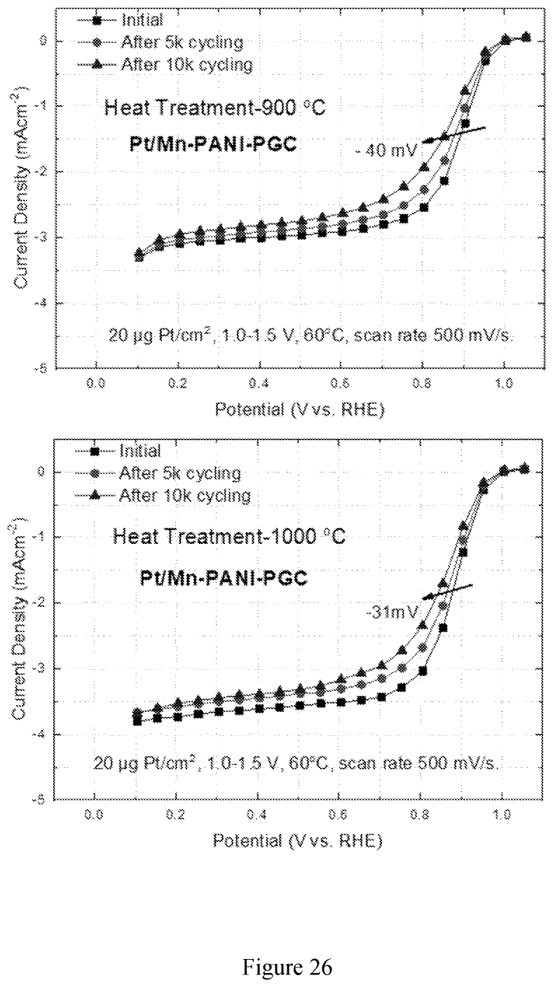

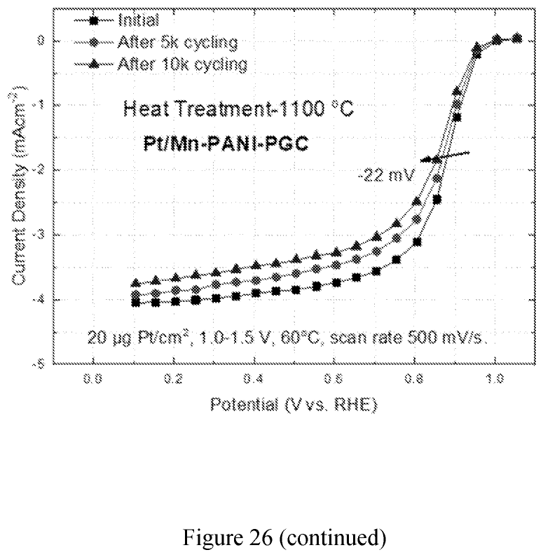

Additional physical characterization and electrochemical measurements are described in FIGS. 8-41.

### Example 2

This example provides a description of Pt/Co nanoparticles and catalyst materials of the present disclosure and methods of making same. Also, characterization and use of the nanoparticles and catalyst materials is described.

The reduction of platinum use and improvement of its corresponding catalytic performance have become of the most important steps to accelerate the development of proton-exchange membrane fuel cells (PEMFCs). In this example, a novel but facile method to boost the Pt-cased catalysts performance by integrating with iron based active sites FeNₓ. Synergistic catalysis between Pt(PtCo) nanoparticles over a platinum-group metal (PGM)-free catalytic substrate derived from iron doped zeolitic imidazolate framework-8 (ZIF-8) led to excellent oxygen reduction reaction performance under both rotating disk electrode (RDE) and fuel cell testing is described. Besides, easy phase transfer during synthesis between ordered intermetallic structures L1₀ PtCo and L1₂ Pt₃Co was achieved and comprehensive comparison between them regrading to catalytic performance was established.

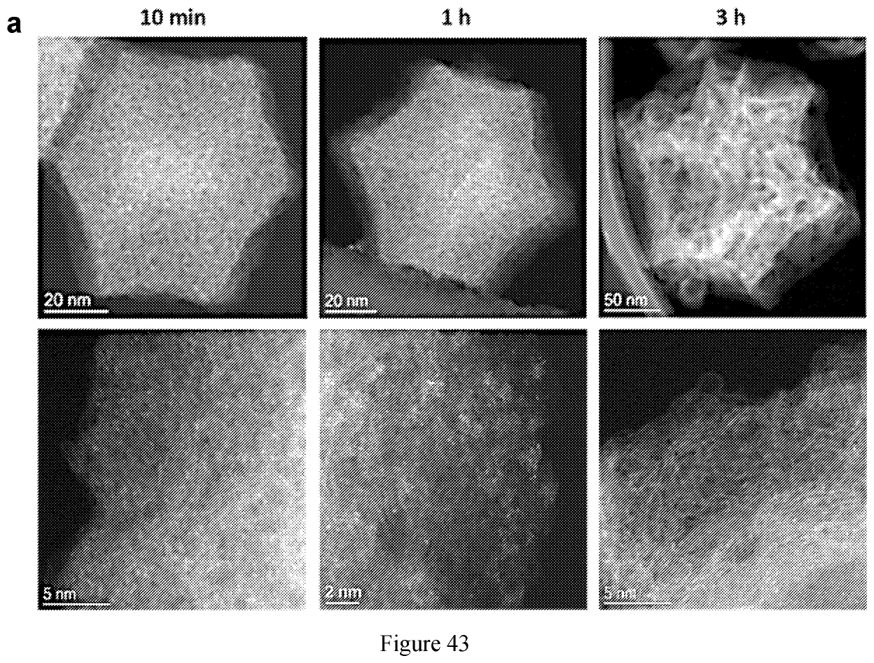

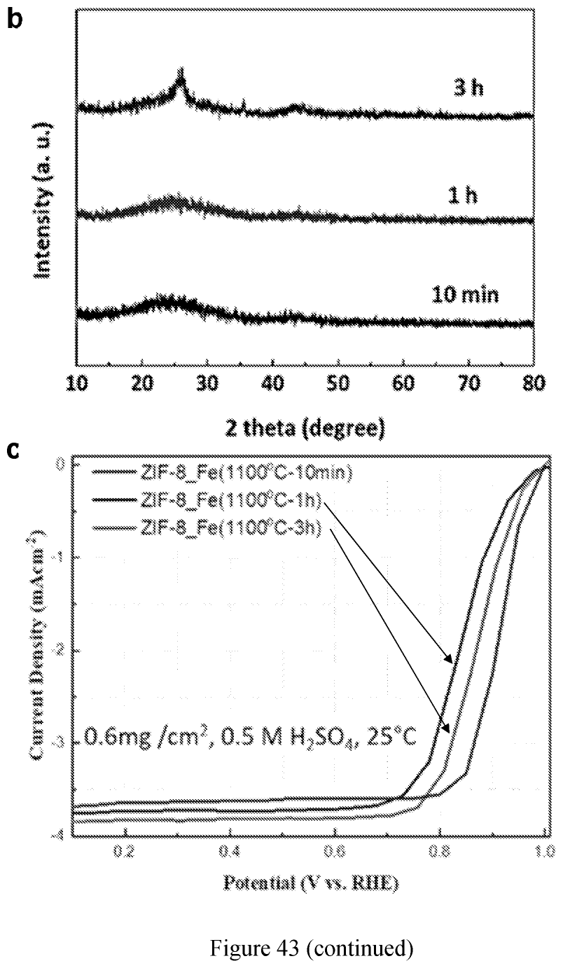

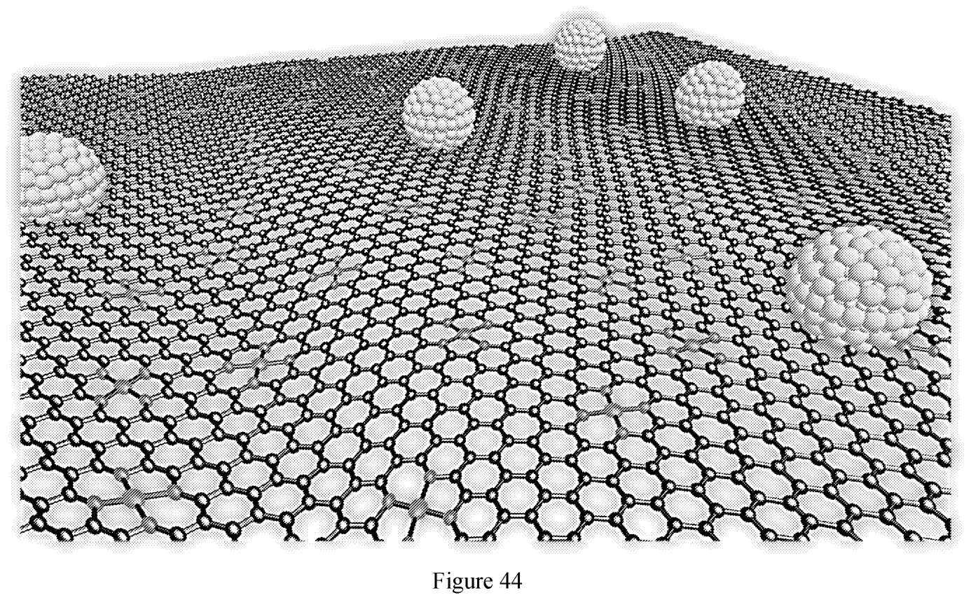

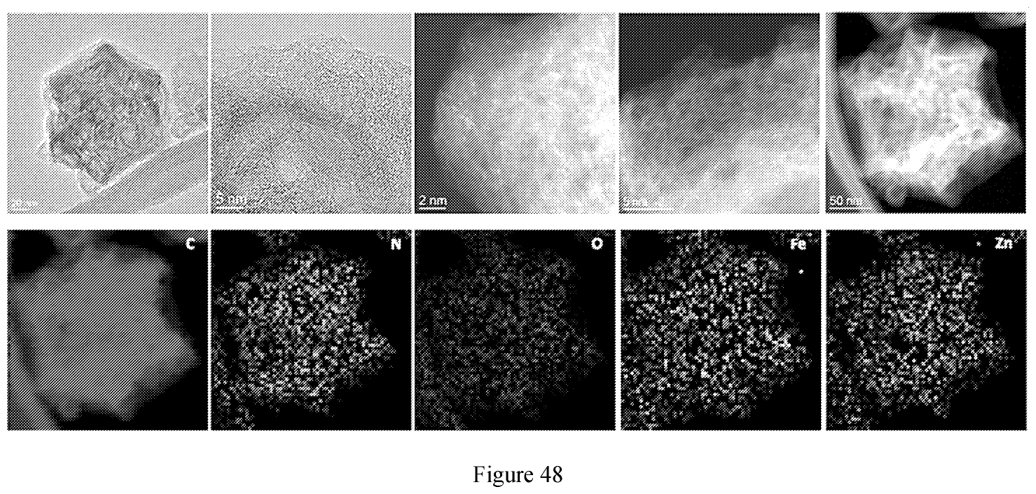

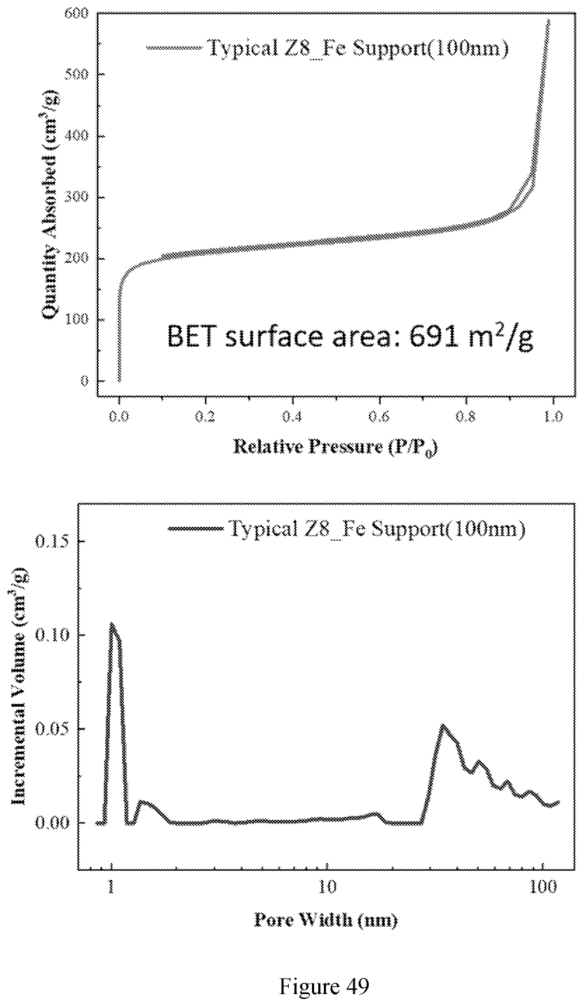

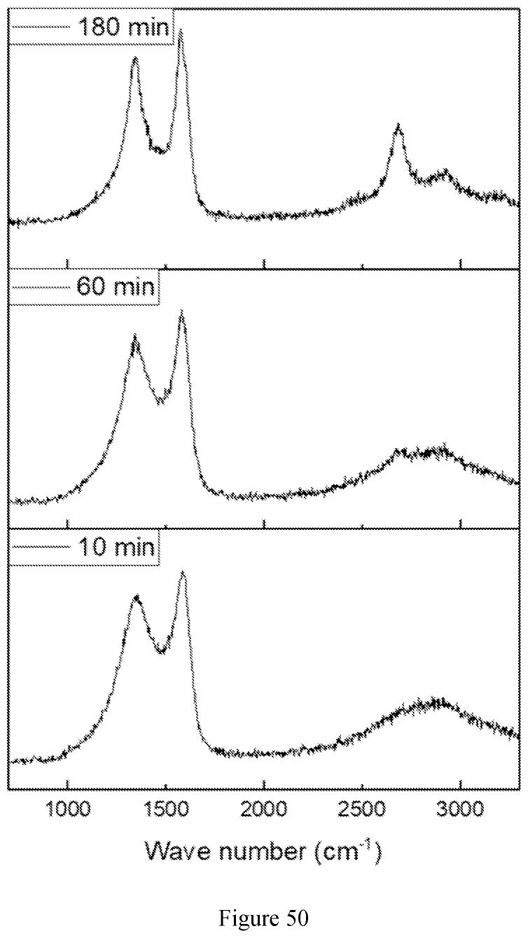

As for a typical Fe-doped ZIF-8-derived PGM-free catalyst (ZIF-8_Fe) (FIG. 43a), carbon accounts for more than 96 at % with less than 0.5 at % Fe. (FIG. 48). Considering its hierarchical porous structure, abundant surface area (FIG. 49), adjustable particle size and the most importantly, well dispersed active sites FeNₓ, ZIF-8_Fe possesses desirable properties as a carbon support for Pt/PtM NPs.

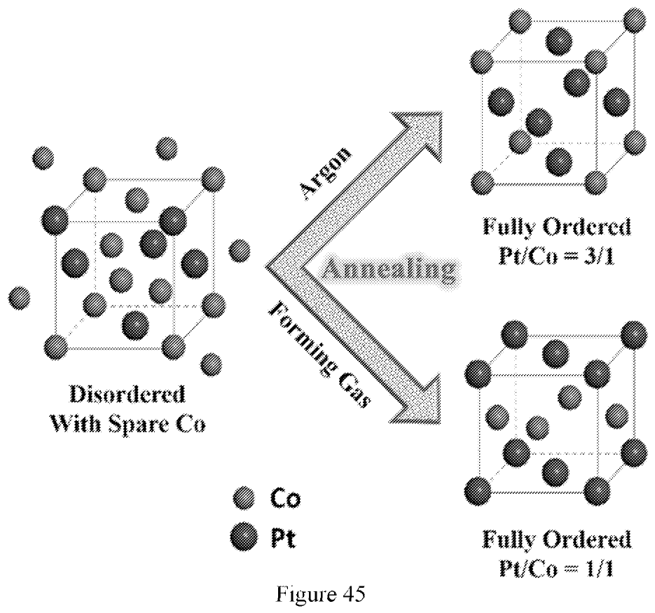

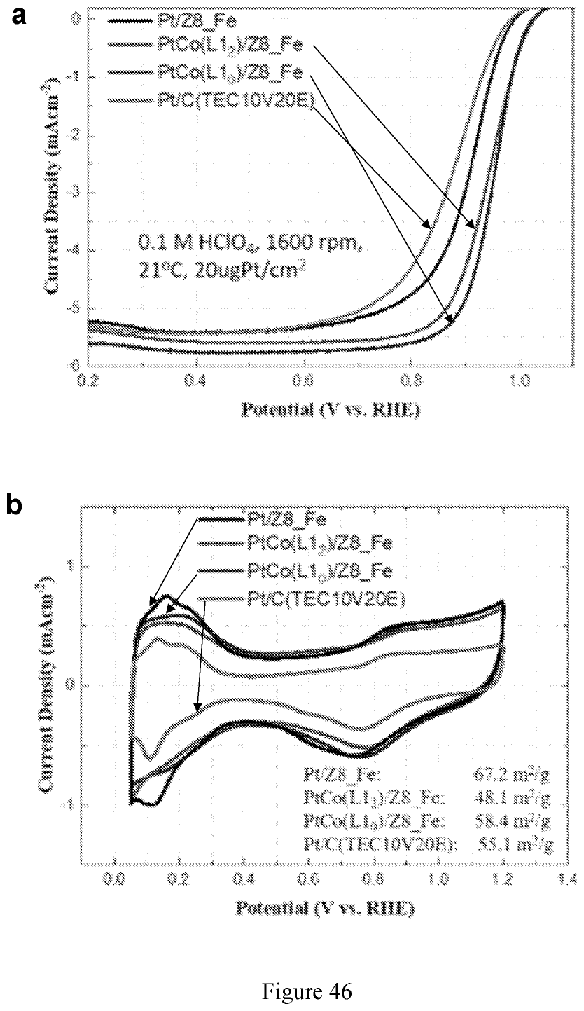

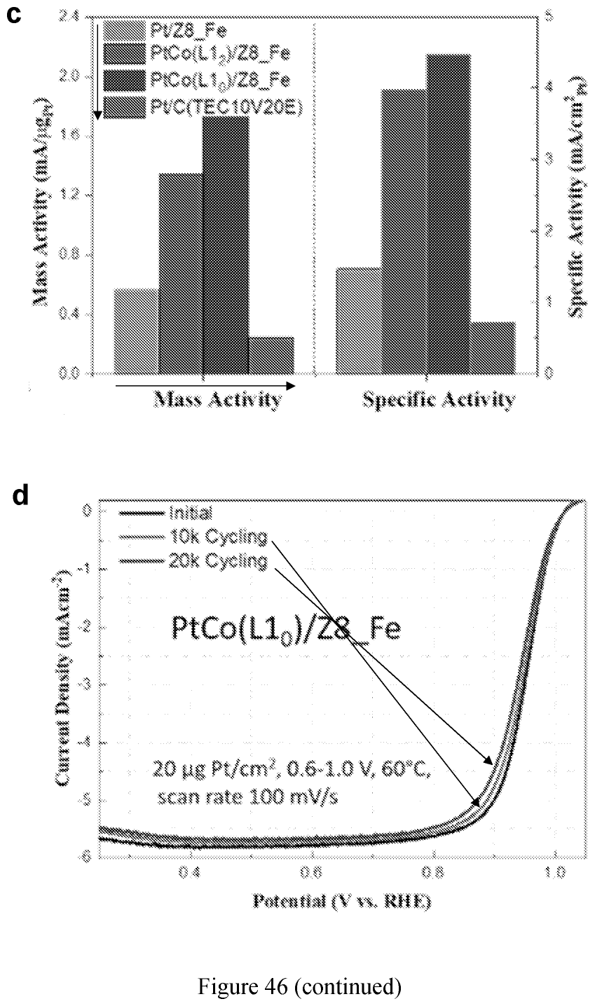

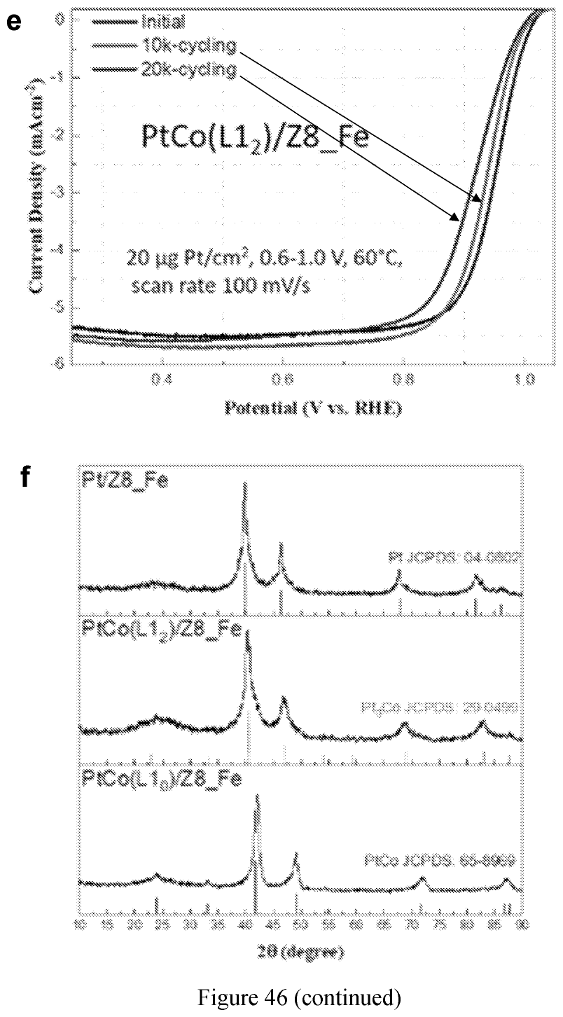

Design and synthesis of synergistic ORR catalysts, containing Pt or PtCo NPs deposited on highly active ZIF-8_Fe carbon support, denoted as Pt(PtCo)/Z8_Fe, is described. The pyrolysis process during the synthesis of ZIF-8_Fe was optimized, achieving higher degree of graphitization and promising ORR catalytic performance with half-wave potential (E_{1/2}) of 0.87 V vs RHE under RDE test. (FIGS. 43bc and 50) The uniform and dense dispersion of FeNₓ active sites could be identified clearly in FIG. 43a. In line with the purpose of preserving FeNₓ sites and simplifying synthesis during Pt deposition, an impregnation method equipped with freeze drying and followed by reduction under hydrogen was employed. In the cases of PtCo/Z8_Fe, a facile method to tune the intermetallic structure between cubic L1₂ (Pt₃Co) and tetragonal L1₀ (PtCo), with excessive feeding of Co precursors was developed (FIG. 45). Changes of gas atmosphere during high temperature treatment achieved facile transformation between different intermetallic structures confirmed by XRD spectra (FIG. 46f) During high temperature annealing (up to 600° C.), forming gas could enlarge the lattice spacing of Pt NPs, which bring more Co species to incorporate into Pt to form L1₀ (PtCo) rather than L1₂ (Pt₃Co) in the case of pure argon gas. Excessive Co could behave as obstacles to avoid agglomeration of NPs during synthesis and be removed by acid leaching. This new method enables a facile control of intermetallic structures of PtCo and an apple to apple comparison between L1₀ (PtCo) and L1₂ (Pt₃Co) catalysts, which may also be versatile for other intermetallic compounds. As a result, both Pt/Z8_Fe and PtCo/Z8_Fe exhibited high ORR catalytic performance, demonstrated under both RDE and MEA testing.

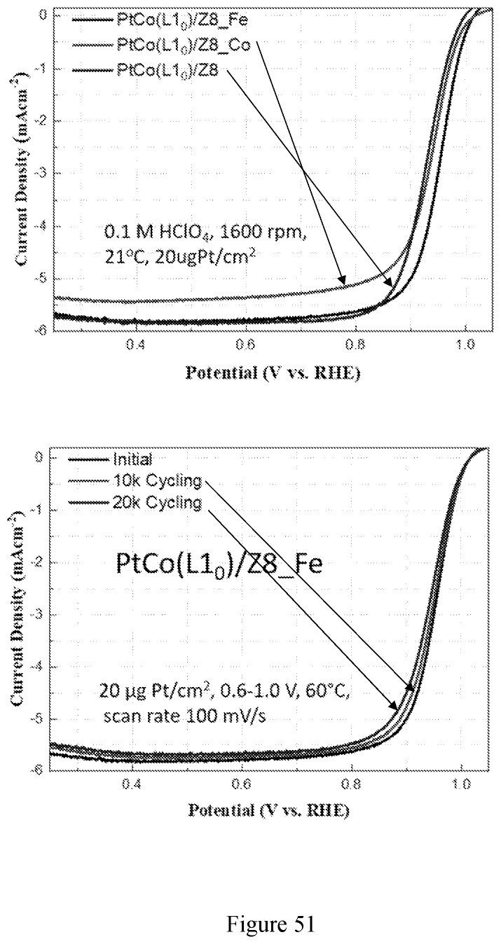

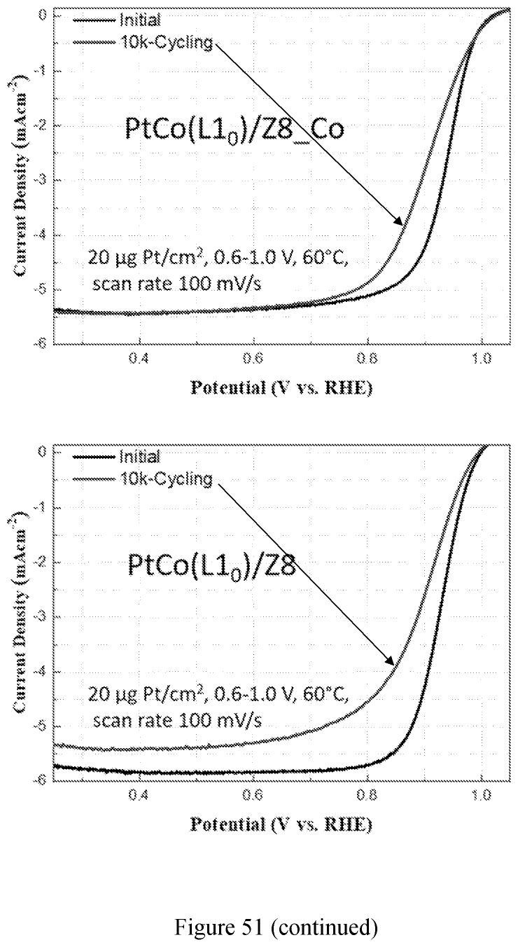

First, the ORR performance of the catalysts in the liquid half-cell were evaluated by the RDE method. As a result, Pt/Z8_Fe showed enhanced performance with E_{1/2} of 0.9 V vs RHE and mass activity (MA) of 0.57 A/mg_{PT} at 0.9 V vs RHE, exceeding commercial Pt/C catalysts, indicating the FeNₓ active sites existing in ZIF-8_Fe contribute the intrinsic activity enhancement of Pt/Z8_Fe through synergistic interaction. Both PtCo(L1₂)/Z8_Fe and PtCo(L1₀)/Z8_Fe showed superior activity with E_{1/2} of around 0.95 V vs RHE (FIG. 46a). FIG. 46c shows the specific activities (SA) of 3.98, and 4.48 mA/cm²_{Pt}, respectively, on PtCo(L1₂)/Z8_Fe and PtCo(L1₀)/Z8_Fe catalysts, and the MAs are 1.34, and 1.73 mA/μg_{Pt}, respectively. Both the SA and MA of ZIF-8_Fe supported Pt/PtCo catalysts outdistance those measured on commercial Pt/C. Considering the comparable activity of PtCo(L1₂)/Z8_Fe and PtCo(L1₀)/Z8_Fe, the stability of them during accelerated durability test (ADT) at 60° C. was further tested and compared (FIGS. 46d and e). Compared with the obvious degradation of PtCo(L1₂)/Z8_Fe, PtCo(L1₀)/Z8_Fe exhibited minimized loss of performance. This is a fair comparison for the first time of stability between PtCo L1₂ and L1₀ intermetallic structure, indicating more strongly coupled Co (3d) and Pt (5d) atomic orbitals in L1₀-PtCo, which benefits a lot to the stability of PtCo alloy catalysts. In order to study the performance enhancement facilitated by synergistic behavior of PtCo NPs and FeNₓ sites, L1₂ PtCo NPs were deposited on cobalt doped ZIF-8 (Z8_Co) and pure ZIF-8 (Z8) derived carbon supports by identical method, respectively. As shown in FIG. 51, PtCo(L1₀)/Z8_Fe outperformed other catalysts regarding to higher E_{1/2}. In addition, Z8_Fe supported catalysts showed dramatically increased stability during ADTs compared with both Z8_Co and Z8 supported ones, indicating FeNₓ could be holding a unique position among other PGM-free active sites, to facilitate ORR through synergistic interaction with Pt-based catalysts.

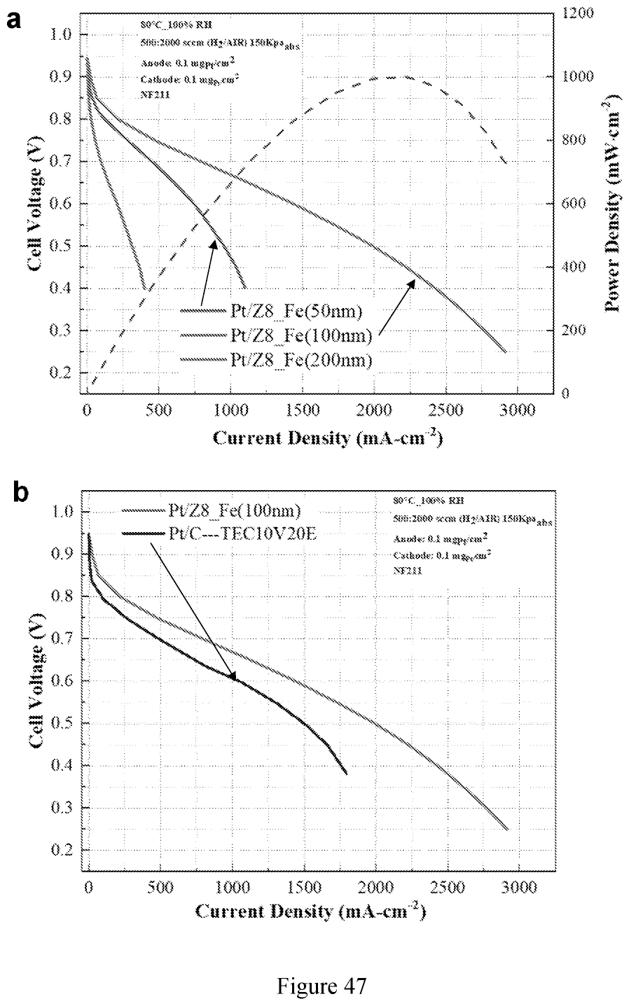

In order to evaluate the catalysts performance in operating fuel cell environments of different mass and charge transport limitations, the performance of Pt/Z8_Fe was tested in membrane electrode assembly (MEA) with H₂-Air. Without intending to be bound by any particular theory, it is considered particle size of M doped ZIF-8 could have impact on the catalyst performance, particularly under MEA tests. So, Pt was deposited onto different sizes ZIF-8_Fe, including 50 nm, 100 nm and 200 nm, and evaluated their performance under MEA tests. It clearly shows in FIG. 47a, that the 100 nm ZIF-8-Fe supported Pt catalysts significantly outperforms other ones, achieving a high max power density up to 1000 mW/cm², meeting the DOE target. The performance of Pt/Z8_Fe(100 nm) was compared with commercial Pt/C in FIG. 47b. The Pt/Z8_Fe(100 nm) demonstrated higher current density than the commercial Pt/C through the entire polarization scan, reaching a current density of 1500 mA/cm²_{Pt} at 0.6 V and 245 mA/cm²_{Pt} at 0.8 V, which is exceptional for pure Pt catalysts and exceed most of the Pt alloy catalysts reported so far. The performance enhancement on both high and low cell voltage could be owing to, not only the improved intrinsic activity facilitated by synergistic interaction between Pt and FeNₓ active sites, but also the optimized mass transport due to favorable porous carbon structure during the fuel cell operations.

In summary, a series of synergistic ORR catalysts were designed and synthesized by depositing Pt or PtCo particles on highly active PGM-free ZIF-8_Fe carbon support. Much higher performance of Pt/Z8_Fe catalysts was demonstrated compared with commercial Pt/C under both RDE and MEA tests, indicating the advantages of ZIF-8_Fe support material. In the cases of PtCo catalysts, a method was developed to enables a facile control of intermetallic structures of PtCo and an apple to apple comparison between L1₀ (PtCo) and L1₂ (Pt₃Co) catalysts. With similar initial performance, PtCo(L1₀)/Z8_Fe exhibited higher stability than PtCo(L1₂)/Z8_Fe under ADT tests by RDE.

Experimental Details

Catalysts Synthesis. Synthesis of ZIF-8_Fe derived carbon support. Synthesis of active ZIF-8_Fe carbon material is based on a known synthesis. Typical synthesis procedure of 100 nm ZIF-8_Fe carbon material is described below with a few modifications. Zinc nitrate hexahydrate (3.39 g) and iron nitrate nonahydrate (100 mg) were dissolved in 300 mL methanol in a round-bottom flask as solution 1; 2-Methylimidazole (3.94 g) was dissolved in another 300 mL methanol as solution 2. Then, two solutions were mixed gradually into the bottom-flask and it was sealed with a rubber stopper along with a cable tie. The mixture was then put into an oven and heated from 25° C. to 60° C. in 20 mins. The oven was kept on constant temperature at 60° C. for 24 h. After cooling, the resulting suspension was separated by centrifuging at 9000 rpm (10-15 mins each time) to collect all precipitant and washing with ethanol three times. All precipitant was collected and dried at 60° C. in a vacuum oven for 12 h. The dried light-yellow powder was then finely ground and heated at 1100° C. in a tube furnace under N₂ flow for 3 h. After heat treatment, the furnace was cooled down to 25° C. The obtained black powder was finally ground to be the as-synthesized ZIF-8_Fe carbon support.

Synthesis of Pt (PtCo)/Z8_Fe catalysts. PtCo nanoparticle deposition onto the ZIF-8_Fe carbon support was performed through a forming gas (hydrogen (10%)+argon) reduction method with a controlled Pt mass loading of 20 wt %. The carbon support powder was dispersed in Milli-Q water by ultrasonic treatment for 1 hour to form a homogeneous complex suspension. Then, a given amount of hexachloroplatinic acid solution and hexahydrate cobalt (II) chloride (both 10 mg/mL) were added into the previous suspension solution under stirring for 20 minutes with N₂ bubbling. The new suspension solution was further homogenized by ultrasonic treatment for 1 hour and quick-freeze by using liquid nitrogen, followed by freeze drying for overnight. The dried powder was then heated at 200° C. in a tube furnace under forming gas flow for 6 h (h=hour(s)). After cooling down to 25° C., the furnace was reheated to 650° C. for another 6 hours, under argon or forming gas for ordering L1₂ Pt₃Co or L1₀ PtCo intermetallic structures, respectively. The resulting powder was leached by 0.1M HClO₄ at 60° C. for 6 hours and post treated at 400° C. under argon to obtain the final catalyst.

Electrochemical measurements. All electrochemical measurements were performed on a CHI Electrochemical Station (Model 760b) equipped with high-speed rotators from Pine Instruments. A rotating ring disk electrode (RRDE) from Pine Research Instrumentation (model: AFE7R9GCPT, USA) was used as the working electrode, containing glassy carbon disk and platinum ring: disk OD=5.61 mm; ring OD=7.92 mm; ID=6.25 mm. An Hg/HgSO₄ reference electrode and a graphite rod counter electrode with a diameter of 0.250 inches and a length of 12 inches were used to complete the cell. To prepare the working electrode, 10 mg catalyst was dispersed ultrasonically in a 1.0 mL mixture of isopropanol and Nafion (5 wt. %) solution to form an ink. Then the ink was drop-casted on the disk electrode with a designed loading of 20 μg_{Pt}/cm² and dried at room temperature to yield a thin-film electrode. All the cyclic voltammetry (CV) and ORR polarization curves were recorded in 0.1 M HClO₄ and the ORR activity was measured in 0.1 M HClO₄ saturated with O₂ at 1600 rpm using linear sweep voltammetry (LSV) polarization plots at a scan rate of 10 mV·s⁻¹. The accelerated stress tests (ASTs) were applied to evaluate catalyst stability by cycling the potentials ranging from 0.6 to 1.0 V, (scan rate: 50 mV/s) at 60° C. in 0.1 M HClO₄ saturated with N₂ by using RDE. All reference potentials have been converted to reversible hydrogen electrode (RHE).

Fuel Cell Fabrication and Testing. Catalysts were incorporated into MEAs by spraying of a water/n-propanol based ink onto a 5 cm² area of a Nafion 211 membrane. Each electrode was prepared with Pt loading of 0.1 mg_{Pt}/cm², and 29BC gas diffusion layers (SGL Carbon) were used on both anode and cathode. H₂-air fuel cell testing was carried out in a single cell using a commercial fuel cell test system (Fuel Cell Technologies Inc.). The MEA was sandwiched between two graphite plates with straight parallel flow channels machined in them. The cell was operated at 80° C., with 150 kPa_{abs} H₂/air or H₂/O₂, and a gas flow rate of 500/2000 sccm for anode/cathode, respectively. Catalyst mass activity was measured via the DOE/FCTT protocol (potential step from 0.6 V to 0.9 V and 15 min (minute(s)) hold, current averaged during last 1 min) in 150 kPa_{abs} H₂/O₂ (80° C., 100% RH, 500/2000 sccm) with correction for measured H₂ crossover. The ECSA was obtained by calculating H adsorption charge in CV curves between 0.1-0.4 V (0.45-0.55 V background subtracted) at 30-35° C. with 500 sccm H₂ on the anode and stagnant N₂ on the cathode, assuming a value 210 μC/cm² for the adsorption of a H monolayer on Pt.

### Example 3

This example provides a description of Pt/Co nanoparticles and catalyst materials of the present disclosure and methods of making same. Also, characterization and use of the nanoparticles and catalyst materials is described.

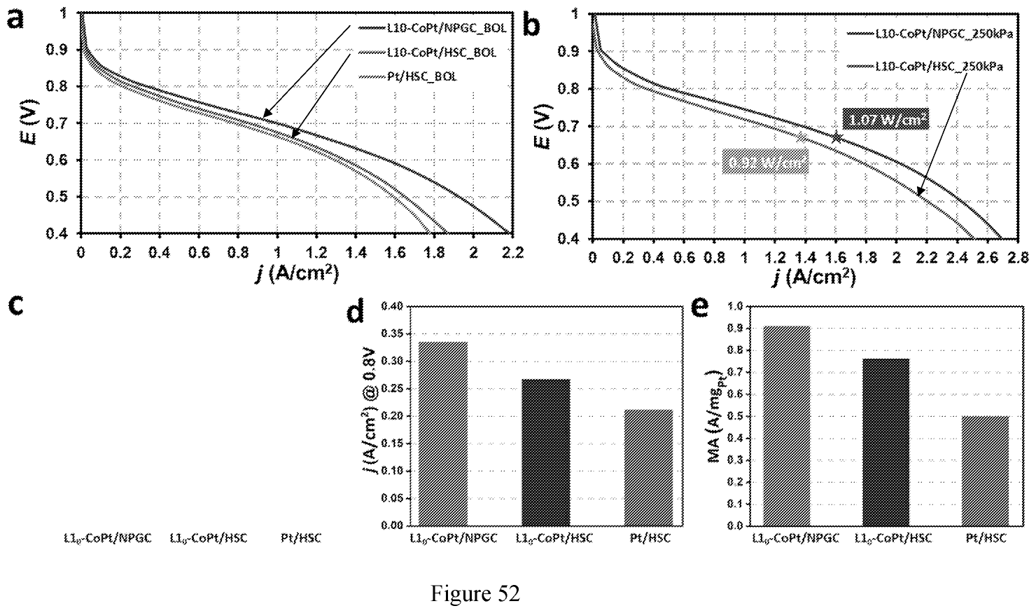

The fuel cell performance for L1₀-CoPt/NPGC, L1₀-CoPt/HSC, and Pt/HSC catalysts was studied. At the beginning-of-life (BOL) cycle, the L1₀-CoPt/NPGC exhibited higher current densities in the entire range from 0.4-1.0 V under Hz-Air condition (FIG. 52a). In particular, L1₀-CoPt/NPGC catalyst delivered high current densities of 1.56 A/cm² at 0.6 V and 1.18 A/cm⁻¹ at the heat rejection limit of 0.67 V, which translates to high power densities of 0.79 W/cm² at 0.67 V (rated power density), 0.94 W/cm² at 0.6 V. Compared with the HSC support, the NPGC possesses relatively lower porosity, which reduces the voltage loss at mass transport region (high-current region). Moreover, the Coulombic interaction between ionomer and nitrogen heteroatoms could enable a uniform coverage of ionomer on the surface of NPGC, which minimizes the transport loss caused by inhomogeneous ionomer patches in the catalyst layer. These support features rendered L1₀-CoPt/NPGC catalyst better high-current performance, despite L1₀-CoPt/NPGC and L1₀-CoPt/HSC showed similar ECSAs (FIG. 52c). In the kinetic (high-voltage) region, the L1₀-CoPt/NPGC catalyst displayed a current density of 0.335 A/cm² at 0.8V, surpassing the DOE target of 0.3 A/cm² and the performance of L1₀-CoPt/HSC and Pt/HSC catalysts (FIG. 52d). The great performance in the high-voltage region for the L1₀-CoPt/NPGC catalyst is also reflected by its outstanding intrinsic mass activity. The intrinsic catalytic activity measurements were carried out by holding the cell at 0.9 V (vs. RHE) with O₂ as the cathodic gas feed. The L1₀-CoPt/NPGC catalyst showed higher BOL mass activity (MA) relative to that of L1₀-CoPt/HSC and Pt/HSC catalysts (FIG. 52e). The MA (iR corrected) for L1₀-CoPt/NPGC is as high as 0.91 A/mg_{PT}, which exceeds the DOE 2020 target (0.44 A/mg_{PT} at 0.9 V) by a large margin and represents an unprecedentedly high ORR activity measured in a single-cell configuration. The desirable ORR kinetics of the L1₀-CoPt/NPGC catalyst could stem from the highly strained Pt surface and desirable ionomer morphology. It was studied that the L1₀ ordering in the core structure could impose compressive biaxial strains on the Pt shell, which optimizes oxygenated species-binding energies and enhances the activity. In parallel, the Coulombic interaction between the ionomer and N atoms on the carbon support promotes the homogeneous coverage of ionomer in the catalyst layer, which mitigates the ionomer poisoning issue. When tested at 250 kPa_{abs}, the L1₀-CoPt/NPGC catalyst showed a rated power density of 1.07 W/cm², higher than that for L1₀-CoPt/HSC catalyst (0.92 W/cm²) and the DOE target of 1 W/cm² (FIG. 52b). The great performance at the high-current region demonstrates the potentials of the L1₀-CoPt/NPGC catalyst for the practical application in the cell stack of fuel cell vehicles.

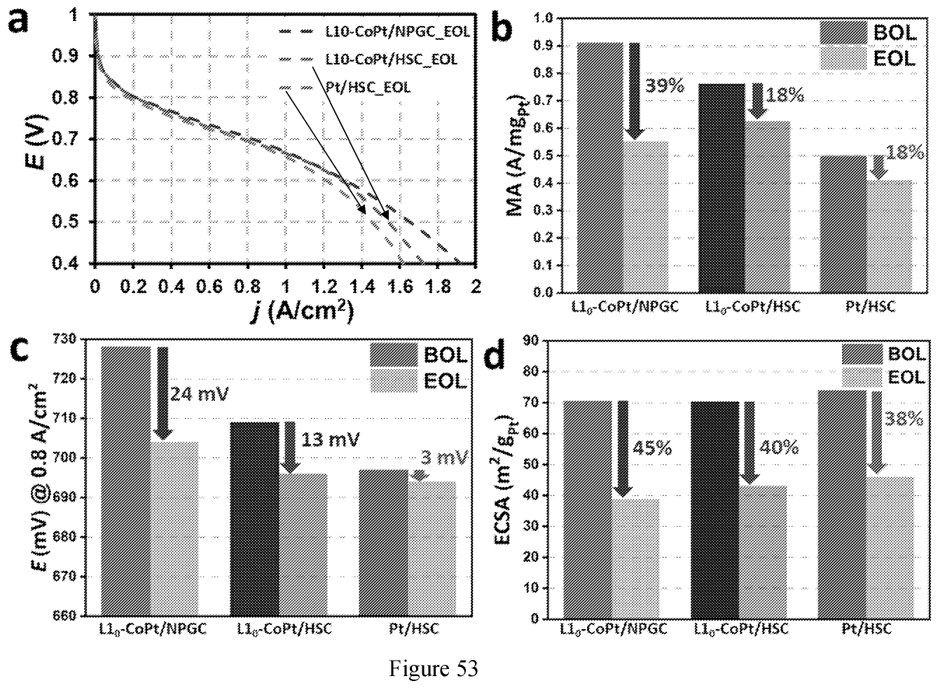

Moreover, L1₀-CoPt/NPGC performed desirable stability in MEA testing. Accelerated stress test (AST) was carried by repeatedly sweeping from 0.6 to 1.0 V based on DOE catalyst stability evaluation protocols. The end-of-life (EOL) polarization curves are shown in FIG. 53a. Loss of MA, voltages at 0.8 A/cm², and ECSA, which are critical evaluation metrics for the catalyst stability, were measured after 30,000 voltage cycles, as shown in FIGS. 53b, 53c, and 53d. No substantial activity losses were observed for the L1₀-CoPt/NPGC catalyst, and the specific values for the loss of MA (FIG. 53b) and the voltage loss at 0.8 A/cm² (FIG. 53c) both meet the DOE 2020 targets (MA loss≤40%, voltage loss at 0.8 A/cm^{2≤30} mV). The L1₀-CoPt/HSC and Pt/HSC counterparts exhibited fewer performance losses because the highly porous carbon structure effectively inhibits particle migration/coalescence and mitigates the loss of ECSA (FIG. 53d). Comparatively, the NPGC support is of relatively lower porosity, and thus affords less protection of particles. However, considering the relatively low BOL performances of L1₀-CoPt/HSC and Pt/HSC catalysts, the L1₀-CoPt/HSC catalyst is more advantageous in real fuel cell application. Noteworthy, the end-of-life (EOL) MA for L1₀-CoPt/NPGC (0.55 A/mg_{PT}) is even higher than the DOE 2020 target for BOL. In short, the L1₀-CoPt/NPGC catalyst traded off some stability for BOL performance, which improved the overall property. Microscopic characterizations collected from the EOL sample indicate the L1₀-CoPt/NPGC catalyst preserved the core-shell and intermetallic structure after voltage cycling, though the average particle size increased to 4.0±1.5 nm.

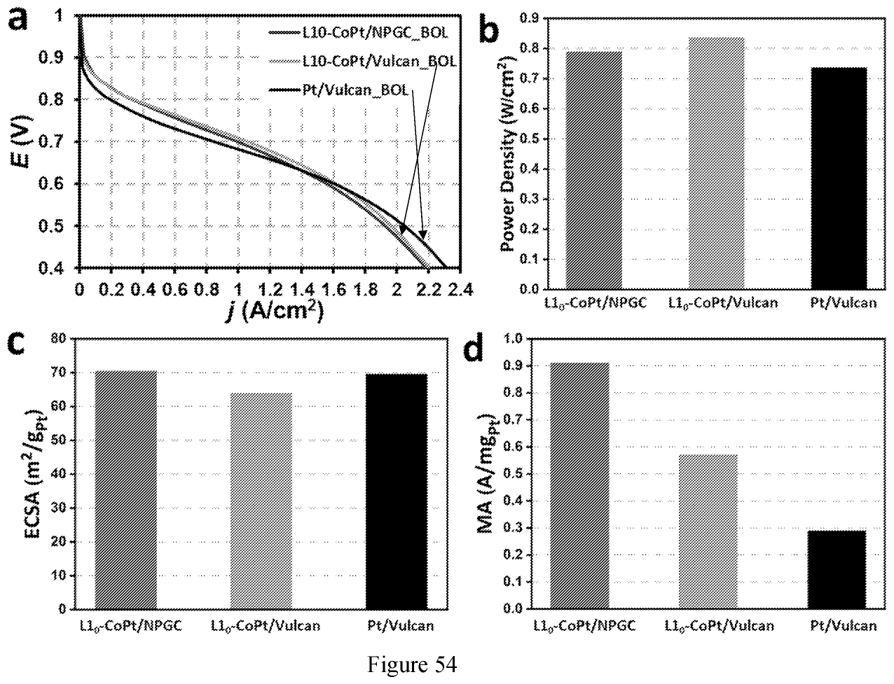

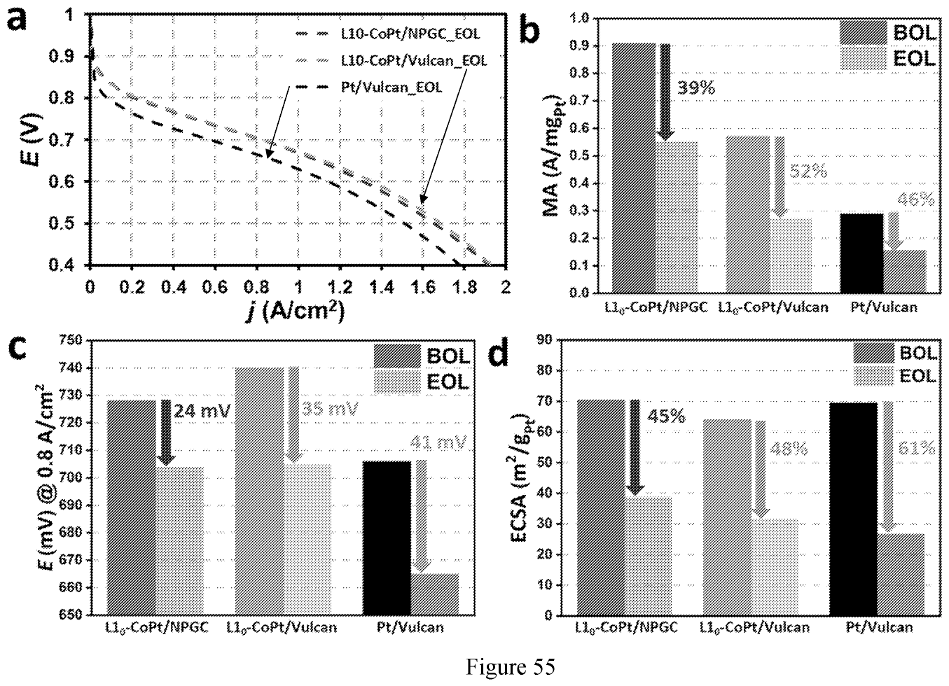

The fuel cell performances for the L1₀-CoPt/NPGC, L1₀-CoPt/Vulcan, and Pt/Vulcan catalysts were compared (FIG. 54). FIG. 54a shows their current-voltage (i-V) polarization curves measured under 150 kPa of fully humidified air. At the BOL stage, the L1₀-CoPt/NPGC catalyst displayed lower current densities in the mass-transport region comparing with the L1₀-CoPt/Vulcan and Pt/Vulcan, which can be ascribed to the porous structure resulting in relatively high mass-transport resistance. The BOL power densities for these catalysts are in the order of L1₀-CoPt/Vulcan>L1₀-CoPt/NPGC>Pt/Vulcan (FIG. 54b). The great power density of the L1₀-CoPt/Vulcan catalyst is associated with the ordered L1₀ structure improving the ORR activity and solid carbon support allowing more accessibility to the air feed. It should be noted the gap of power density between L1₀-CoPt/NPGC and L1₀-CoPt/Vulcan is not remarkable, suggesting the voltage penalty caused by porous structure is not significant. The voltage loss due to limited mass transport in the NPGC support could be compensated by the desirable local transport because of the high ECSA (>70 m²/mg_{PT}), as shown in FIG. 54c. By contrast, the L1₀-CoPt/Vulcan showed a relatively low ECSA as particles on solid carbons usually undergo a higher degree of sintering and agglomeration during thermal annealing. A catalyst with higher ECSA requires less O₂ flux to the Pt surface and exhibits better local transport. Pt/Vulcan catalyst possessed the highest ECSA and best high-current performance among the three catalysts. However, the intrinsic activity of Pt/Vulcan is much lower than the other two counterparts, resulting in an undesirable rated power density. The L1₀-CoPt/NPGC performed remarkably higher mass activity relative to that of the L1₀-CoPt/Vulcan counterpart (FIG. 54d). The superior intrinsic activity can be correlated to the porous structure of the NPGC support, which prevents a complete coverage of ionomer on the particles and surface poisoning. The porous property also rendered the L1₀-CoPt/NPGC catalyst improved stability compared with the L1₀-CoPt/Vulcan and Pt/Vulcan catalysts. FIG. 55a includes the polarization curves after catalyst AST. The L1₀-CoPt/NPGC catalyst exhibited the smallest loss of MA, as shown in FIG. 55b. The voltage losses at 0.8 A/cm² for the L1₀-CoPt/NPGC, L1₀-CoPt/Vulcan, and Pt/Vulcan are 24 mV, 35 mV, and 41 mV, respectively (FIG. 55c). The relatively small voltage loss of the L1₀-CoPt/NPGC catalyst could be a consequence of porous structure inhibiting the motion of particles and suppressing the loss of ECSA (FIG. 55d). In sum, the NPGC support of intermediate porosity was demonstrated to afford the L1₀-CoPt catalyst with balanced mass activity, power density, and stability.

### Example 4

This example provides a description of Pt/Co nanoparticles and catalyst materials of the present disclosure and methods of making same. Also, characterization and use of the nanoparticles and catalyst materials is described.

Provided is a concept to design hybrid ORR catalysts by integrating PGM NPs, and FeN₄ site-rich Fe—N—C carbon denoted as Pt/FeN₄—C or PtCo/FeN₄—C. As a comparison, the Fe-free nitrogen-doped carbon (NC) derived from carbonized ZIF-8, and the CoN₄—C from cobalt-doped ZIF-8 were also studied to justify the effectiveness of FeN₄ in carbon to enhance Pt and PtCo catalyst performance dramatically. Furthermore, during the synthesis of PtCo/FeN₄—C catalysts, an effective approach to preparing L1₂ Pt₃Co intermetallic structures: through controlled high-temperature annealing treatments was developed. The favorable porous carbon structure of FeN₄—C and its abundant nitrogen doping enables a uniform Pt and Pt₃Co NP distribution presenting average particle sizes of 3 to 4 nm. Unlike large particle sizes of ordered PtCo intermetallic reported before, the use of the FeN₄ site-rich Fe—N—C carbon can significantly reduce the particle size while achieving an ordered structure. The newly developed Pt/FeN₄—C and Pt—Co/FeN₄—C catalysts show excellent performance and durability in rotating disk electrode (RDE) and membrane electrode assembly (MEA) studies. Compared to traditional carbon black-supported Pt (Pt/C), the Pt/FeN₄—C achieved significantly improved ORR mass activity (MA) of 0.451 A/mg_{PT} and retained 80% of the initial value after 30,000 accelerated stress test (AST) voltage cycles in an MEA with low cathode loading of 0.1 mg_{PT}/cm², exceeding the DOE 2020 targets even without using an alloy. Furthermore, the Pt₃Co/FeN₄—C achieved much higher ORR mass activities of 0.72 A/mg_{PT}. The Pt₃Co/FeN₄ catalyst reached a power density of 824 mW/cm² at 0.67 V and only lost 23 mV at 1.0 A/cm² after 30,000 voltage cycles in an MEA. The DFT calculation further predicted the possible synergistic mechanism of Pt sites and FeN₄ sites to enhance the intrinsic activity of Pt concerning O₂ adsorption energy and activation energy to break O—O bonds during the ORR. The promotional role of the FeN₄ site in boosting the activity and stability of Pt catalysts demonstrated an effective strategy to reduce Pt loading for high-performance low-PGM electrodes in PEMFCs.

Results and Discussion

Catalysts Synthesis and Structures

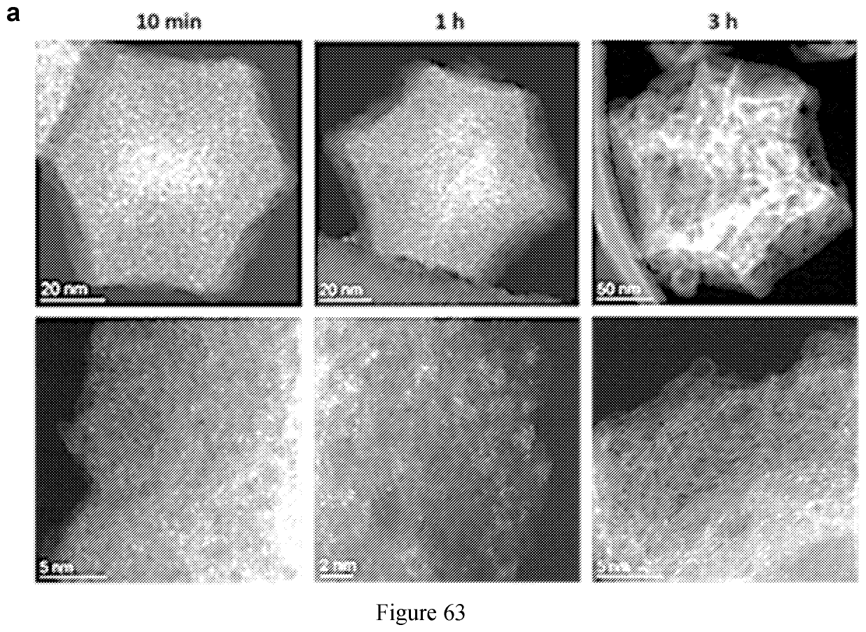

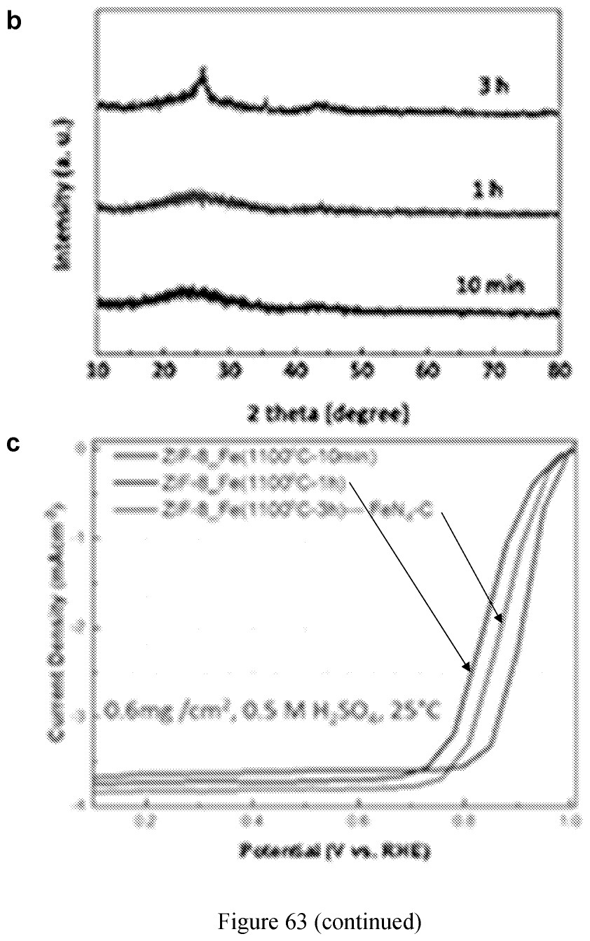

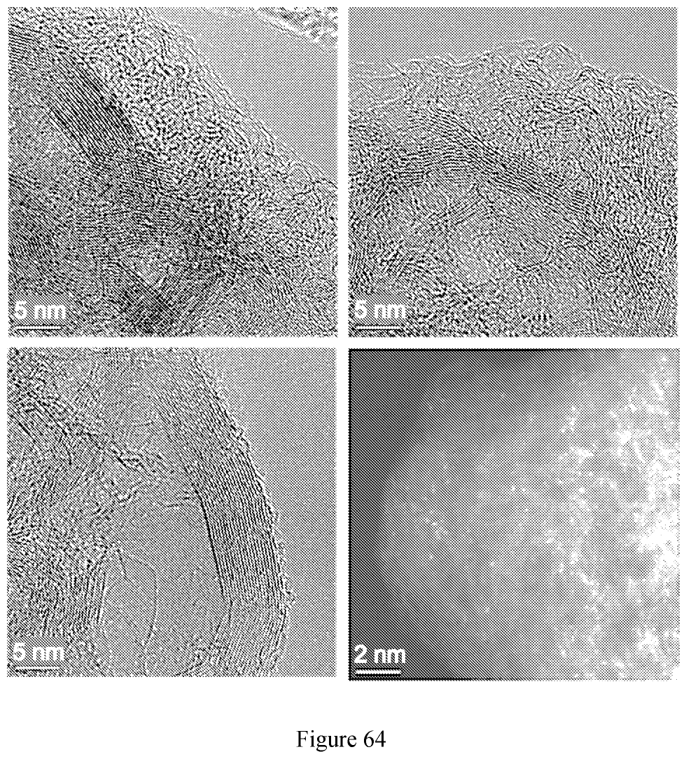

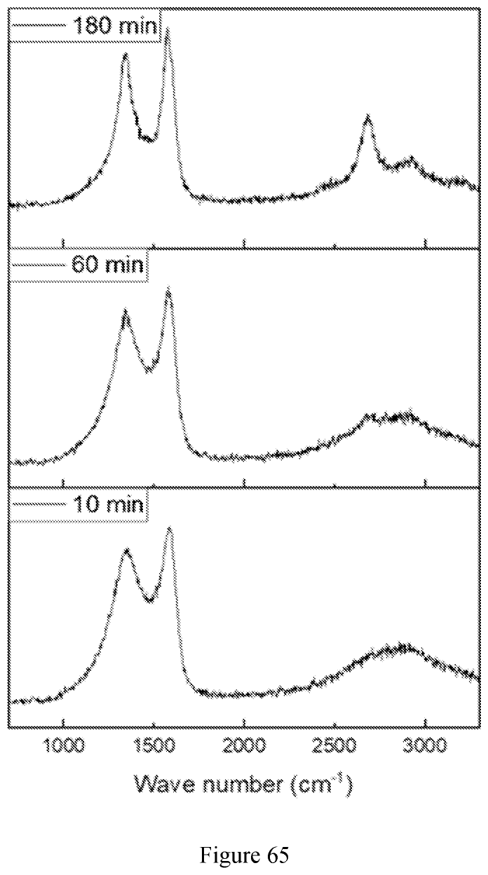

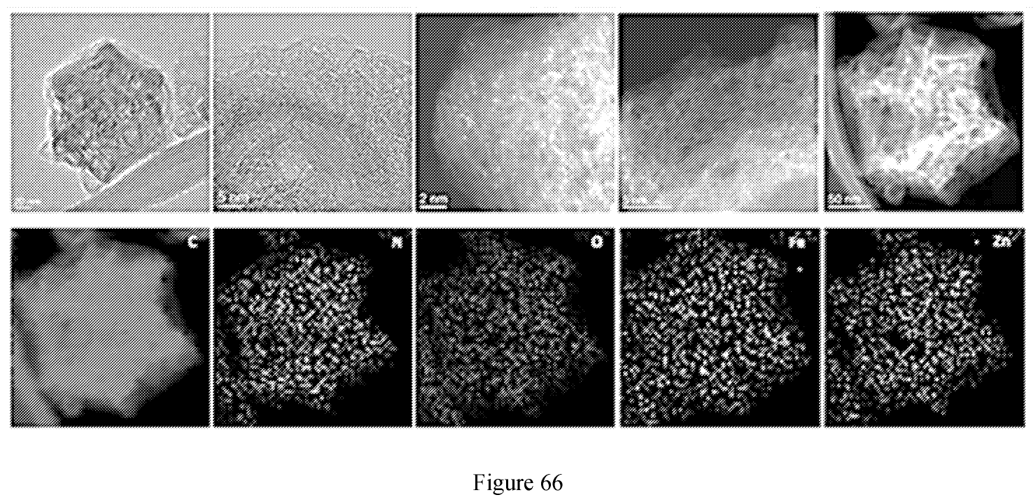

Fe—N—C catalysts containing highly active FeN₄ sites through multiple effective methods are described. A chemical doping of Fe³⁺ ions into ZIF-8 nanocrystals and partially replaced Zn to form Fe—N₄ coordination followed by subsequent pyrolysis in an Ar atmosphere to convert the Fe-doped ZIF-8 to FeN₄ active sites uniformly dispersed into partially graphitized carbon was used. The carbon phase, derived from the hydrocarbon in ZIF-8, is partially graphitized and has a surface area up to 700 m²/g, containing atomically dispersed FeN₄ sites with a significant micropore volume connected to hierarchical porous structures. More importantly, the carbon particle size can be easily tuned during the synthesis, ranging from 20 to 1000 nm, which provides an excellent opportunity to design electrode structures in MEAs. Therefore, the FeN₄—C was applied as support to synthesize Pt and PtCo catalysts. The degree of the graphitization of carbon support is critical to Pt catalyst stability. Thus, unlike traditional Fe—N—C catalysts with significant amorphous carbon, the pyrolysis duration was prolonged from one to three hours at 1100° C. to graphitize the FeN₄—C, aiming to increase catalyst stability. The graphitized layer structure of the FeN₄—C is apparent in the STEM images (FIGS. 63a and 64). The highly graphitized carbon structures in the FeN₄—C was verified from a sharp (002) peak in XRD patterns and well-separated D (˜1339 cm⁻¹) and G (˜1589 cm⁻¹) peaks along with the appearance of a 2D (˜2700 cm⁻¹) peak in Raman spectra (FIGS. 63b and 65). The high ORR activity of FeN₄—C is confirmed with an E_{1/2} of 0.87 V vs. RHE in RDE testing (0.6 mg/cm² loading, 900 rpm, and 25° C. in 0.5 M H₂SO₄). The abundant and uniform distribution of nitrogen dopants and single Fe sites throughout the FeN₄—C shown in mapping images (FIG. 66) demonstrated that the nitrogen species could be preserved during the prolonged pyrolysis, directly corresponding to its high ORR activity.

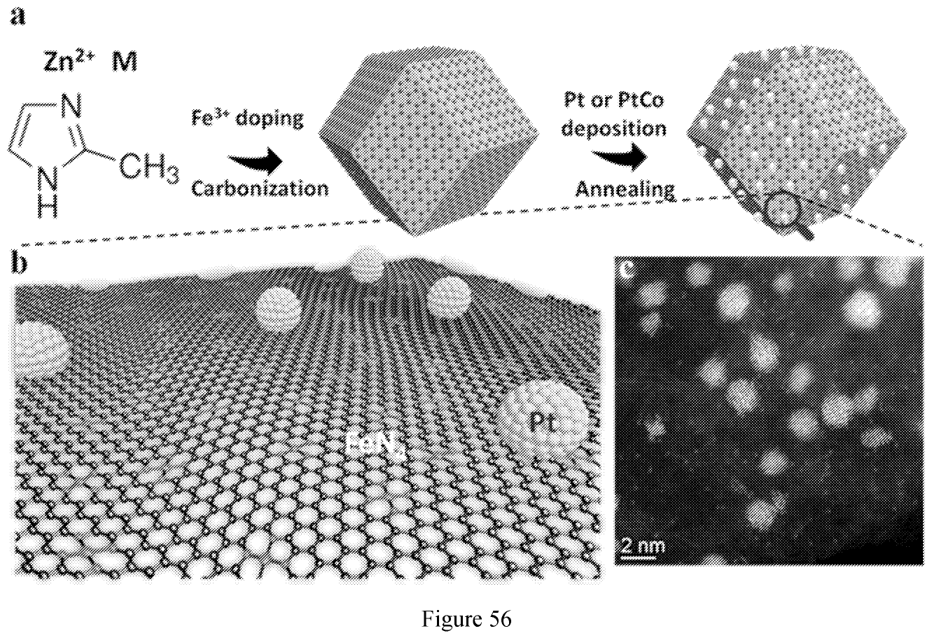

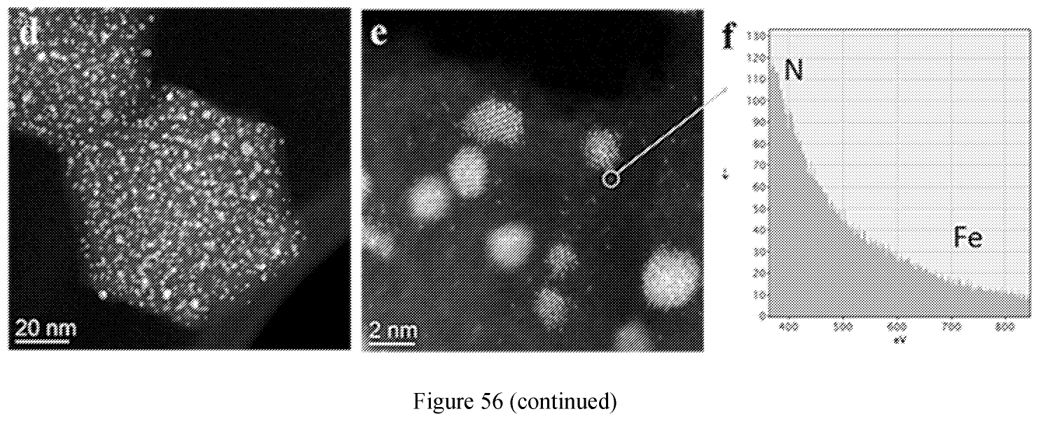

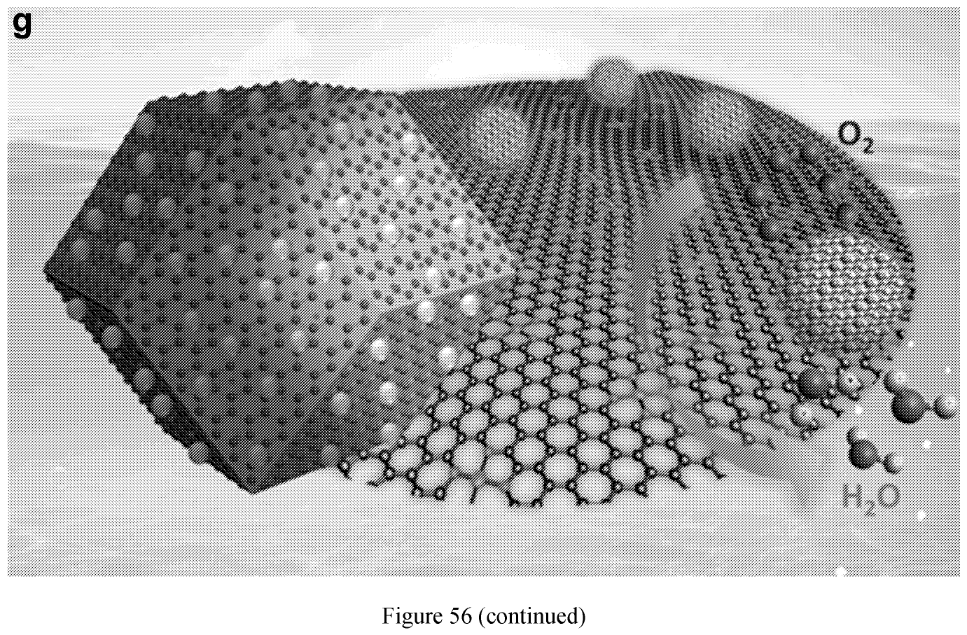

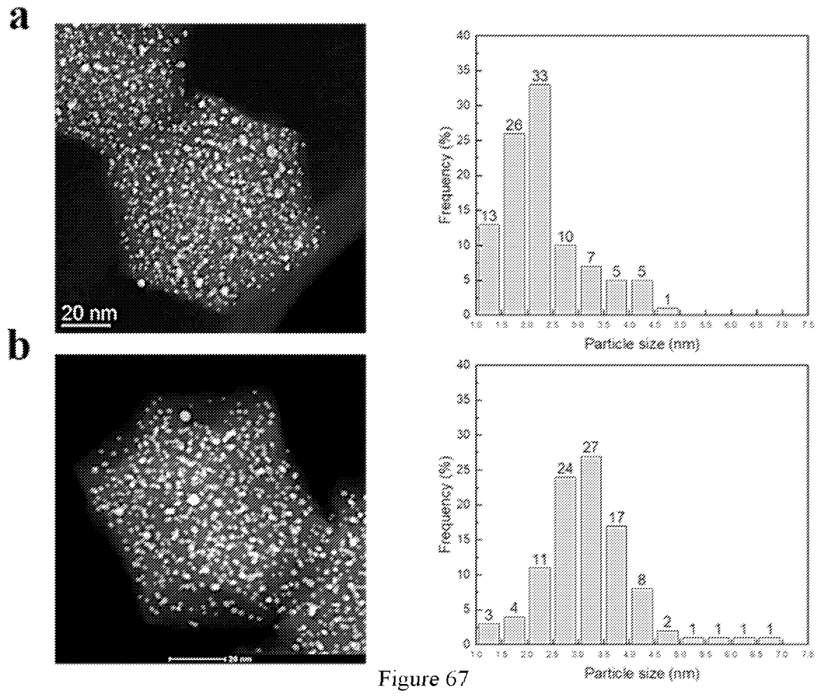

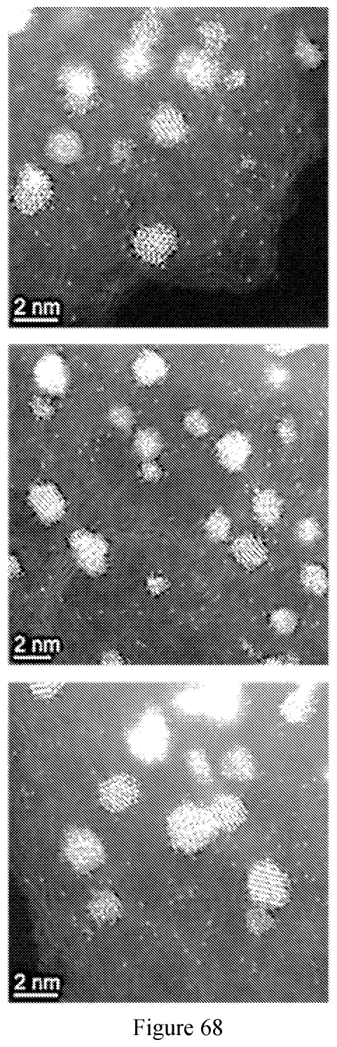

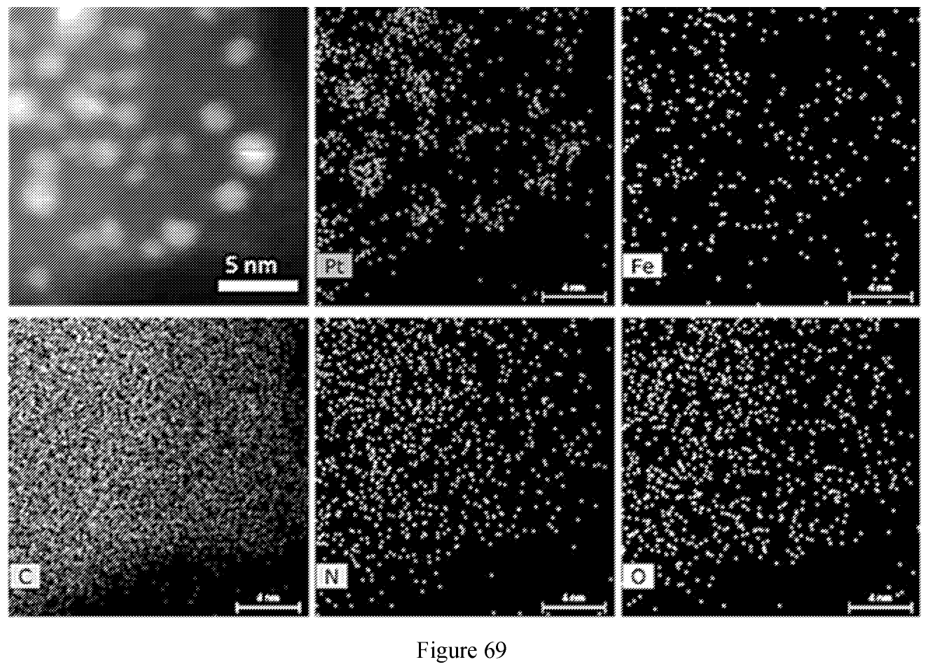

During the subsequent Pt deposition, an impregnation method was applied with freeze-drying to disperse Pt nanoparticles on the FeN₄—C support. A forming gas (5% H₂ in Ar) was applied as a reductant to prepare the Pt/FeN₄—C catalyst. This method minimizes the possible damage of FeN₄ sites by avoiding a complicated wet chemistry synthesis. This catalyst synthesis scheme is illustrated in FIGS. 56a and 56b. As shown in FIG. 63a, atomically-dispersed FeN₄ sites, shown as single bright spots, can be observed in the FeN₄—C carbon support. After the Pt deposition, Pt NPs with a uniform particle size around 2.4 nm (FIGS. 56d and 67a) co-exist with FeN₄ sites embedded in carbon (FIGS. 56c and 56e). These isolated single metal sites are identified to co-exist with N at the atomic level (FIGS. 56e & f) verified using electron energy-loss spectroscopy (EELS). This is a typical feature of atomically dispersed single Fe site catalysts, likely in FeN₄ active sites. These atomic FeN₄ sites are abundant and can be clearly distinguished in the carbon support with uniform dispersion (FIG. 68). The STEM-EDX mapping of the Pt/FeN₄—C in FIG. 69 showed Pt and Fe's relatively separate existence with a small portion of Fe around the Pt NPs. Fe-based aggregates were not observed in the catalyst.

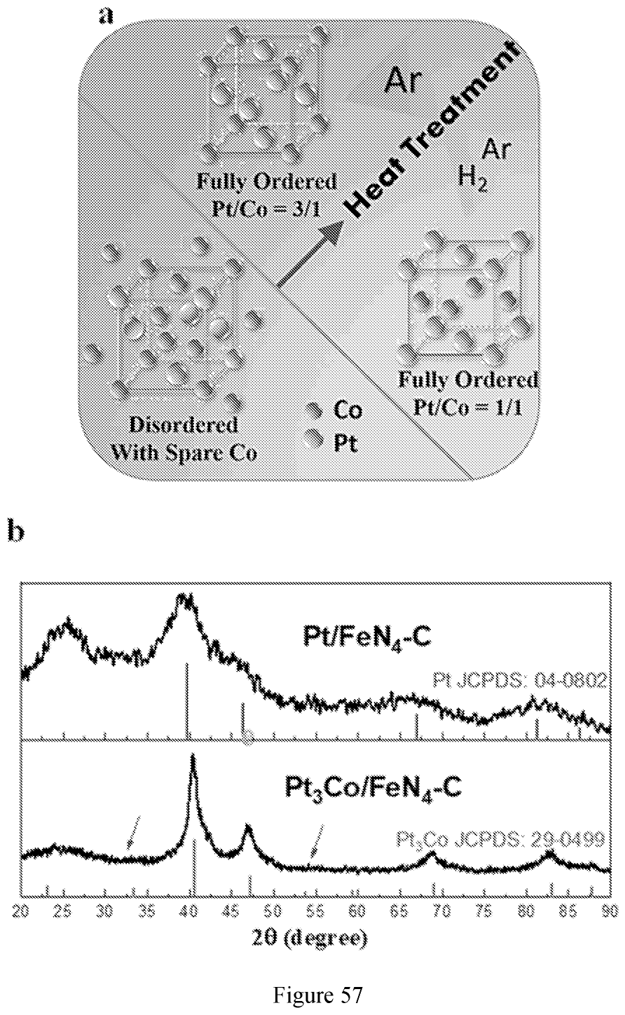

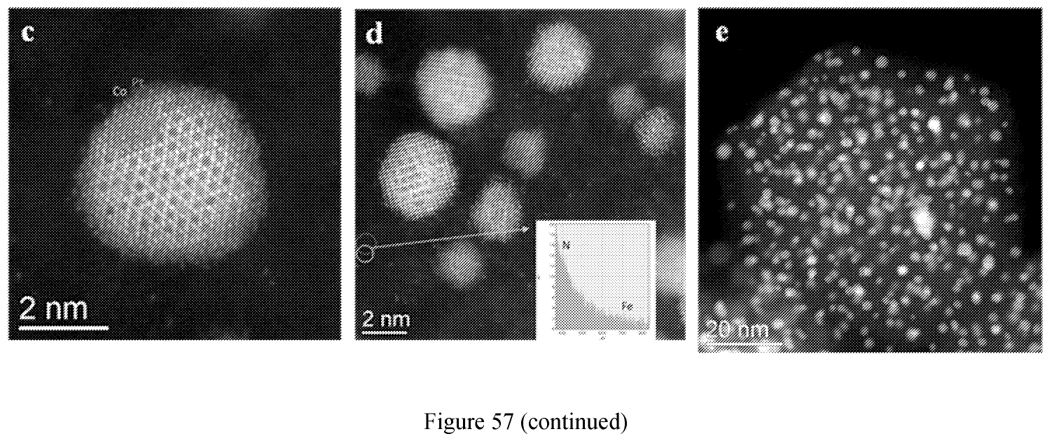

PtCo intermetallic NP catalysts represent one of the most active ORR catalysts. Intermetallic ordering can improve the performance and durability. Pt₃Co intermetallic NPs were integrated with the active FeN₄—C support using an impregnation method followed by a reduction under forming gas at 200° C. (FIG. 57a). To prepare L1₂ (Pt₃Co) intermetallic structures, a method to control their intermetallic structures using second-step annealing at 650° C. under Ar atmosphere was developed. The Pt₃Co intermetallic structures were confirmed using XRD (FIG. 57b). Excess Co could behave as an obstacle to the formation of NP agglomerates during the annealing and can be easily removed using subsequent acid treatment. This new method enables effective control of L1₂ (Pt₃Co) intermetallic structures on the FeN₄—C support.

High-angle annular dark-field scanning transmission electron microscopy (HAADF-STEM) was used to study structures of Pt—Co NPs. Significant atomic number difference between Co (Z=27) and Pt (Z=78) enables clear visualization of atomic ordering in bimetallic Pt—Co NPs through the atomic number (Z) contrast imaging. FIG. 57f show a typical L1₂ Pt₃Co NP viewed along the (001) direction, exhibiting face-centered cubic crystal structure with Pt:Co in a 3:1 ratio. Pt shell structures for the Pt₃Co catalysts are apparent after an acid leaching process, demonstrating a structure known to be highly active for the ORR. L1₂ Pt—Co NPs have a uniform distribution on the FeN₄—C carbon support, presenting average particle sizes of 4.2 nm. (FIGS. 57h and 67). Without intending to be bound by any particular theory, it is considered that the small particle sizes with narrow distribution result from the favorable porous structure and abundant FeN₄ sites in the carbon support (FIGS. 70 and 71), generating electronic confinement effects on Pt—Co NPs and restraining their particle agglomeration during the annealing. Pt₃Co NPs are surrounded by FeN₄ sites at the atomic scale (FIG. 57d & g), indicating their close location for a possible synergistic effect to boost the ORR.

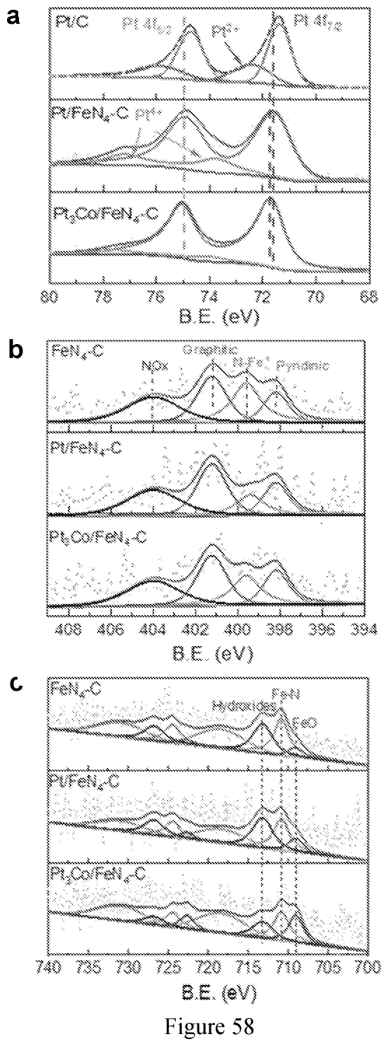

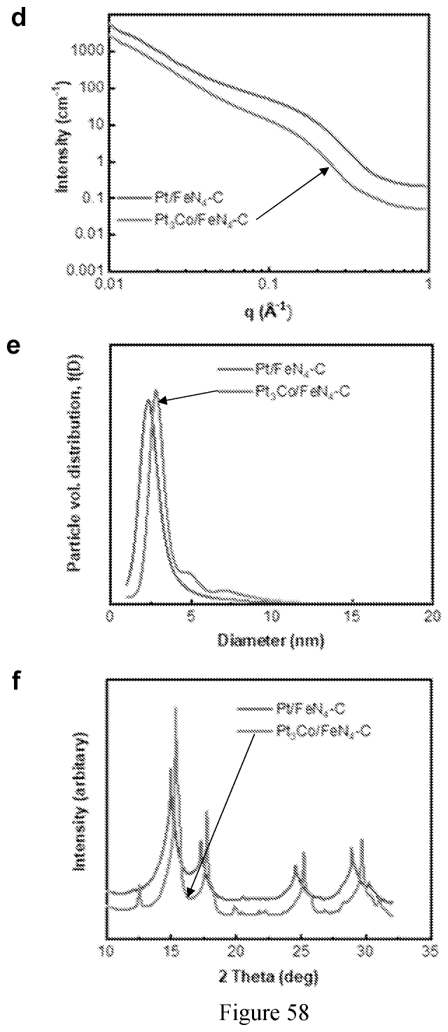

Also investigated were the FeN₄—C supported Pt and Pt₃Co catalysts' electronic structures using X-ray photoelectron spectroscopy (XPS). Possible electron transfer from Pt to the FeN₄—C support causes a positive shift in the Pt 4f binding energy in the Pt/FeN₄—C catalyst (FIG. 58a) compared to conventional Pt/C. FeN₄ sites embedded carbon, behaving electronegatively, can modify the electronic structure of adjacent carbon. The resultant electron deficiency of carbon likely strengthens the Pt NP deposition. It enhances the metal-support interactions. The similar strengthening effect was observed for the Pt₃Co intermetallic NP, evidenced by a further positive shift of Pt 4f binding energy than the Pt/FeN₄—C. Due to the incorporation of Co, these positive shifts of Pt 4f binding energy could be partially caused by the interaction among Pt and Co, along with the introduced strain effects. As for the N is XPS, both Pt and Pt—Co catalysts demonstrated abundant pyridinic N (398.6 eV), graphitic N (401.1 eV), and the possible Fe—N (399.6 eV) content, which is consistent with the FeN₄—C support (FIG. 58b). Pyridinic N and Fe—N bonds are generally evidenced to be the formation of FeN₄ active sites (FIG. 58c), indicating that the FeN₄ active sites in supports are well preserved for all the corresponding Pt or Pt₃Co catalysts consistent with the STEM images.

The small-angle X-ray scattering (SAXS) regions of the X-ray scattering curves are shown in FIG. 58d. The most prominent feature of these curves is the scattering feature in the 0.04 to 0.6 Δ⁻¹ region, attributed to scattering from metal particles. The scattering in this region was fit to yield the particle size distributions shown in FIG. 58e. These data show that as-prepared catalysts have narrow and substantially mono-modal particle size distributions with mean diameters less than 2 nm. The wide-angle X-ray scattering (WAXS) regions of the X-ray scattering curves are shown in FIG. 58f. The WAXS curves show peaks attributed to scattering from the (111), (200), (220), and (311) planes. As illustrated in FIG. 58f, incorporating Co into the catalyst causes a shift of all scattering peaks to larger two-theta values relative to the scattering peaks observed for the Pt/FeN₄—C indicative of compression of the lattice by incorporation of smaller Co atoms. Also evident in FIG. 58f is scattering from the (110) plane indicative of the presence of the Pt₃Co L1₂ ordered intermetallic phase. The ratio of the area of the (110) peak to the sum of the areas of the (111) and (200) peaks can be used to estimate the volume fraction of Pt₃Co comprising the ordered intermetallic phase versus the solid solution phase. This calculation for the peak areas for the Pt₃Co/FeN₄—C catalyst (FIG. 58f) and comparison with the plot of I₁₁₀/(I₁₁₁+I₂₀₀) indicates that approximately 25% of the Pt₃Co is in the L1₂ phase.

Electrocatalysis Study for ORR in Aqueous Acidic Electrolytes.

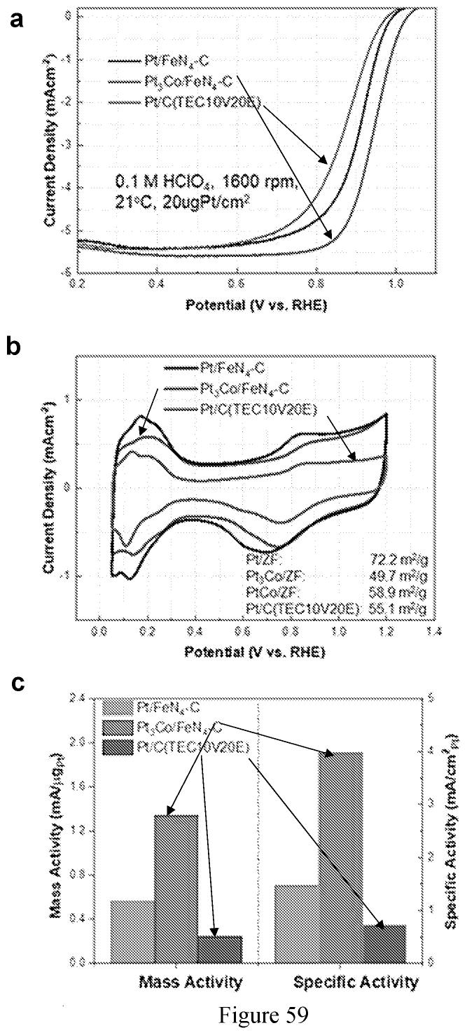

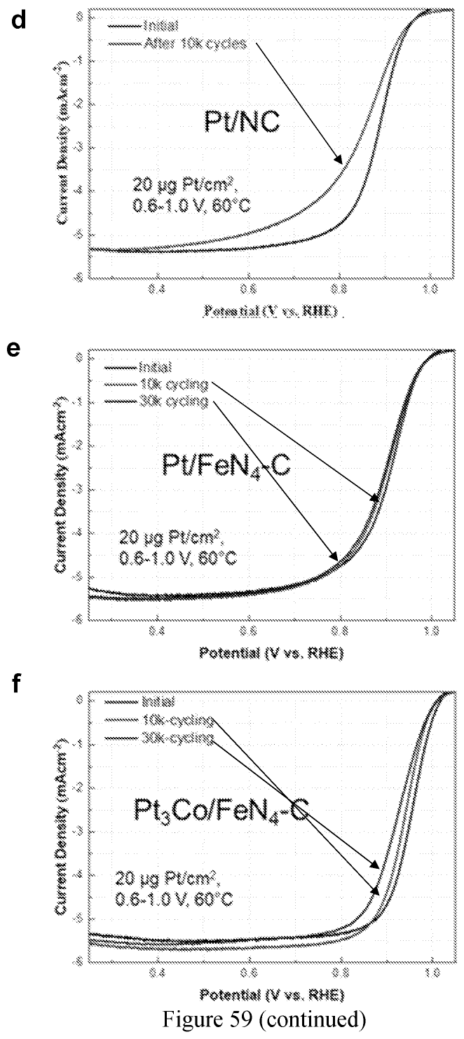

The ORR activity and stability of FeN₄—C supported Pt and Pt₃Co catalysts in 0.1 M HClO₄ electrolyte was evaluated using the RDE method (FIG. 59a). The Pt/FeN₄—C catalyst showed enhanced performance with an E_{1/2} of 0.9 V vs. RHE (60 μg_{Pt}/cm², 1600 rpm, 0.1 M HClO₄) and mass activity (MA) of 0.57 A/mg_{PT} at 0.9 V vs. RHE, exceeding that of commercial Pt/Vulcan Carbon (Pt/C) catalysts (TEC10V20E from TKK) (E_{1/2}: 0.87 V and 0.242 A/mg_{PT}). The enhanced activity suggested that the FeN₄ active sites in the support may promote the Pt/FeN₄—C catalyst due to either mass or intrinsic activity improvements or both. Furthermore, the Pt₃Co/FeN₄—C catalyst exhibited outstanding catalytic activity with E_{1/2} of around 0.95 V vs. RHE. The Pt/FeN₄—C catalyst exhibited higher electrochemically-active surface area ECSA (72.2 m²/g) than the Pt/C (55.1 m²/g) and Pt₃Co catalysts (49.7 m²/g) (FIG. 59b). FIG. 59c compares the measured specific activities (SA) and MA for Pt₃Co/FeN₄—C(SA 3.98 mA/cm²_{Pt}; MA: 1.34 mA/μg_{Pt}) and 4.48 mA/cm²_{Pt}, representing one of the most active PGM catalysts. It should be noted that the underpotential hydrogen adsorption/desorption (HAD) reaction using cyclic voltammetry was employed to determine ECSA to avoid the use of toxic CO for CO stripping experiments. However, it may underestimate the real ECSA by the factor of 1.5 due to the suppression in HAD on small Pt NPs (2-3 nm) of these catalysts primarily attributed to the changes in surface-structure-sensitive adsorption caused by a possible ensemble effect.

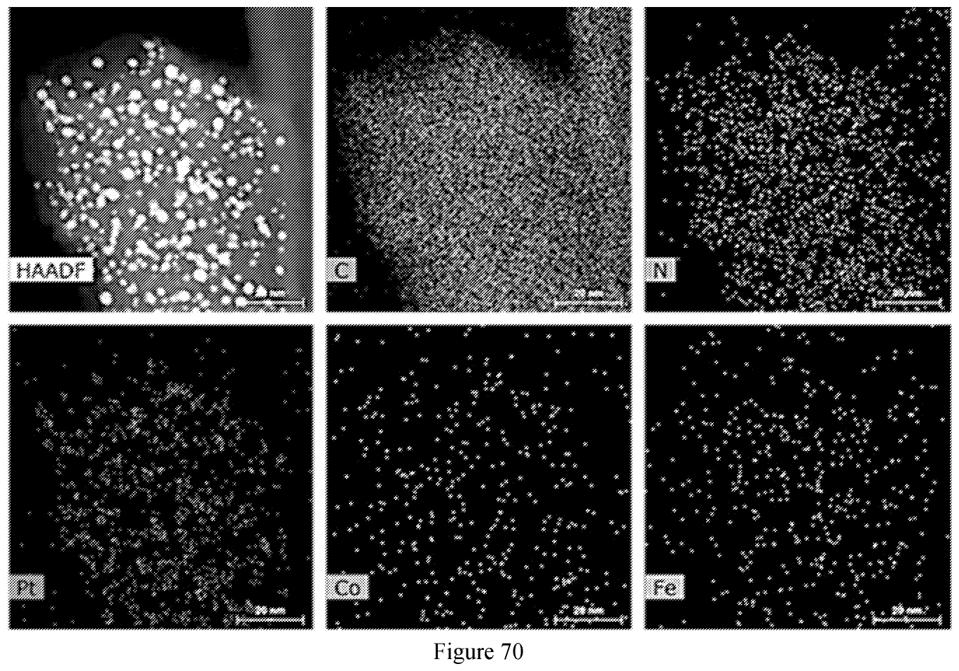

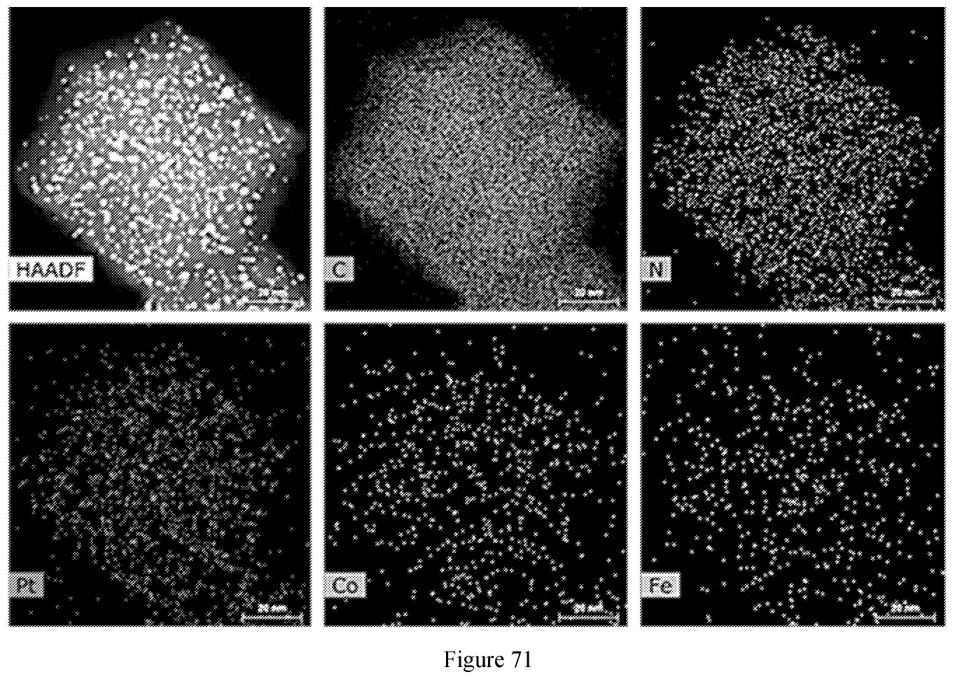

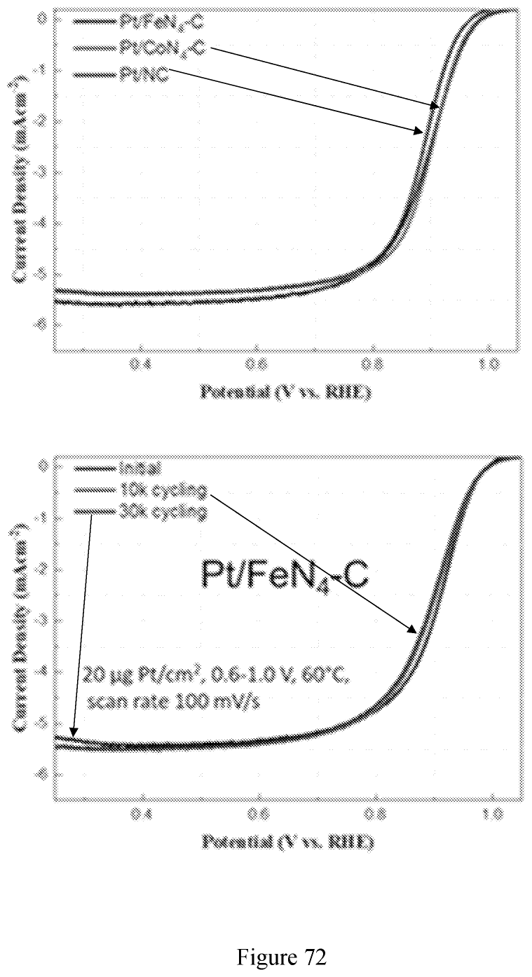

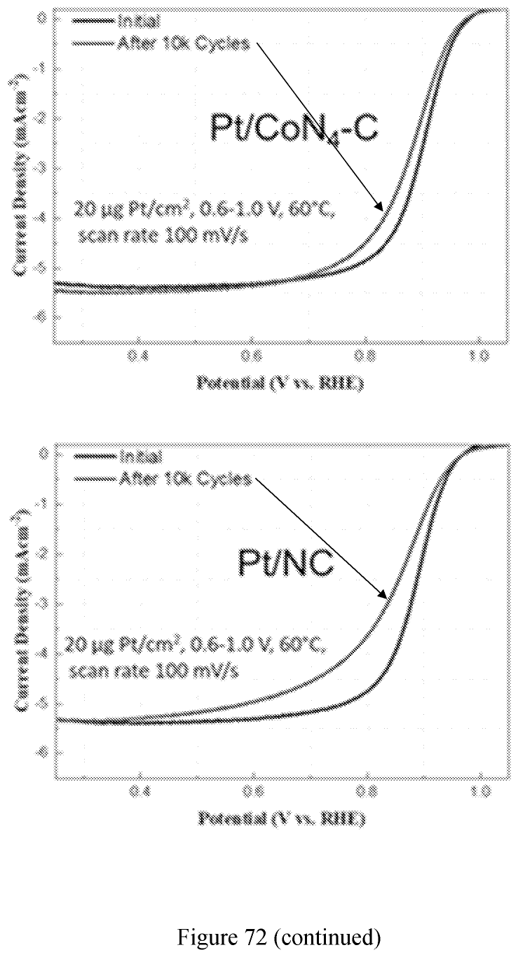

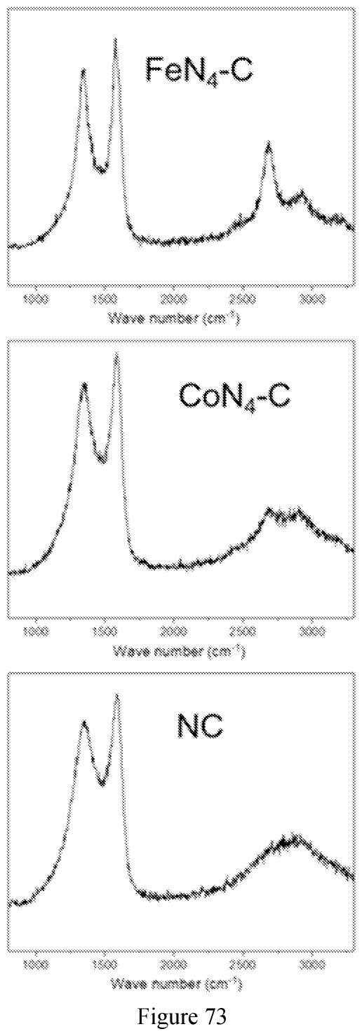

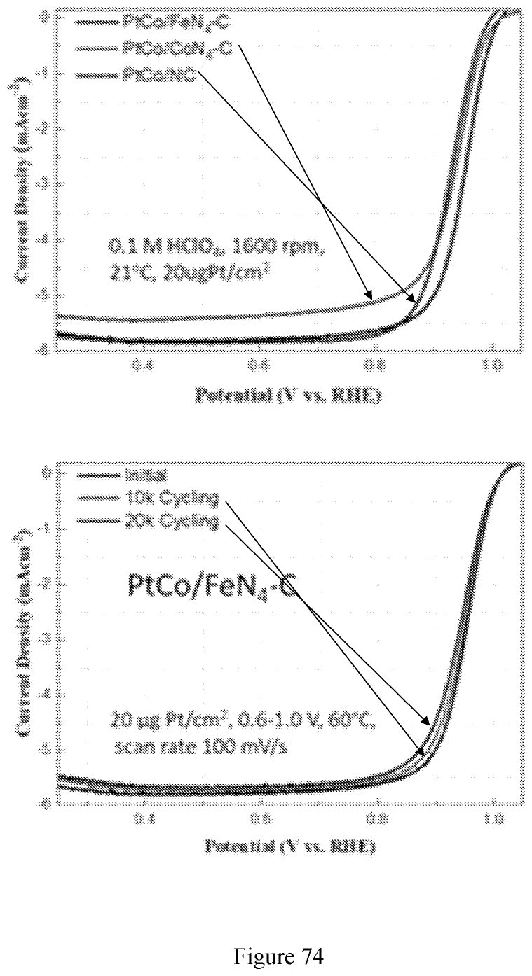

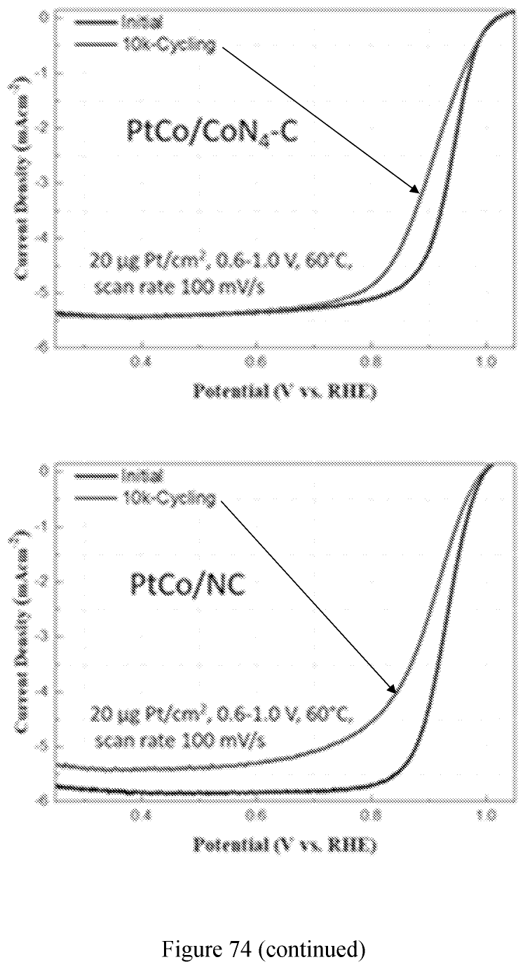

The stability for all studied catalysts was evaluated in an acidic electrolyte using RDE. The Pt/FeN₄—C catalyst exhibited superior stability during accelerated stress tests (ASTs) under 30000 potential cycles from 0.6 to 1.0 V at 60° C. (FIG. 59d). Besides FeN₄ active sites, atomically-dispersed CoN₄ sites and metal-free N-doped carbon are also identified as promising PGM-free catalysts. Compared with the Pt/CoN₄—C and the Pt/NC, the Pt/Fe₄N—C exhibited enhanced catalytic activity. Most importantly, unlike the apparent activity loss observed with the Pt/CoN₄ and the Pt/NC, there is almost no decline for the Pt/FeN₄—C after the AST (FIG. 72). The enhanced stability is likely due to the strengthened metal-support interactions originating from abundant FeN₄ sites in the highly graphitized carbon (FIG. 73). Although the Pt₃Co/FeN₄—C present outstanding activity, degradation of Pt₃Co/FeN₄—C around 30 mV in E_{1/2} was observed during the AST stability studies at 60° C. in 0.1 M HClO₄ electrolyte (FIGS. 59e & f). In agreement with Pt catalysts, the FeN₄—C-supported PtCo catalysts showed enhanced stability versus both the CoN₄—C and NC-supported catalysts (FIG. 74), further confirming the strong interaction provided by FeN₄ active sites in the carbon.

MEA Tests in Fuel Cells.

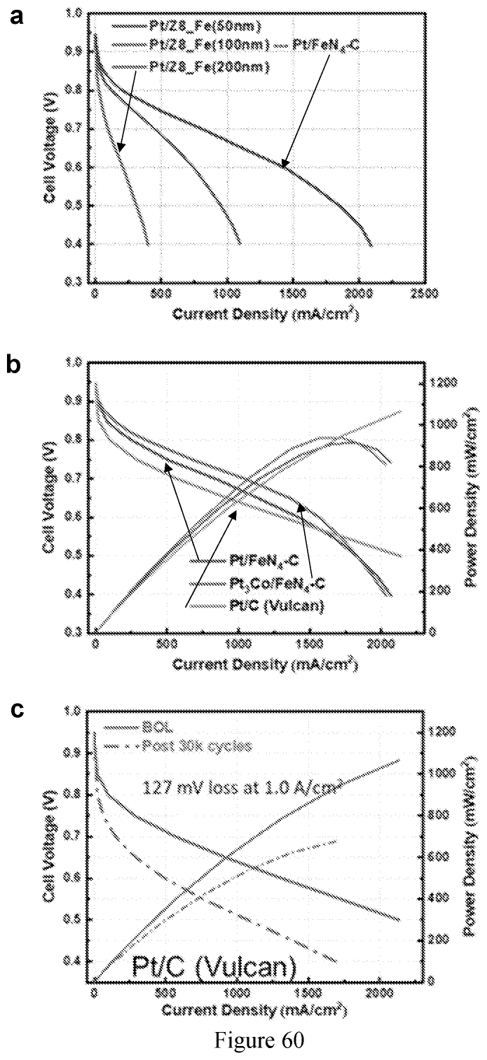

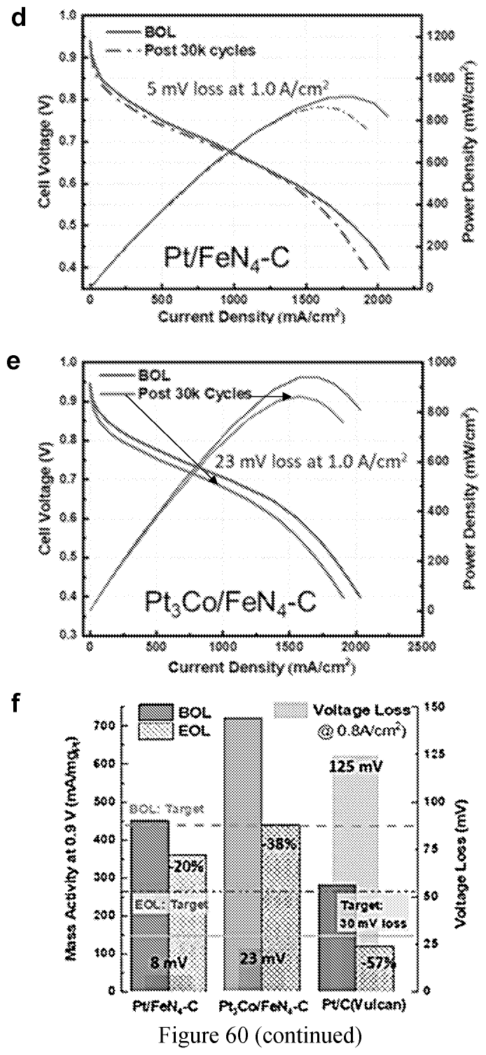

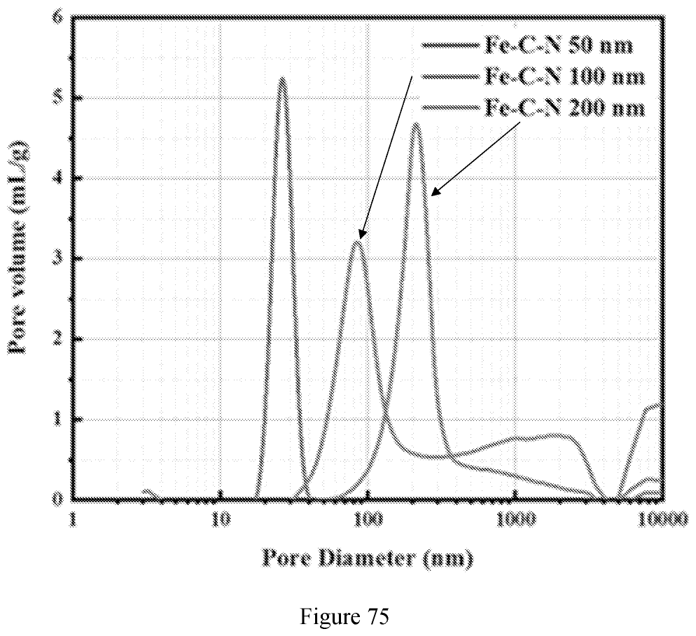

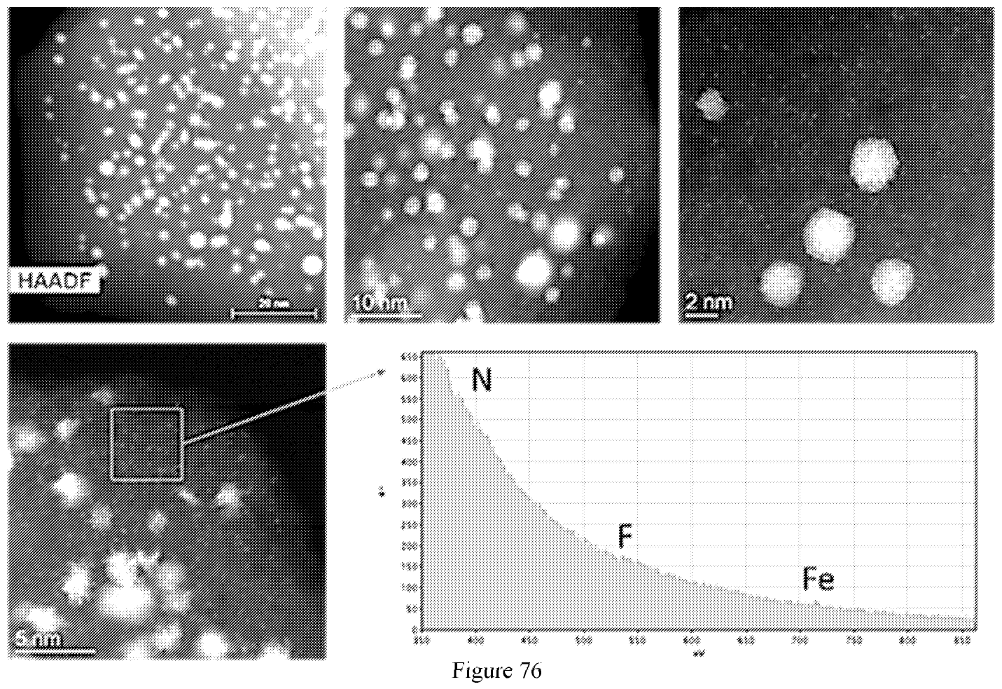

The catalyst performance was evaluated in fuel cell environments, which involved incorporating the catalyst with solid-state ionomer for proton-conduction and the formation of porous electrode structures. Different FeN₄—C-supported Pt and Pt₃Co catalysts were tested as the cathode in membrane electrode assemblies (MEAs) under H₂-air (FIG. 60). According to previous MEA studies on PGM-free catalysts, the particle size of FeN₄—C carbon may affect the catalyst's MEA performance. Therefore, Pt NPs were deposited onto FeN₄—C carbon supports with various sizes of 50, 100, and 200 nm, and evaluated their MEA performances. Results shown in FIG. 60a indicate that the 100 nm FeN₄—C supported Pt catalyst significantly outperforms the others, achieving a much higher current density throughout the entire voltage range. The performance differences may be attributed to the corresponding ionomer dispersion and mass transport limitation in different pore structures resulting from different primary carbon particle sizes (FIG. 75, Table 6). Previous studies using nano-CT imaging on PGM-free Fe—N—C catalysts indicated that the 100 nm carbon particle size could lead to uniform ionomer dispersion with the least proton resistance.

TABLE 6
BET surface area of different Fe-doped
ZIF-8 derived carbon supports.

| | 200 nm | 100 nm | 50 nm |
|---|---|---|---|
| | (m²/g) | (m²/g) | (m²/g) |
| BET Surface area | 696 | 691 | 1145 |

Based on the optimal 100 nm FeN₄—C support, the MEA performance of the Pt/FeN₄—C and the Pt₃Co/FeN₄—C catalysts was compared with commercial Pt/C catalysts, as shown in FIG. 60b. The Pt/FeN₄—C demonstrated a higher current density than the commercial Pt/C in the typical PEMFC operating voltage range (>0.6 V). The corresponding MEA generated a MA at 0.9 V of 0.45 A/mg_{PT} exceeding the DOE target of 0.44 mA/mg_{PT} even without using PtM alloys. It also reached a current density of 1.02 A/cm² at 0.67 V and 0.252 A/cm² at 0.80 V much higher than the Pt/Vulcan (0.77 A/cm² at 0.67 V and 0.10 A/cm² at 0.80 V). The newly achieved MEA performance using the Pt/FeN₄ cathode catalyst is exceptional, comparable with most of the Pt alloy catalysts published thus far. Notably, the much-enhanced mass activity at 0.9 V may not be directly contributed by the FeN₄ active sites in the support. However, the synergistic effect originating from FeN₄ may boost the intrinsic activity of Pt sites, as discussed herein.

In good agreement with RDE tests in acidic electrolytes, the Pt₃Co/FeN₄—C catalyst performed much better in MEAs than the Pt/FeN₄—C catalyst. The Pt₃Co/FeN₄—C cathode exhibited excellent MA at 0.9 V of 0.72 A/mg_{PT}, significantly exceeding the DOE target at 0.440 mA/mg_{PT} (FIG. 60f). The Pt₃Co/FeN₄—C catalysts generated 0.355 A/cm² at 0.8 V, exceeding the DOE target of 300 mA/cm². At the critical voltage of 0.67 V, they yielded 1.23 A/cm², corresponding to power densities of 824 mW/cm².

These Pt and PtCo catalysts were also subjected to AST for 30,000 voltage cycles from 0.6 to 0.95 V with a 0.5 s rise time and 2.5 s dwell time at each potential under H₂/N₂ atmosphere. As shown in FIGS. 60c & f, the Pt/FeN₄—C exhibited superior stability during AST, with only 8 mV loss at 0.8 A/cm² and 20% loss in MA at 0.9 V, significantly exceeding the DOE targets of 30 mV and 40% MA loss. This is in good agreement with RDE results showing excellent activity and stability. The well-preserved performance demonstrated that FeN₄—C supported Pt is superior to current Pt/C catalysts supported on carbon blacks (e.g., XC-72). The Pt₃Co/FeN₄—C catalyst displayed good stability in the MEA with corresponding voltage losses of 23 mV at 1.0 A/cm² and 21 mV at 0.8 A/cm², exceeding the DOE stability target (30 mV loss) (FIGS. 60d & e). Unlike the RDE results at 60° C., the Pt₃Co/FeN₄—C MEA exhibited slightly better stability concerning mass activity loss at 0.9 V (from 0.72 to 0.44 A/mg_{PT}, −38%). This is possibly due to the relatively larger particle size of Pt₃Co NPs, which are more stable in the fuel cell operating environment. For comparison, MAs and H₂-air MEA performances for Pt₃Co/FeN₄—C and Pt/FeN₄—C catalyst, along with representative published results, are provided in Table 7.

TABLE 7
Comparison of MEA mass activity and H₂-Air fuel cell performance of these synergistic catalysts with
representative Pt-alloy catalysts in literatures. The test conditions are the same: 80° C., 100% RH).

| | | | BOL | EOL | Current | Current | Voltage | Power |
|---|---|---|---|---|---|---|---|---|
| | Cathode | | MA | MA | Density | Density | Loss@0.8 | density |
| | Loading | H₂/air | @0.9 V | @0.9 V | @0.6 V | @0.8 V | A/cm² | @ 0.67 V |
| Catalysts | (mg_{Pt}/cm²) | pressure | (mA/mgPt) | (mA/mg_{Pt}) | (mA/cm²) | (mA/cm²) | (mV) | (mW/cm²) |
| Pt/FeN₄—C | 0.1 | 150 | 451 | 361 | 1400 | 245 | 8 | 679 |
| | | kPa | | | | | | |
| | | (abs) | | | | | | |
| Pt₃Co/ | 0.1 | 150 | 720 | 441 | 1605 | 356 | 22 | 822 |
| FeN₄—C | | kPa | | | | | | |
| | | (abs) | | | | | | |
| L1₀-W—PtCo/C | 0.11 | 150 | 570 | 470 | 1020^{e} | 230^{e} | 40^{e} | 500^{e} |
| | | kPa | | | | | | |
| | | (abs) | | | | | | |
| LP@PF-1 | 0.033 | 150 | 1080 | 670 | 1200 | 300 | 6 | 650^{e} |
| | | kPa | | | | | | |
| | | (abs) | | | | | | |
| LP@PF-2 | 0.035 | 150 | 1770 | 260 | 1300 | 270 | 47 | 650^{e} |
| | | kPa | | | | | | |
| | | (abs) | | | | | | |
| L10- | 0.105 | 150 | 560 | 453 | 1000^{e} | 330^{e} | N/A | N/A |
| CoPt/Pt | | kPa | | | | | | |
| | | (abs) | | | | | | |
| P1-NA | 0.1 | 170 | 500^{e} | 170^{e} | 1500^{e} | 200^{e} | N/A | 780^{e} |
| (PtNi) | | kPa | | | | | | |
| | | (abs) | | | | | | |
| P2-NA | 0.1 | 170 | 630^{e} | 440^{e} | 1500^{e} | 200^{e} | N/A | 780^{e} |
| (PtNi) | | kPa | | | | | | |
| | | (abs) | | | | | | |
| P2-SA | 0.1 | N/A | 640^{e} | 510^{e} | N/A | N/A | N/A | N/A |
| (PtNi) | | | | | | | | |
| P2-SA- | 0.1 | N/A | 500^{e} | 550^{e} | N/A | N/A | N/A | N/A |
| AN | | | | | | | | |
| (PtNi) | | | | | | | | |

Catalyst Degradation Mechanisms and XAS Study.

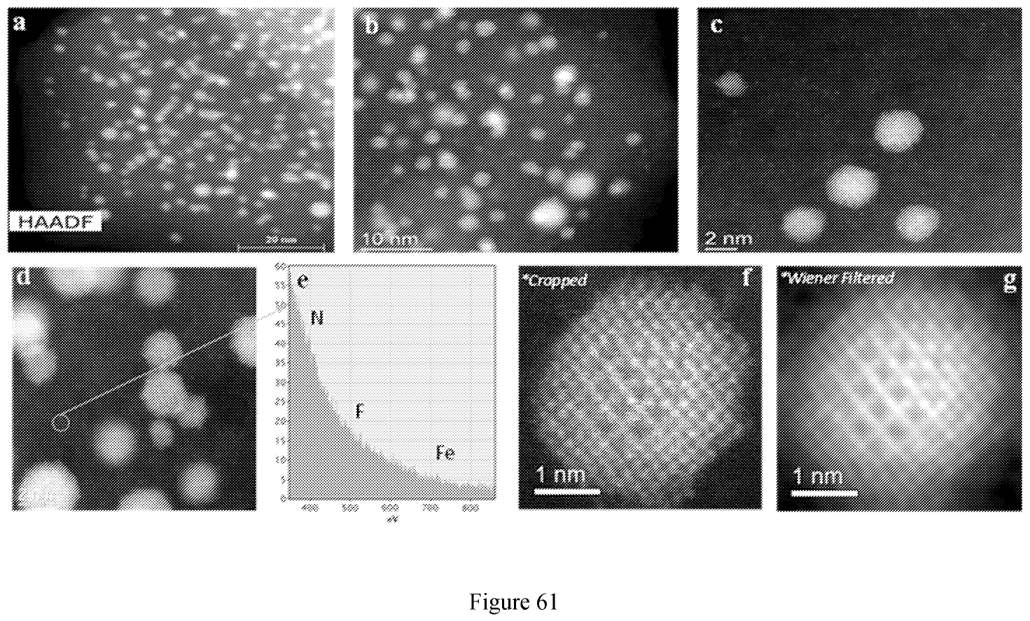

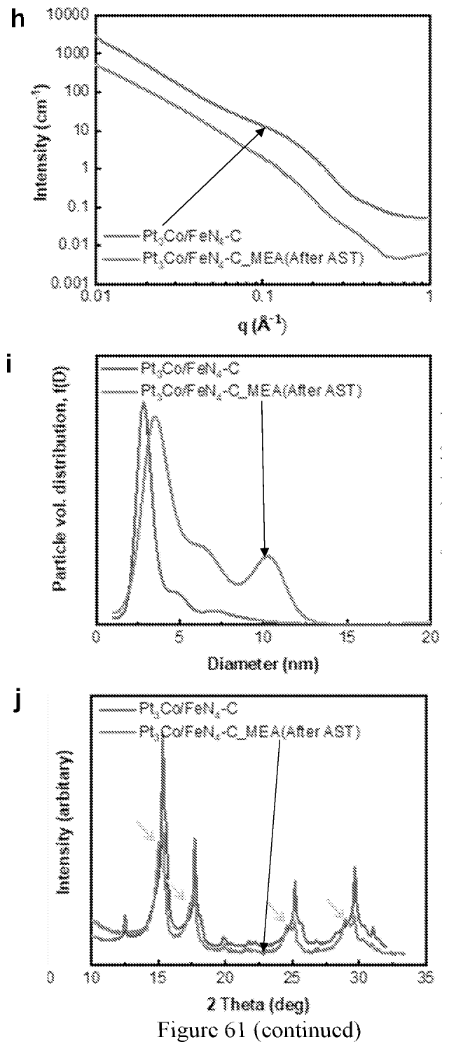

The morphology, structure, and chemical composition of aged FeN₄—C supported PGM catalysts were further studied using advanced electron microscopy. As shown in FIG. 61a-c, the Pt NP size and dispersion were preserved after the AST without apparent agglomeration. Also, the atomically dispersed FeN₄ sites surrounding the Pt NP are retained. The uniform distribution of Fe and N was further confirmed by using the EDX element mapping (FIG. 77). These results supported the hypothesis that the existence of FeN₄ sites in supports strengthens the metal-support interaction, leading to less Pt particle detachment and agglomeration.

Similarly, the coexistence of FeN₄ sites and Pt₃Co NPs remained in the AST-aged catalysts (FIG. 61d-g). The ordered intermetallic L1₂Pt₃Co nanostructures with Pt thin skins were nearly unchanged, in good agreement with the observed high durability in MEA testing. After incorporating catalysts into an MEA and MEA testing, the catalyst particles are observed to increase the mean diameter. The particle size distributions show tailing toward larger diameters and bi- and tri-modal distributions indicative of particle growth (FIGS. 61h & i). The WAXS data for the aged catalyst from the tested MEAS (FIG. 61j) shows overlapping peaks for all reflections with one peak at the two-theta value observed for the as-prepared catalyst (FIG. 58f) and the other shifted to lower two-theta values (indicated using yellow arrows in FIG. 61j). This indicates loss of Co by a portion of the catalyst resulting from incorporation and testing in an MEA. The WAXS peaks for the scattering from the (111), (200), (220), and (311) planes were fit with Gaussian peaks. The two-theta values of the centroids of the fit peaks were utilized to calculate lattice spacings, nearest neighbor distances, and mole fractions of Pt and Co in the phases giving rise to the peaks (Table 8). These fits result in a Pt to Co molar ratio in the as-prepared Pt₃Co/FeN₄—C catalyst of 75:25, as expected. These fits also show that the lattice spacing of a fraction of the catalyst was relatively unaffected by incorporation and testing in the MEA. In contrast, the rest lost nearly all of the original lattice contraction (i.e., lost almost all Co from the lattice). Estimates of the fraction of catalyst losing almost all Co, based on the WAXS peak areas, are 0.6 for the catalyst from the aged MEA, respectively.

TABLE 8
Lattice parameters calculated from WAXS data fits, Pt and Co mole fractions calculated
from lattice parameters, and mean catalyst particle sizes from SAXS data fits.

| | a | NN dist. | Pt | Co | Mean Metal Particle |
|---|---|---|---|---|---|
| Catalysts | (Å) | (Å) | Mol. Frac. | Mol Frac. | Size (nm) |
| Pt@Fe—NC-600 | 3.924 | 2.775 | 1.00 | 0.00 | 1.9 |
| Pt₃Co/FeN₄—C | 3.827 | 2.706 | 0.75 | 0.25 | 2.4 |
| Pt₃Co/FeN₄—C_MEA | 3.834 | 2.711 | 0.79 | 0.21 | 3.3 |
| (After AST) | 3.914 | 2.768 | 0.99 | 0.01 | |

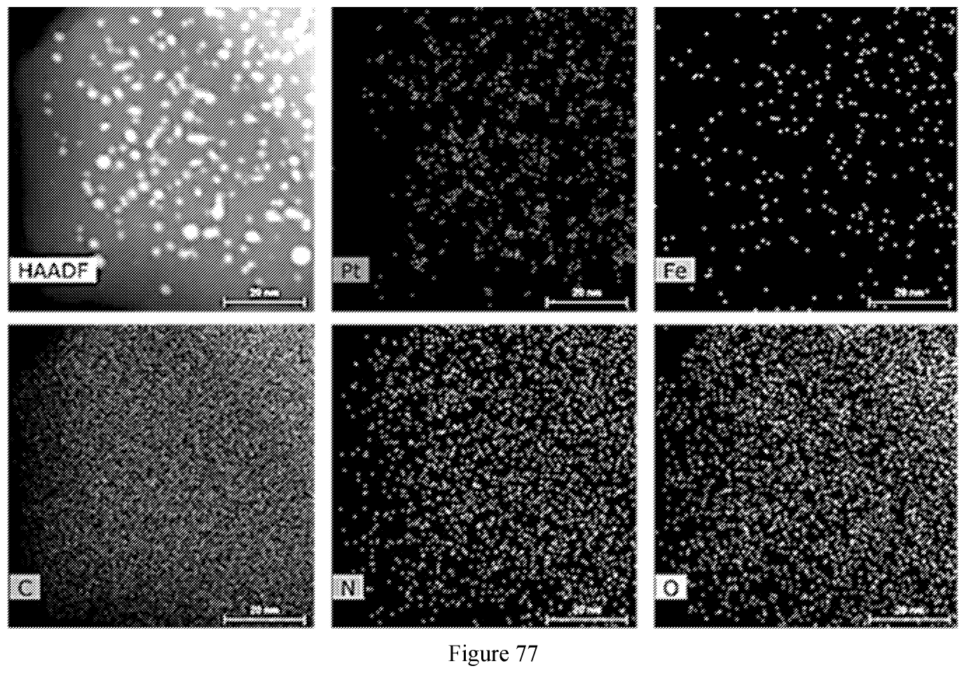

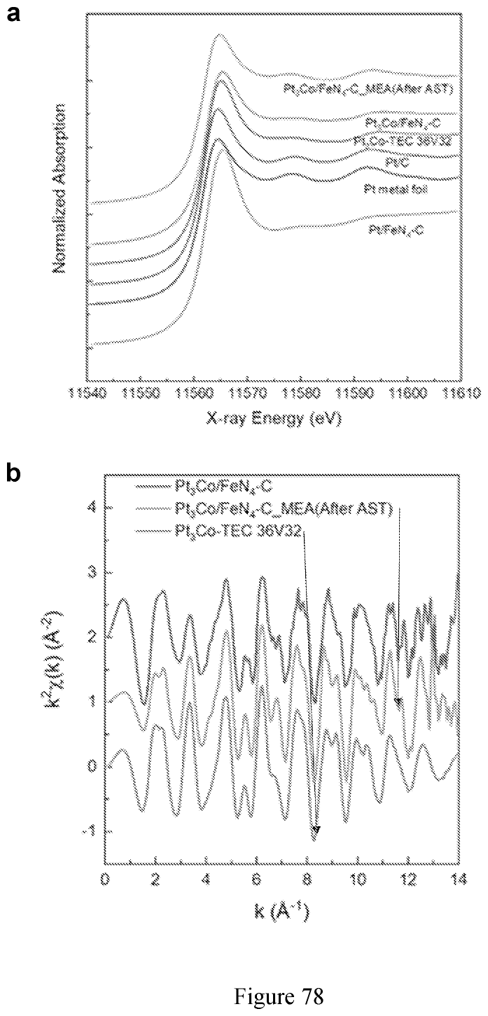

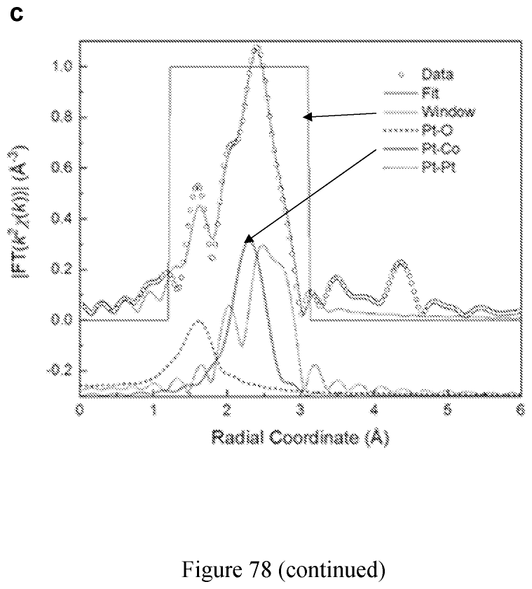

XAFS spectra were processed and fit with the Demeter software package (FIG. 78). The results for Pt and Co are shown in Tables 9 and 10 respectively. Platinum EXAFS were fit between 1.2 Å and 3.1 Å using Pt—O, Pt—Co, and Pt—Pt scattering paths calculated using feff version 6 (feff6). The results are shown in Tables 9. Using scattering paths calculated for a 5 Å Pt cluster, the amplitude reduction factor was found to be 0.805±0.023 from a fit to a Pt metal foil. Furthermore, the energy shift (ΔE₀) was found to be +7.84 eV, which is applied in addition to ΔE₀ in Tables 9 to partially correct for the errors in the feff6 E₀ calculation. The experimental E₀ was defined as the 2^{nd} derivative of m(E) zero crossing. E₀ for the Pt foil was calibrated to 11561.75±0.05 eV, and the E₀ uncertainties for the sample spectra are ±0.2 eV. For the Pt/FeN₄—C, the large Pt—O coordination number (N_{Pt—O}), as well as the Pt—Pt bond length contraction, indicate that the Pt particles are very small. The N_{Pt—O} is large enough to get an accurate measurement of σ² and ΔE₀. For samples where the N_{Pt—O} is very small, σ² and ΔE₀ have been fixed to these values (indicted with bold italics in Tables 9). Compared to the individual path coordination numbers (CN), N_{Pt—Pt} and N_{Pt—Co}, an equivalent pair of variables, the total metal coordination N_{Pt-M} and the fraction N_{Pt—Pt}/N_{Pt-M} are less correlated reduces the uncertainties for these critical parameters. Parameters common to both paths are shown in one row (N and ΔE₀), while parameters specific to each path are shown separately (fraction, R, σ²). For bulk intermetallic Pt₃Co, one would observe 4 Co and 8 Pt nearest neighbors around each Pt atom, and 12 Pt and 0 Co around each Co atom. 32% of the Pt-M bonds are Pt—Co in the commercial platinum cobalt alloy standard, TEC 36V32, which is the correct fraction for Pt₃Co. The Pt₃Co intermetallic is expected to have identical Pt—Co and Pt—Pt bond lengths, while solid solutions will show Pt—Pt and Pt—Co lengths differ. For example, TEC 36V32 Pt₃Co, a solid solution, has Pt—Co and Pt—Pt bond lengths that differ by 0.055 Å. The results are similar for Pt₃Co/FeN₄—C, although lower N_{Pt-M} indicates a smaller average particle size for this catalyst versus the commercial TEC 36V32. The Pt—O coordination in each case is likely a surface oxide since these samples were measured in air.

TABLE 9
Pt L3 EXAFS fit results.

| | | | | Fraction | | | σ² (×10⁻³ | | | | | | k-range (Å⁻¹) |
|---|---|---|---|---|---|---|---|---|---|---|---|---|---|
| Sample | Path | N | | f_{Pt—Co} or f_{Pt—Pt} | R (Å) | | Å²) | | ΔE₀ (eV) | | R-factor | ΔE₀ (eV) | [R-range (Å)] |
| Pt1 5-5 Commercial | Pt—Pt | 9.6 | (3) | | 2.754 | (2) | 5.9 | (2) | 0.0 | (3) | 0.16% | 11561.8 | 3.0-14.2 |
| Pt@C Electrode | Pt—O | 0.42 | (8) | | 2.032 | (16) | [symbol] | | [symbol] | | | | [1.2-3.1] |
| Pt/FeN₄—C | Pt—Pt | 4.0 | (8) | | 2.734 | (10) | 7.3 | (13) | −0.4 | (18) | 1.4% | 11562.4 | 3.0-13.5 |
| | Pt—O | 2.3 | (3) | | 2.011 | (15) | 6.0 | (20) | 4.8 | (1.6) | | | [1.2-3.1] |
| TEC 36V32 | Pt—M | 8.9 | (9) | | | | | | −0.9 | (8) | 0.16% | 11562.4 | 3.0-14.2 |
| (Pt₃Co@C) | Pt—Co | | | 0.32 (7) | 2.652 | (8) | 6.8 | (14) | | | | | [1.2-3.1] |
| | Pt—Pt | | | 0.68 (7) | 2.707 | (5) | 5.9 | (7) | | | | | |
| | Pt—O | 0.86 | (23) | | 2.002 | (26) | 3.2 | (29) | 3.1 | (35) | | | |
| PtCo₃/FeN₄—C | Pt—M | 6.0 | (10) | | | | | | −0.7 | (14) | 1.2% | 11562.4 | 3.0-13.5 |
| | Pt—Co | | | 0.38 (14) | 2.650 | (15) | 6.6 | (26) | | | | | [1.2-3.1] |
| | Pt—Pt | | | 0.62 (14) | 2.708 | (9) | 4.6 | (14) | | | | | |
| | Pt—O | 1.09 | (22) | | 1.991 | (17) | [symbol] | | [symbol] | | | | |
| PtCo₃/ | Pt—M | 9.0 | (5) | | | | | | 0.4 | (4) | 0.17% | 11561.9 | 3.0-14.2 |
| FeN₄—C_MEA(After | Pt—Co | | | 0.14 (4) | 2.668 | (7) | 4.6 | (17) | | | | | [1.2-3.1] |
| AST) | Pt—Pt | | | 0.86 (4) | 2.747 | (2) | 5.3 | (3) | | | | | |

| | | | | | | |
|---|---|---|---|---|---|---|
| Pt—O | 0.60 | (11) | 2.013 | (15) | [symbol] | [symbol] |

TABLE 10
Co K edge EXAFS results

| | | | | Fraction | | σ² (×10⁻³ | | | | | k-range (Å⁻¹) |
|---|---|---|---|---|---|---|---|---|---|---|---|
| Sample | Path | N | | f_{Co—Co} or f_{Co—Pt} | R (Å) | Å²) | ΔE₀ (eV) | | R-factor | E₀ (eV) | [R-range (Å)] |
| TEC 36V32 | Co—M | 9.9 | (5) | | | | −2.4 | (3) | 0.19% | 7709.0 | 3.0-13.3 |
| (Pt₃Co@C) | Co—Co | | | 0.36 (5) | 2.628 (6) | 11.5 (17) | | | | | [1.6-3.1] |
| | Co—Pt | | | 0.64 (5) | 2.656 (5) | 7.0 (6) | | | | | |
| PtCo₃/FeN₄—C | Co—M | 6.0 | (10) | | | | −1.0 | (11) | 0.46% | 7708.4 | 3.0-12.2 |
| | Co—Co | | | 0.28 (14) | 2.638 (17) | 9.6 (73) | | | | | [1.3-3.1] |
| | Co—Pt | | | 0.72 (14) | [symbol] | 4.8 (20) | | | | | |
| | Co—O | 1.05 | (22) | | 1.987 (52) | [symbol] | 5 | (6) | | | |
| PtCo₃/ | Co—M | 7.80 | (9) | | | | −1.9 | (7) | 0.79% | 7708.8 | 3.0-12.2 |
| FeN₄—C_MEA(After | Co—Co | | | 0.32 (12) | 2.628 (15) | 9.5 (44) | | | | | [1.6-3.1] |
| AST) | Co—Pt | | | 0.68 (12) | [symbol] | 5.6 (14) | | | | | |

The aged catalysts show increased N_{Pt-M} and lower N_{Pt—O} coordination numbers than the fresh Pt₃Co/FeN₄—C catalyst, indicating particle growth. They also show a lower Pt—Co fraction, which suggests significant Co dissociation from Pt. In other words, there is a higher average Pt—Pt coordination in the aged catalysts. Increases in average Pt—Pt bond length up to +0.039 Å correspond to larger particles with less cobalt, consistent with the changes in coordination number. It isn't possible to determine whether the changes are due to the growth of separate Pt-rich particles, loss of Co from the growing PtₓCo particles, or a rearrangement of the atoms to form a core-shell structure based on just the Pt EXAFS. The cobalt K edge EXAFS results are shown in Table 10. Uncertainties for the measured E₀ are +/−0.4 eV. S₀² and ΔE₀ were found to be 0.775 and +7.12 eV, respectively, from fits to a cobalt metal foil. For the catalysts, it is clear from inspection that multiple paths overlap between 1.5 and 3.0 Å. However, the shorter k data range compared to Pt made it challenging to resolve them. It was noted that the Pt—Co bond length, R, and σ² from the Pt EXAFS must equal the R and σ² for Co—Pt from the Co EXAFS. These constraints may be applied to stabilize the fits. Therefore, except for TEC 36V32, the Co—Pt distance was fixed, while σ² was allowed to vary. For TEC 36V32 powder, the Co results confirm R and σ² are the same. Therefore, the alternative strategy of simultaneous fits was not pursued. Significant Co—Co coordination is observed at −2.62 Å, much longer than for monometallic Co (R=2.507 Å) and shorter than Pt—Pt (˜2.70 Å), offering further evidence of alloying over both intermetallic and a separate class of Co-rich nanoparticles. A fraction of the particles may consist of intermetallic Pt₃Co, but within the sensitivity of the EXAFS measurements, more of the Co is alloyed.

In addition, the Pt₃Co/FeN₄—C powder exhibited some Co oxidation. The Co-M and Co—O coordination numbers are the same as for Pt, which suggests the Pt and Co are initially similarly distributed between the surface and interior. All other samples had a low-R structure but fitting it to Co—O resulted in unstable fits with physically unreasonable parameters. Therefore, only Co-metal paths were fit in those samples. In the MEAs, N_{Co-M} does not increase as much as N_{Pt-M}, which suggests that the processes responsible for the change in Co coordination are not in concert with those responsible for the Pt coordination change. One explanation is that some Pt-rich particles have grown quite large, consistent with the increased average Pt—Pt bond length and the larger Pt—Pt fraction.

DFT Study of FeN₄—C Supported Pt Catalysts.

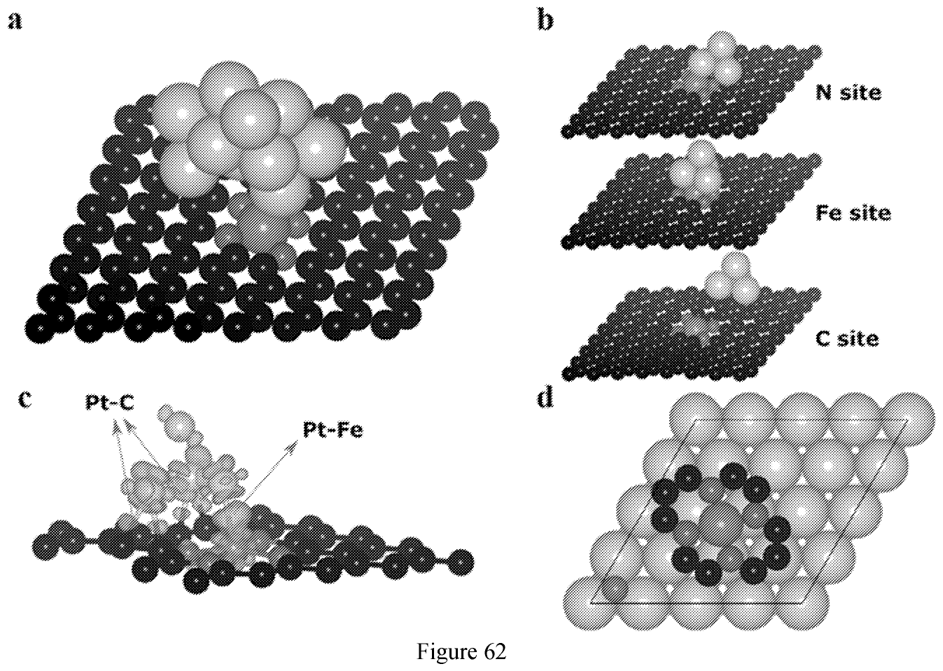

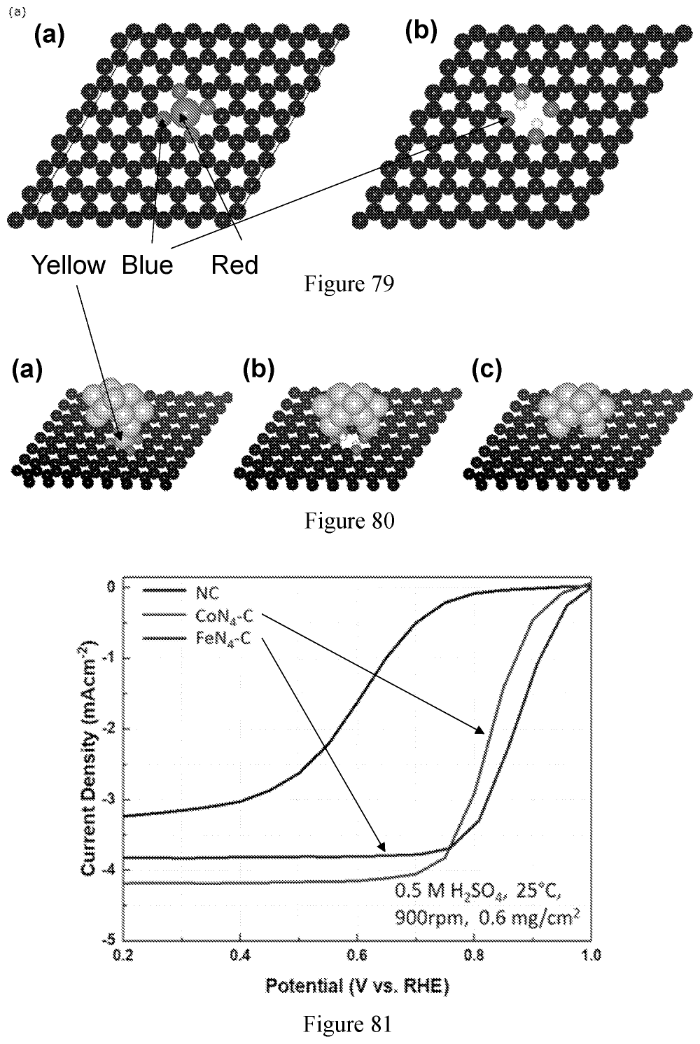

The first-principles density functional theory (DFT) calculations were performed to understand the synergy that MN₄ (M: Fe or Co) and N sites in carbon modify catalytic properties of Pt sites. A computational model was constructed consisting of a thirteen-atom cuboctahedral Pt₁₃ cluster and a graphene layer with a FeN₄ (Pt/FeN₄—C), a CoN₄ (Pt/CoN₄—C), an N₄ moiety (Pt/NC), or no dopants (Pt/C). The optimized atomistic structures of Pt/FeN₄—C, Pt/CoN₄—C, Pt/NC, and Pt/C are shown in FIG. 62a and FIGS. 79-80. The binding energy was calculated using these models, defined as the energy difference between the adsorption system and the corresponding isolated system (i.e., the Pt₁₃ cluster and the doped carbon substrate). In Table 11, the DFT results show that the binding energies of the Pt/FeN₄—C, Pt/CoN₄—C, Pt/NC, and Pt/C systems are −4.23, −4.15, −3.43, and −2.43 eV, respectively. A more negative value of the binding energy indicates stronger interaction between the Pt cluster and carbon substrates. Consequently, FeN₄ sites in carbon lead to the strongest binding for Pt clusters.

TABLE 11
Predicted binding energies between metal, and nitrogen co-doped carbon
substrate and Pt clusters including a four-atom tetrahedral Pt4 cluster
and a thirteen-atom cuboctahedral Pt13 cluster. The binding energies
were calculated as the difference in energy between the adsorption
system and the corresponding isolated systems. Hence, negative value
of the binding energy indicates attractive interaction between the
Pt NPs and metal, nitrogen co-doped carbon substrates.

| E_{b} (eV) | FeN₄—C | CoN₄—C | N₄—C | C |
|---|---|---|---|---|
| Pt13 | −4.23 | −4.15 | −3.43 | −2.43 |
| Pt4 | −3.30 | −3.15 | −2.16 | −1.20 |

To further distinguish the most favorable binding sites to a Pt NP, the DFT calculations were performed to predict the binding energy of a four-atom tetrahedral Pt₄ cluster adsorbed on various graphene locations containing a FeN₄ moiety (FIG. 62b). The centroid of a Pt₄ cluster prefers to be anchored on the top of the nitrogen site, with a binding energy of −3.30 eV, compared to on the Fe site and C site with binding energies of −2.60 and −1.90 eV, respectively. Furthermore, FIG. 62c shows that when the centroid of a Pt₄ cluster is adsorbed on the N site of a FeN₄ moiety, the Pt atoms in the Pt₄ cluster will form strong interaction with the central Fe site and the two C sites adjacent to the N atom. The migration of Pt NPs on carbon leads to catalyst particle agglomeration and performance loss. Here, it was predicted that a FeN₄ site in carbon could suppress the migration process of Pt NPs. Hence, the DFT results elucidate that the Pt/FeN₄—C catalyst exhibited much enhanced stability than the Pt/CoN₄—C and Pt/NC catalysts (FIG. 72).

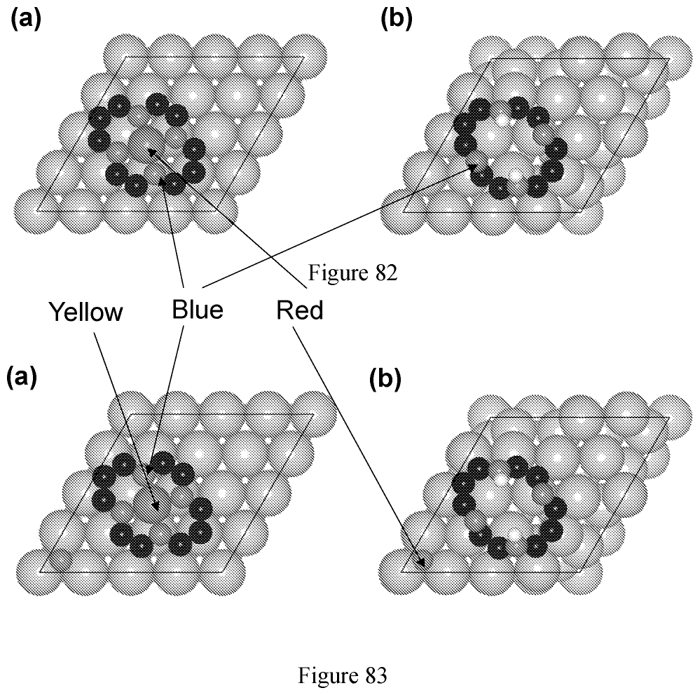

The DFT calculations were conducted to investigate how the FeN₄ site affects the intrinsic ORR activity of Pt sites. Previous studies once indicated that the Pt NP could assist the CoN₄ site to break O—O bond, resulting in the enhancement of the CoN₄ site's ORR activity. Others have suggested Pt(100) could enhance the ORR activity of FeN₄ active site through tailoring local charge distribution near the FeN₄ site. These studies found that Pt will enhance the ORR activity at MN₄ sites. However, considering the ORR activity measured herein on the Pt/FeN₄—C, Pt/CoN₄—C, and Pt/NC catalysts are much higher than PGM-free MN₄ sites (FIGS. 81 and 72), it is considered that the opposite effect may be more reasonable, i.e., FeN₄ sites enhancing the intrinsic activity of Pt sites. As shown in FIG. 82, FeN₄@Pt(111), CoN₄@Pt(111), and N₄@Pt(111) models consisting of an MN₄ or an N moiety adsorbed at Pt(111) surface were constructed. The binding energy of O on the metal surface, e.g., Pt(111), denoted as ΔE₀−ΔE₀^{Pt}, is an adequate descriptor to evaluate the ORR activity. The volcano plot suggests that a metal surface that binds O with about 0.2 eV weaker than Pt(111) surface would have a maximum ORR activity. Here, the binding energies of O on the exposed Pt site of FeN₄@Pt(111), CoN₄@Pt(111), and N₄@Pt(111) were calculated, and the corresponding atomic structure of optimized configuration of adsorbed O are presented in FIG. 62d and FIG. 83. The value of ΔE₀−ΔE₀^{Pt} on FeN₄@Pt(111), CoN₄@Pt(111), and N₄@Pt(111) were predicted to be 0.15, 0.13, and 0.12 eV weaker, suggesting that all these PGM-free sites, especially the FeN₄ could effectively enhance intrinsic activity of the Pt(111) surface. The theoretical predictions is well verified by using FeN₄ site-rich carbon as the support for Pt and PtCo catalysts with significantly enhanced ORR activity and MEA performance.

Conclusions.

Demonstrated herein is a design of high-performance low-PGM fuel cell catalysts by integrating the highly stable Pt₃Co intermetallic nanoparticle and the most promising PGM-free FeN₄ site-rich carbon catalyst. The high surface area, porous morphology, controlled graphitization degree, and adjustable carbon particle size dramatically improve the Pt and PtCo nanoparticle dispersion with uniform and narrow size distribution, promoting high catalytic activity and Pt utilization. In addition, the dense FeN₄ sites likely significantly strengthen the interaction between Pt and carbon, thus preventing nanoparticle agglomeration, which enhances catalyst stability. Significantly, the FeN₄ sites around the Pt sites can weaken the adsorption of O₂ and intermediates during the ORR, intrinsically improving the catalytic activity of Pt for the ORR.

Atomically dispersed FeN₄ carbon-supported Pt and the ordered cubic L1₂ (Pt₃Co) intermetallic catalysts were synthesized. Compared to the common solid solution Al-structure, PtCo intermetallics with strong Pt-M interaction are particularly promising as new fuel cell catalysts due to their superior M-stabilization in the corrosive ORR conditions. Comprehensive RDE and MEA studies verified that the FeN₄-rich carbon is superior to traditional nitrogen-doped carbon and carbon black concerning ORR activity and stability. In particular, the Pt/FeN₄—C catalyst has achieved compelling activity and stability with 30 mV positive shift in half-wave potential relative to a Pt/C (i.e., Vulcan XC-72) catalyst and only 10 mV loss after 30 k potential cycles. MEA performance further demonstrated outstanding mass activity at 0.9 V (0.45 A/mg_{PT}) and durability (20% loss in MA at 0.9 V and 8 mV loss at 0.8 A/cm² MEA studies), achieved the challenging DOE targets by using Pt even without alloying.

The Pt₃Co intermetallic catalyst on the FeN₄-carbon achieved a high ORR activity with half-wave potentials above 0.95 V, representing one of the most active PGM catalysts. The Pt₃Co/FeN₄ MEA reached a power density of 824 mW/cm² at 0.67 V and only lost 23 mV at 1.0 A/cm² after 30,000 voltage cycles in an MEA. Further engineering electrode structures by optimizing ionomer/carbon ratios can balance ORR mass activity, power density, and durability. Thus, the effective approach to leveraging the most promising PGM-free FeN₄ sites in the design of ordered PtCo intermetallics for high-performance low-PGM catalysts may be a new avenue to advance fuel cell catalyst technologies for the high impact transportation application.

Experimental Details:

Catalysts Synthesis.

Synthesis of the ZIF-8_Fe derived carbon support. The synthesis of active ZIF-8_Fe carbon material is based on our previous publication. The typical synthesis procedure of 100 nm ZIF-8_Fe carbon material is described below with a few modifications. Zinc nitrate hexahydrate (3.39 g) and iron nitrate nonahydrate (100 mg) were dissolved in 300 mL methanol in a round-bottom flask as solution 1; 2-Methylimidazole (3.94 g) was dissolved in another 300 mL methanol as solution 2. Two solutions were then mixed gradually into the bottom-flask, and it was sealed with a rubber stopper along with a cable tie. The mixture was then put into an oven and heated from 25° C. to 60° C. in 20 mins. The oven was kept at a constant temperature at 60° C. for 24 h. After cooling, the resulting suspension was separated by centrifuging at 9000 rpm (10-15 mins each time) to collect all precipitant and washing with ethanol three times. All precipitant was collected and dried at 60° C. in a vacuum oven for 12 h. The dried light-yellow powder was then finely ground and heated at 1100° C. in a tube furnace under N₂ flow for three hours. After heat treatment, the furnace was cooled down to 25° C. The obtained black powder was finely ground to be the as-synthesized FeN₄—C carbon support.

Synthesis of the Pt (Pt—Co)/FeN₄—C catalysts. Pt—Co nanoparticle deposition onto the FeN₄—C carbon support was performed through a forming gas (hydrogen (10%)+argon) reduction method with a controlled Pt mass loading of 20 wt %. The carbon support powder was dispersed in Milli-Q water by ultrasonic treatment for 1 hour to form a homogeneous complex suspension.

Pt: Then, a given amount of hexachloroplatinic acid solution (10 mg/mL) was added into the previous suspension solution under stirring for 20 minutes with N₂ bubbling. The new suspension solution was further homogenized by ultrasonic treatment for 1 hour and quick-freeze using liquid nitrogen, followed by freeze-drying overnight. The dried powder was then heated at 200° C. in a tube furnace under forming gas flow for six hours. After cooling down to 25° C., the furnace was reheated to 600° C. for another 1 hours, under argon to obtain the final catalyst.

Pt—Co: Then, a given amount of hexachloroplatinic acid solution and hexahydrate cobalt (II) chloride (both 10 mg/mL) were added into the previous suspension solution under stirring for 20 minutes with N₂ bubbling. The new suspension solution was further homogenized by ultrasonic treatment for 1 hour and quick-freeze by using liquid nitrogen, followed by freeze-drying overnight. The dried powder was then heated at 200° C. in a tube furnace under forming gas flow for six h. After cooling down to 25° C., the furnace was reheated to 650° C. for another 6 hours, under argon or forming gas for ordering L1₂ Pt₃Co. The resulting powder was leached by 0.1 M HClO₄ at 60° C. for 6 hours and post-treated at 400° C. under argon to obtain the final catalyst.

Physical Characterizations.

Raman spectra were collected on a Renishaw Raman system at 514 nm laser source to analyze carbon structures. Excitation power was held constant at ˜150 μW for all samples prepared as powders on a glass surface. The excitation laser was focused through a 100× microscope objective for a total interrogation spot size of ˜1 micron diameter. The scattered light was collected in backscatter configuration into an optical fiber and then dispersed through the Renishaw spectrometer and projected onto a CCD camera. Scanning electron microscopy (SEM) images were obtained on a Hitachi SU 70 microscope at a working voltage of 5 kV. Bright-field and high-resolution transmission electron microscopy (HRTEM) images and scanning TEM-energy dispersive spectroscopy (STEM-EDS) elemental maps were obtained with a Talos F200X (Thermo Fisher Scientific) at an accelerating voltage of 200 kV.

X-ray diffraction (XRD) was conducted by using a Rigaku Ultima IV diffractometer with Cu K-α X-rays. X-ray photoelectron spectroscopy (XPS) was performed with a Kratos AXIS Ultra DLD XPS equipped with a hemispherical energy analyzer, and a monochromatic Al Kα source operated at 15 keV and 150 W and pass energy was fixed at 40 eV for the high-resolution scans. Samples were prepared as pressed powder supported on a metal bar for the measurements. The FWHM of the major XPS peaks ranged from 0.3 eV to 1.7 eV for the relevant elements. All the instrument parameters were constant, including FWHMs, peak shapes, instrument design factors, chemical shifts, experimental settings, and sample factors. The binding energy of Au was used as the reference. Pt particle size distributions were measured by TEM images of more than 120 particles for different catalysts.

X-ray scattering at beam line 9-ID-C at the Advanced Photon Source (APS), Argonne National Laboratory, was utilized to determine the catalyst particle size and lattice spacings of the metal particles in the as-prepared catalyst powders and in the cathodes of the AST-cycled MEAs. Monochromatic X-rays with an energy of 21 keV were used for the X-ray scattering measurements. The scattered X-ray intensity was obtained over a range of scattering angles/scatterer dimensions: ultra-small-angle X-ray scattering (USAXS), pinhole small-angle X-ray scattering (pinSAXS), and wide-angle X-ray scattering (WAXS). A Bonse-Hart camera was used for the USAXS region data collection and a Pilatus 100 K detector for pinhole SAXS and WAXS. The complete scattered intensity, I(q), was then obtained by combining the USAXS (10⁻⁴ to 6×10⁻² Å⁻¹) and the pinhole SAXS (3×10⁻² to 1 Å⁻¹). The scattering data were corrected and reduced with the NIKA software package, and data analysis was conducted using the IRENA software package. Both packages were run on IGOR Pro 7.0 (Wavemetrics).

Metal particle size distributions were obtained from the measured scattering data using the maximum entropy (MaxEnt) method, which involves a constrained optimization of parameters to solve the scattering equation:

I(q)=|Δ_{Q}|2∫|F(q,r)|2(V(r))2Np(r)drᵢₙₜ

Where I(q) is the scattered intensity, Q is the scattering length density of the particle, F (q, r) is the scattering function at scattering vector q of a particle of characteristic dimension r. V is the volume of the particle, and Np is the number density of particles in the scattering volume.

The WAXS data covered a d-spacing range from approximately 6 Å to 0.8 Å. The background scattering taken for the mounting tape was subtracted from the scattering data for each sample. The WAXS data analysis utilized powder diffraction multi peak fitting 2.0, an Irena macro. The positions of the (111), (200), (220), and (311) scattering peaks were utilized to determine the lattice spacing and this spacing was then utilized to calculate the Pt to Co ratio in the crystalline portions of the catalyst particles using Vegard's law and the nearest neighbor (NN) distances of 2.775 Å and 2.492 Å for Pt and Co, respectively. The Pt—Pt nearest neighbor distance was determined by fitting the WAXS region of data acquired for the as-prepared Pt/Fe—N—C catalyst. The Co—Co nearest neighbor distance was determined from the EXAFS fits for Co foil.

XAFS measurements were made at Materials Research Collaborative Access Team (MRCAT) beam lines 10ID and 10BM at The Advanced Photon Source, Argonne National Laboratory. Co and Fe K edge XAFS were measured at 10ID using a gas ionization chamber with Soller slits and the appropriate filter. Harmonic rejection was accomplished using the uncoated mirror. Pt L₃ edge XAFS were measured at 10BM using a Vortex ME4 silicon drift detector. The monochromator 2^{nd} crystal was detuned to 50% of the maximum intensity for harmonic rejection. Double crystal Si (111) monochromators were used at both beam lines. The vertical beam slit on 10BM was set to limit energy resolution degradation to less than +10%. The energies were calibrated within ±0.05 eV to known in the art.

Electrochemical Measurements. All electrochemical measurements were performed on a CHI Electrochemical Station (Model 760b) equipped with high-speed rotators from Pine Instruments. A rotating ring disk electrode (RRDE) from Pine Research Instrumentation (model: AFE7R9GCPT, USA) was used as the working electrode, containing glassy carbon disk and platinum ring: disk OD=5.61 mm; ring OD=7.92 mm; ID=6.25 mm. An Hg/HgSO₄ reference electrode and a graphite rod counter electrode with a diameter of 0.250 inches and a length of 12 inches were used to complete the cell. To prepare the working electrode, 10 mg catalyst was dispersed ultrasonically in a 1.0 mL mixture of isopropanol and Nafion (5 wt. %) solution to form an ink. The ink was then drop-casted on the disk electrode with a designed loading of 20 μg_{Pt}/cm² and dried at room temperature to yield a thin-film electrode. All the cyclic voltammetry (CV) and ORR polarization curves were recorded in 0.1 M HClO₄, and the ORR activity was measured in 0.1 M HClO₄ saturated with O₂ at 1600 rpm using linear sweep voltammetry (LSV) polarization plots at a scan rate of 10 mV·s⁻¹. The accelerated stress tests (ASTs) were applied to evaluate catalyst stability by cycling the potentials ranging from 0.6 to 1.0 V, (scan rate: 50 mV/s) at 60° C. in 0.1 M HClO₄ saturated with N₂ by using RDE. All reference potentials have been converted to a reversible hydrogen electrode (RHE).

Fuel Cell Fabrication and Testing. As-synthesized catalysts were incorporated into the membrane electrode assembly (MEA) by directly spraying a water/n-propanol based ink onto a Nafion 211 membrane. The MEA was prepared with a Pt loading of ˜0.1 mg_{Pt} cm⁻² on the cathode side. H₂-air fuel cell testing was carried out in a single cell using a commercial fuel cell test system (Fuel Cell Technologies Inc.). The MEA was sandwiched between two graphite plates with straight parallel flow channels machined in them. The cell was operated at 80° C., with 150 kPa_{abs} H₂/air or H₂/O₂, and a gas flow rate of 500/1000 sccm for anode/cathode, respectively. Catalyst mass activity was measured via the current DOE/FCTT protocol (potential step from 0.6 V to 0.9 V and 15 min hold, current averaged during last 1 min) and by measuring the current at 0.9 V (IR-free) in 150 kPa_{abs} H₂/O₂ (80° C., 100% relative humidity (RH), 500/1000 sccm) with correction for measured H₂ crossover. The electrochemical active surface area was obtained by calculating underpotentially-deposited hydrogen (H_{UPD}) charge in CV curves between 0.1-0.4 V (0.4-0.45 V background subtracted); assuming a value of 210 μC/cm² for the adsorption of a hydrogen monolayer on Pt (CV curves were obtained under 150 kPa_{abs} H₂/N₂, 30° C., >100% RH, 500/1000 sccm). The potential cycling accelerated stability test (AST) was conducted using the trapezoidal wave method from 0.6 V to 0.95 V with 0.5 s rise time and 2.5 s hold time (150 kPa_{abs} H₂/N₂, 80° C., 100% RH, 200/200 sccm).

Computational method. The first-principles density functional theory (DFT) calculations with a plane-wave basis set were performed using the Vienna ab initio simulation package (VASP) software. In all calculations, the plane-wave basis set's cutoff energy was set as 500 eV for plane wave expansion. The generalized gradient approximation (GGA) in the form of the Perdew, Burke, and Ernzernhof (PBE) functionals was used to describe the electronic exchange and correlation energy. The projector augmented wave (PAW) pseudopotential was used to describe the core electrons. Metal, nitrogen co-doped carbon was modeled with a hexagonal 7×7 graphene layer containing the metal and nitrogen dopants. Platinum clusters were modeled using a thirteen-atom cuboctahedral particle and a four-atom tetrahedral particle. The platinum catalyst was modeled with a p(4×4) Pt(111) surface slab. The Brillouin zone was sampled using Monkhorst scheme with 2×2×1 k-point grid for model Pt/FeN₄—C, Pt/CoN₄—C, and Pt/N₄—C, 3×3×1 k-point grid for model FeN₄@Pt(111), CoN₄@Pt(111), and N₄@Pt(111). A vacuum layer of 12 Å perpendicular to the surface was added to avoid periodic images' interaction.

Although the present disclosure has been described with respect to one or more particular embodiments and/or examples, it will be understood that other embodiments and/or examples of the present disclosure may be made without departing from the scope of the present disclosure.

1. A composition, comprising:
a graphitic carbon material having a plurality of pores, a specific surface area of 350-550 m²/g, inclusive, and an I_{(D)}/I_{(G)} of 1-10, inclusive, and wherein the graphitic carbon material is at least 90 at % carbon and has a hierarchical porosity; and
a plurality of nanoparticles disposed on a surface of the graphitic carbon material.

2. The composition of claim 1, wherein the plurality of nanoparticles are present at a concentration of 5 to 80% by weight of the total weight of the composition.

3. The composition of claim 1, wherein the graphitic carbon material is nitrogen-doped with one or more N-dopants.

4. The composition of claim 3, wherein the one or more N-dopants are chosen from graphitic N-dopants, pyridinic N-dopants, NOₓ species, and combinations thereof.

5. The composition of claim 3, wherein the N-dopant is present at 0.2-0.5 at %.

6. The composition of claim 3, wherein the plurality of nanoparticles are platinum nanoparticles or platinum cobalt nanoparticles.

7. The composition of claim 6, wherein the platinum cobalt nanoparticles are L1₀ PtCo nanoparticles or L1₂ Pt₃Co nanoparticles.

8. The composition of claim 1, wherein the graphitic carbon material has a cumulative pore volume of 0.7±0.1 cm³/g.

9. The composition of claim 3, wherein the graphitic carbon material is formed from heating a mixture of polymerized aniline, pyrrole, and manganese.

10. The composition of claim 1, wherein the graphitic carbon material further comprises iron.

11. The composition of claim 10, wherein the graphitic carbon material comprises a plurality of FeNₓ groups, wherein x is 1 to 4.

12. The composition of claim 11, wherein x is 4.

13. The composition of claim 12, wherein the plurality of nanoparticles are platinum nanoparticles or platinum cobalt nanoparticles.

14. The composition of claim 13, wherein the platinum cobalt nanoparticles are L1₀ PtCo nanoparticles or L1₂ Pt₃Co nanoparticles.

15. The composition of claim 1, wherein each pore of the plurality of pores has a longest linear dimension or diameter of 1-75 nm, inclusive.

16. A graphitic carbon material, wherein the graphitic carbon material has a plurality of pores, a specific surface area of 350-550 m²/g, and an I_{(D)}/I_{(G)} of 1-10, and
wherein the graphitic carbon material is at least 90 at % carbon.

17. The graphitic carbon material of claim 16, wherein the graphitic carbon material is nitrogen-doped with one or more N-dopants.

18. The graphitic carbon material of claim 17, wherein the one or more N-dopants are chosen from graphitic N-dopants, pyridinic N-dopants, NOₓ species, and combinations thereof.

19. The graphitic carbon material of claim 18, wherein the N-dopant is present at 0.2-0.5 at %.

20. The carbon graphitic material of claim 19, wherein the graphitic carbon material has a cumulative pore volume of 0.7±0.1 cm³/g.

21. The graphitic carbon material of claim 16, wherein the graphitic carbon material is formed from heating a mixture of polymerized aniline, pyrrole, and manganese.

22. The graphitic carbon material of claim 16, wherein the graphitic carbon material further comprises iron.

23. The graphitic carbon material of claim 22, wherein the graphitic carbon material comprises a plurality of FeN₄ groups.

24. A method of making a graphitic carbon material of claim 16, comprising:
providing a mixture comprising:
one or more polyanilines;
one or more polypyrroles; and
manganese; and
thermally treating the mixture,
wherein the graphitic material is formed.

25. The method of claim 24, wherein a portion of the polyanilines and/or a portion of the polypyrroles are formed in situ.

26. The method of claim 25, wherein the mixture is formed by:
providing a reaction mixture comprising:
aniline,
pyrrole,
manganese,
optionally, one or more polymerization catalysts, and
optionally, one or more solvents, and
holding the reaction mixture at a temperature of 18-24° C., inclusive,
wherein the polyanilines and polypyrroles are formed.

27. The method of claim 24, wherein the mixture is a hydrogel comprising water and the method further comprises removing at least a portion of the water.

28. The method of claim 24, wherein the ratio of polyaniline to polypyrrole is 4 to 2, inclusive.

29. The method of claim 24, wherein thermally treating comprises heating the mixture to a temperature of 1050-1110° C., inclusive.

30. The method of claim 29, wherein the temperature is 1090-1110° C., inclusive.

31. The method of claim 24, further comprising acid washing the graphitic carbon material.

32. The method of claim 31, further comprising thermally treating the graphitic carbon material following acid washing, wherein the thermally treating comprises heating the graphitic carbon material at a temperature of 900-1110° C., inclusive.

33. A method of making a composition of claim 1, comprising:
forming a reaction mixture comprising:
an aqueous solution of the graphitic carbon material,
a platinum source, and
a cobalt source,
dehydrating the reaction mixture to form a powder;
thermally treating the powder;
annealing the powder,
wherein the composition of claim 1 is formed.

34. The method of claim 33, wherein the thermally treating is performed in a reducing atmosphere.

35. The method of claim 33, wherein the annealing is performed in an inert atmosphere.

36. The method of claim 33, wherein the annealing is performed at a temperature of 550-770° C., inclusive.

37. A device comprising the composition of claim 1.

38. The device of claim 37, wherein the device is an electrode.

39. The device of claim 38, wherein the electrode further comprises an electrolyte membrane, a gas diffusion membrane, or a combination thereof.

40. A device comprising a plurality of electrodes of claim 38.

41. The device of claim 40, wherein the device is a fuel cell, electrolysis device, or a battery.

42. A device comprising the graphitic carbon material of claim 16.

43. The device of claim 42, wherein the device is an electrode.

44. The device of claim 43, wherein the electrode further comprises an electrolyte membrane, a gas diffusion membrane, or a combination thereof.

45. A device comprising a plurality of electrodes of claim 43.

46. The device of claim 45, wherein the device is a fuel cell, electrolysis device, or a battery.
